(19) United States
(12) Patent Application Publication
(10) Pub. No.: US 2025/0200039 A1
(43) Pub. Date: Jun. 19, 2025

(54) System and Method for Input Data Query Processing

(71) Applicant: DataPelago, Inc., Mountain View, CA (US)

(72) Inventors: Satyanarayana Lakshmipathi Billa, Sunnyvale, CA (US); Abhishek Kumar Dikshit, San Jose, CA (US); Kenneth A. Bullis, Mountain View, CA (US); Ramit Goyal, Saratoga, CA (US)

(21) Appl. No.: 18/542,291

(22) Filed: Dec. 15, 2023

(51) Int. Cl. G06F 16/2453; G06F 11/34; G06F 16/245

(52) U.S. Cl. CPC G06F 16/24542; G06F 11/3433; G06F 16/24569

(57) ABSTRACT

A computer-based system and corresponding computer-implemented method process input data queries in a manner enabling advanced functionality for data analytics. The method transforms a query plan tree into a query strategy tree. The query plan tree is constructed from an input data query associated with a computation workload. The method compiles the query strategy tree into dataflow graph(s) (DFG(s)). The method transmits the DFG(s) for execution via a virtual platform. The method monitors execution of the DFG(s). The method outputs, based on a result of the execution monitored, a response to the input data query. The result is received from the virtual platform and represents at least one computational result of processing the computation workload by the virtual platform. The system and method enable rapid and efficient retrieval and analysis of data stored in data lakes and other data storage systems, in response to user queries.

### RELATED APPLICATIONS

This application is related to U.S. application Ser. No. 18/541,993, entitled “System and Method for Computation Workload Processing,” filed on Dec. 15, 2023, and U.S. patent application Ser. No. ______, entitled “Programmable Dataflow Unit” (Attorney Docket No.: 6214.1004-000), filed on Dec. 15, 2023. The entire teachings of the above applications are incorporated herein by reference.

### BACKGROUND

A data lake is a repository designed to store and process large amounts of structured and/or unstructured data. Conventional data lakes provide limited real-time or batch processing of stored data and can analyze the data by executing commands issued by a user in SQL (structured query language) or another query or programming language. The exponential growth of computer data storage raises several challenges for storage, retrieval, and analysis of data. In particular, data lakes and other data storage systems have the capacity to store large and ever-increasing quantities of data.

### SUMMARY

An example embodiment disclosed herein may provide functionality for rapidly and efficiently retrieving and analyzing data stored in data lakes and other data storage systems, in response to user queries. Example embodiments may provide, among other things, a novel query compilation and execution orchestration framework in a data analytics pipeline, as well as a novel multifaceted intermediate representation in which common data analytics and high-performance computing pipelines can be represented.

According to an example embodiment, a computer-implemented method comprises transforming a query plan tree into a query strategy tree. The query plan tree is constructed from an input data query associated with a computation workload. The method further comprises compiling the query strategy tree into at least one dataflow graph. The method further comprises transmitting the at least one dataflow graph for execution via a virtual platform. The method further comprises monitoring the execution of the at least one dataflow graph. The method further comprises outputting, based on a result of the execution monitored, a response to the input data query. The result is received from the virtual platform and represents at least one computational result of processing the computation workload by the virtual platform.

The method may further comprise generating, based on the input data query associated with the computation workload, a query logic tree including at least one query element node. The method may further comprise constructing, based on the query logic tree generated, the query plan tree in an intermediate representation (IR). The IR may be compatible with at least one type of computation workload. The at least one type of computation workload may include a type of the computation workload associated with the input data query. The IR may be architecture-independent and the IR may represent at least one query operation of the input data query.

The at least one type of computation workload may include a Structured Query Language (SQL) query plan, a data ingestion pipeline, an artificial intelligence (AI) or machine learning (ML) workload, a high-performance computing (HPC) program, another type of computation workload, or a combination thereof for non-limiting example.

Transforming the query plan tree into the query strategy tree may include generating the query strategy tree from the query plan tree. The query strategy tree may include at least one action node. An action node of the at least one action node may correspond to a respective portion of the computation workload. The transforming may further include determining at least one resource for executing the action node of the query strategy tree generated. The action node may include at least one stage. A stage of the at least one stage may correspond to a unique portion of the respective portion of the computation workload. Determining the at least one resource may include determining at least one respective resource for executing each stage of the at least one stage.

The query plan tree may be annotated with at least one statistic relating to the computation workload and transforming the query plan tree into the query strategy tree may be based on a statistic of the at least one statistic.

The transforming may include distributing at least a portion of the computation workload equally across at least two action nodes of at least one level of action nodes of the query strategy tree. It should be understood that such distributing is not limited thereto. For example, the at least a portion of the computation workload is not limited to being distributed equally. Further, the computation workload may be distributed across at least two stages of one (single) action node for non-limiting example.

The transforming may include applying at least one optimization to the query strategy tree. The at least one optimization may include a node-level optimization, an expression-level optimization, or a combination thereof for non-limiting examples.

The compiling may include selecting, based on at least one resource associated with an action node of at least one action node of the query strategy tree, a virtual machine (VM) of at least one VM of the virtual platform. The compiling may further include translating the action node of the at least one action node of the query strategy tree into a dataflow graph of the at least one dataflow graph. The compiling may further include assigning the dataflow graph for execution by the VM selected.

It should be understood, however, that such selecting, translating, and assigning are not limited thereto. For example, the selecting may include selecting at least one VM from the at least one VM of the virtual platform. An action node may include at least one stage, as disclosed further below. According to an example embodiment, the translating may include translating each stage of the at least one stage into a respective dataflow graph of the at least one dataflow graph and the assigning may include assigning the respective dataflow graph to a VM of the at least one VM selected. As such, in an event an action node includes multiple stages, each stage of the multiple stages may be translated (converted) on a stage-by-stage basis into a respective dataflow graph. Each respective dataflow graph may, in turn, be assigned to a particular VM on a dataflow-graph-by-dataflow-graph basis such that different dataflow graphs may be assigned to a same or different VM of the at least one VM selected.

Selecting the VM may be further based on at least one of: (i) workload of the VM, (ii) at least one resource of the VM for processing the computation workload, and (iii) compatibility of the computation workload with the VM for non-limiting examples.

A scheduling mode for the query strategy tree may be a store-forward mode and the method may further comprise identifying the action node of the at least one action node of the query strategy tree by traversing the query strategy tree in a breadth-first mode. The action node of the at least one action node of the query strategy tree may be a parent action node, e.g., an immediate parent action node, an intermediate parent action node, or an ultimate parent action node, associated with at least one child action node of the query strategy tree. The translating and the assigning may be performed responsive to determining that execution of a respective dataflow graph of the at least one dataflow graph has completed. The respective dataflow graph may correspond to a child action node of the at least one child action node.

A scheduling mode for the query strategy tree may be a cut-through mode and the selecting may include causing the VM to reserve the at least one resource associated with the action node of the at least one action node of the query strategy tree. The translating and the assigning may be performed responsive to traversing the query strategy tree in a post-order depth-first mode.

The VM selected may include at least one programmable dataflow unit (PDU) based execution node and the selecting may be further based on at least one resource of a PDU based execution node of the at least one PDU based execution node. A dataflow node of the dataflow graph may correspond to a query operation and the selecting may include mapping the query operation to the PDU based execution node.

The VM selected may include at least one non-PDU based execution node and the selecting may be further based on at least one resource of a non-PDU based execution node of the at least one non-PDU based execution node. The non-PDU based execution node may be a central processing unit (CPU) based execution node, a graphics processing unit (GPU) based execution node, a tensor processing unit (TPU) based execution node, or another type of non-PDU based execution node for non-limiting examples.

The monitoring may include detecting an execution failure of a dataflow graph of the at least one dataflow graph on a first VM of the virtual platform and assigning the dataflow graph for execution on a second VM of the virtual platform.

The method may include adapting the query strategy tree based on at least one statistic associated with the computation workload. A statistic of the at least one statistic may include a runtime statistical distribution of data values in a data source associated with the computation workload. The adapting may be responsive to identifying a mismatch between the runtime statistical distribution of the data values and an estimated statistical distribution of the data values.

The adapting may include regenerating a dataflow graph of the at least one dataflow graph by performing at least one of: (i) reordering dataflow nodes of the dataflow graph, (ii) removing an existing dataflow node of the dataflow graph, and (iii) adding a new dataflow node to the dataflow graph for non-limiting examples.

The computer-implemented method may further comprise generating, based on a dataflow graph of the at least one dataflow graph, a plurality of dataflow subgraphs and configuring dataflow subgraphs of the plurality of dataflow subgraphs to, when executed via the virtual platform, perform a data movement operation in parallel. The data movement operation may include at least one of: (i) streaming data from a data source associated with the computation workload and (ii) transferring data to or from at least one VM of the virtual platform.

The compiling may include selecting a VM of at least one VM of the virtual platform. The selecting may be based on at least one resource associated with a stage of at least one stage of an action node of at least one action node of the query strategy tree. The compiling may further include translating the stage into a dataflow graph of the at least one dataflow graph. The compiling may further include assigning the dataflow graph for execution by the VM selected.

A scheduling mode for the query strategy tree may be a store-forward mode and the method may further comprise identifying the action node by traversing the query strategy tree in a breadth-first mode. The action node of the at least one action node of the query strategy tree may be a parent action node of at least one child action node of the query strategy tree. The stage of the action node may be associated with a stage of at least one stage of the at least one child action node. The translating and the assigning may be performed responsive to determining that execution of a respective dataflow graph of the at least one dataflow graph has completed. The respective dataflow graph may correspond to the stage of the at least one stage of the at least one child action node. The action node may be a child action node of a parent action node of the query strategy tree and the stage of the action node may be associated with a stage of at least one stage of the parent action node.

A scheduling mode for the query strategy tree may be a cut-through mode and the selecting may include causing the VM to reserve the at least one resource associated with the stage of the at least one stage of the action node of the at least one action node of the query strategy tree. The translating and the assigning may be performed responsive to traversing the query strategy tree in a post-order depth-first mode.

The transforming may include distributing at least a portion of the computation workload equally across at least two stages of an action node of at least one action node of the query strategy tree. It should be understood, however, that the computation workload is not limited to being distributed equally.

According to another example embodiment, a computer-based system comprises at least one processor and a memory with computer code instructions stored thereon. The at least one processor and the memory, with the computer code instructions, are configured to cause the system to implement a compiler module. The compiler module is configured to transform a query plan tree into a query strategy tree. The query plan tree is constructed from an input data query associated with a computation workload. The compiler module is further configured to compile the query strategy tree into at least one dataflow graph. The at least one processor and the memory, with the computer code instructions, are further configured to cause the system to implement a runtime module. The runtime module is configured to transmit the at least one dataflow graph for execution via a virtual platform, monitor the execution of the at least one dataflow graph, and output a response to the input data query based on a result of the execution monitored. The result is received from the virtual platform and represents at least one computational result of processing the computation workload by the virtual platform.

Alternative computer-based system embodiments parallel those described above in connection with the example computer-implemented method embodiment.

According to yet another example embodiment, a non-transitory computer-readable medium has encoded thereon a sequence of instructions which, when loaded and executed by at least one processor, causes the at least one processor to implement a compiler module. The compiler module is configured to transform a query plan tree into a query strategy tree. The query plan tree is constructed from an input data query associated with a computation workload. and compile the query strategy tree into at least one dataflow graph. The sequence of instructions further causes the at least one processor to implement a runtime module. The runtime module is configured to transmit the at least one dataflow graph for execution via a virtual platform, monitor the execution of the at least one dataflow graph, and output a response to the input data query based on a result of the execution monitored. The result is received from the virtual platform and represents at least one computational result of processing the computation workload by the virtual platform.

Alternative non-transitory computer-readable medium embodiments parallel those described above in connection with the example computer-implemented method embodiment.

It is noted that example embodiments of a method, system, and computer-readable medium may be configured to implement any embodiments, or combination of embodiments, described herein.

It should be understood that example embodiments disclosed herein can be implemented in the form of a method, apparatus, system, or computer readable medium with program codes embodied thereon.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a block diagram of an example embodiment of a computer-based system.

FIG. 1B is a block diagram of an example embodiment of a data analytics compute cluster.

FIG. 2 is a block diagram of an example embodiment of a data analytics system.

FIG. 3 is a block diagram of an example embodiment of a multi-cloud analytics platform.

FIG. 4 is a block diagram of an example embodiment of a service console server.

FIG. 5 is a block diagram of an example embodiment of a query server.

FIG. 6 is a flow diagram of an example embodiment of a data analysis process that may be performed by an example embodiment of query server disclosed herein.

FIG. 7 is a block diagram of an example embodiment of computation pushdown.

FIG. 8 is a block diagram of an example embodiment of a reused computation.

FIG. 9 is a flow diagram of an example embodiment of a process for generating a dataflow graph.

FIG. 10 is a block diagram of an example of a disaggregated data analytics stack with domain-specific computing.

FIG. 11 is a block diagram of an example of a scaled and distributed architecture for a data analytics pipeline.

FIG. 12 is a block diagram of an example embodiment of an architecture for a computer-based system disclosed herein.

FIG. 13 is a block diagram of an example embodiment of a query server architecture.

FIG. 14A is a block diagram of an example embodiment of a data analytics compute plane.

FIG. 14B is a block diagram of an example embodiment of different components of the data analytics compute plane of FIG. 14A.

FIG. 14C is a block diagram of an example embodiment of disaggregation of the data analytics compute plane of FIG. 14A.

FIG. 15 is a block diagram of an example embodiment of a first phase of a data analytics pipeline.

FIGS. 16A and 16B are block diagrams of example embodiments of a logical plan and optional logical optimization, respectively.

FIG. 17 is a flow diagram of an example embodiment of physical plan generation and optional physical optimization for the logical plan of FIG. 16B.

FIG. 18 is a block diagram of an example embodiment of a second phase of a data analytics pipeline.

FIG. 19A is a block diagram an example embodiment of a tree of actions.

FIG. 19B is a block diagram of an example embodiment of machine code for a data flow graph (DFG) corresponding to a first action of FIG. 19A, according to an embodiment.

FIG. 19C is a block diagram of an example embodiment of machine code for a DFG corresponding to a third action of FIG. 19A.

FIG. 20 is a flow diagram of an example embodiment of process implemented by a computer-based system disclosed herein.

FIG. 21 is a block diagram of an example embodiment of join types supported by a join node.

FIG. 22 is a block diagram of an example embodiment of functionality of an example embodiment of an evaluate node disclosed herein.

FIG. 23 is a block diagram of an example embodiment of functionality of an example embodiment of a project bitmap node disclosed herein.

FIG. 24 is a block diagram of an example embodiment of functionality of an example embodiment of a tuple hash node disclosed herein.

FIG. 25 is a block diagram of an example embodiment of use of a hash build node to build a table.

FIG. 26 is a block diagram of an example embodiment of use of a hash probe node to probe a table.

FIG. 27 is a block diagram of example embodiment of use of a tuple build node to build a table.

FIG. 28 is a block diagram of an example embodiment of use of a tuple probe node to probe a table.

FIG. 29 is a block diagram of an example embodiment of functionality of an example embodiment of a merge node disclosed herein.

FIG. 30 is a flow diagram of an example embodiment of a process for distributed scheduling and execution of dataflow graphs.

FIG. 31 is a block diagram of an example embodiment of a query strategy tree with actions that include respective stages.

FIG. 32 is a block diagram of an example embodiment of an inner hash join implementation that includes a build phase and a probe phase.

FIG. 33 is a block diagram of an example embodiment of a left outer hash join implementation that includes a build phase and a probe phase.

FIG. 34 is a block diagram of an example embodiment of a left semi hash join implementation that includes a build phase and a probe phase.

FIG. 35 is a block diagram of an example embodiment of a right semi hash join implementation that includes a build phase and a probe phase.

FIG. 36 is a block diagram of a left anti hash join implementation that includes a build phase and a probe phase.

FIG. 37 is a flow diagram of an example embodiment of a computer-implemented method.

FIG. 38 is a block diagram of an example internal structure of a computer optionally within an embodiment disclosed herein.

### DETAILED DESCRIPTION

A description of example embodiments follows.

Embodiments provide advanced functionality for data analytics. As used herein, a “dataflow graph” (DFG) may include a graph or tree data structure having one or more dataflow node(s) and edge(s), where each dataflow node may represent a computational operation or task to be performed using data, and each edge may represent a dataflow operation or task, i.e., to move data between dataflow nodes.

As used herein, a “query front-end,” or simply “front-end,” may include a client entity or computing device at which a user data query (such as a SQL [structured query language] query, for non-limiting example) is created, edited, and/or generated for submission. Likewise, as used herein, a “query back-end,” or simply “back-end,” may include a server entity or computing device that receives a user data query created by a front-end.

As used herein, an “abstract syntax tree” (AST) may include a graph or tree data structure used to represent the structure of a program, source code, or query, for non-limiting examples. Further, as used herein, a “logical plan” may include a collection of logical operators that describe work used to generate results for a query and/or define which data sources to use and/or operators to apply to generate the results; a logical plan may also be represented by a graph or tree data structure. In the alternative or additionally, a logical plan may represent a query as a relational algebra expression.

As used herein, a “physical plan” may include a logical plan data structure that is annotated with implementation details. Further, as used herein, an “intermediate representation” (IR) may include a data structure, code, or language for an abstract machine that is used to generate code for one or more target machine(s), optionally after applying one or more optimization(s) and/or transformation(s), for non-limiting examples, to the IR; an IR may also be used to represent a physical plan.

As used herein, a “strategy tree” (interchangeably referred to as a “tree of actions”) may include a tree data structure having one or more action node(s) (interchangeably referred to as “action(s)”), where each action node may include one or more operation(s) of a query, and where a parent action node's operation(s) may use data resulting from performing operation(s) of the parent action node's child action node(s).

Further, as used herein, a “stage” may include an optional subcomponent of an action node, where a given action node may have one or more optional stage(s), and each of the optional stage(s) may be a data structure that represents a respective portion of the given action node's operation(s).

Conventional data analytics platforms are constrained in ways that prevent them from meeting the demands of modern data storage, retrieval, and analysis. For example, many existing analytics systems employ general-purpose processors, such as x86 central processing units (CPUs) for non-limiting example, that manage retrieval of data from a database for processing a query. However, such systems often have inadequate bandwidth for retrieving and analyzing large stores of structured and unstructured data, such as those of modern data lakes. Further, the output data resulting from queries of such data stores may be much larger than the input data, placing a bottleneck on system performance. Typical query languages, such as SQL for non-limiting example, can produce inefficient or nonoptimal plans for such systems, leading to delays or missed data. Such plans can also lead to a mismatch between I/O and computing load. For example, in a CPU-based analytics system, I/O may be underutilized due to an overload of computation work demanded of the CPU.

The CAP (Consistency, Availability, and Partition Tolerance) theorem states that a distributed data store is capable of providing only two of the following three guarantees:
a) Consistency: Every read operation receives data in accordance with the most recent write operation.
b) Availability: Every request receives a response.
c) Partition tolerance: The system will continue to operate despite experiencing delay or dropping of messages.
   Similar to the CAP theorem, existing data stores cannot maximize dataset performance, size, and freshness simultaneously; prioritizing two of these qualities leads to the third being compromised. Thus, prior approaches to data analytics have been limited from deriving cost-efficient and timely insights from large datasets. Attempts to solve this problem have led to complex data pipelines having fragmented data silos.

Example embodiments, described herein, provide data analytics platforms that overcome several of the aforementioned challenges in data analytics. In particular, a query compiler may be configured to generate an optimized data flow graph from an input query, providing efficient workflow instructions for the platform. PDUs (Programmable Dataflow Units) are hardware engines for executing the input query in accordance with the workflow and may include a number of distinct accelerators that may each be optimized for different operations within the workflow. Such platforms may also match the impedance between computational load and I/O. As a result, data analytics platforms in example embodiments can provide consistent, cost-efficient, and timely insights from large datasets.

According to an example embodiment, QFlow (Query Flow) is a query compilation and execution orchestration framework of a data analytics pipeline. Such framework may take an IR (intermediate representation) of a computation pipeline, build an optimal strategy of execution with a number of executors, compile the stages of the computation strategy into DFGs, and schedule the DFGs on virtual machine(s) (VM(s)). Within such a framework, namely a QFlow framework, execution of the DFGs may be monitored and a response may be returned to a user responsive to successful completion of the computation strategy.

According to an example embodiment, QFlow IR is a multi-faceted intermediate representation in which common data analytics and high-performance computing pipelines can be represented. Below is a non-limiting list of example frontend frameworks that can be represented in QFlow IR:
a) Logical/physical plans of SQL frameworks like Apache Calcite™ framework, Apache Spark™ framework, Presto® framework, etc.
b) Data ingestion pipelines, such as implemented by an Apache Kafka® streaming platform, Apache Spark streaming platform, etc.
c) Programs of high-performance computing (HPC) languages, such as R, Julia, etc.

According to an example embodiment, a node in a QFlow IR may be annotated with statistics on how many rows and columns are sent to it and how many rows and columns are expected out of it. This information may be used by a QFlow runtime module to generate an execution strategy. The execution strategy may include a tree of actions, wherein each action may contain a portion of the computation to be performed along, with resources for performing that computation. The tree of actions may be created in a way that distributes a load equally on all sibling nodes at each level in the tree.

For each action in the tree, resources may be allocated/reserved at available VMs based on their load, availability of host, PDU compute, memory, and/or network, etc., resources for non-limiting examples. After such allocation/reservation is done, each action may be converted into a DFG and sent to an assigned VM(s). The VM(s) may finish out of order and the QFlow runtime module may keep track of their execution. The actions may be scheduled based on a mode, such as a mode of the following two modes:
a) Cut-through
b) Store-forward

In cut-through mode, all actions of a strategy may be scheduled at once (concurrently), and data may be exchanged/shuffled between multiple VMs using, e.g., transport layer security/transmission control protocol (TLS/TCP) connections for non-limiting example, or any other suitable known protocol(s). In store-forward mode, data of selected actions may be stored locally, e.g., on solid-state drives (SSDs) for non-limiting example, or any other suitable known storage system, on a VM. A parent action may be scheduled once a child action and all its siblings are done processing. The cut-through mode reduces latency of a query, whereas the store-forward mode is fault-tolerant and can reschedule actions upon VM failures.

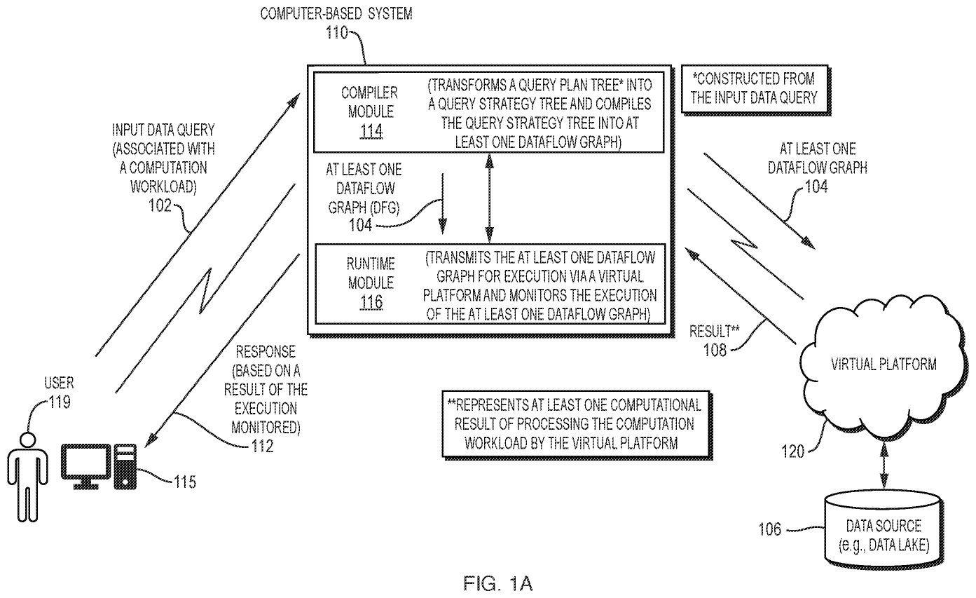

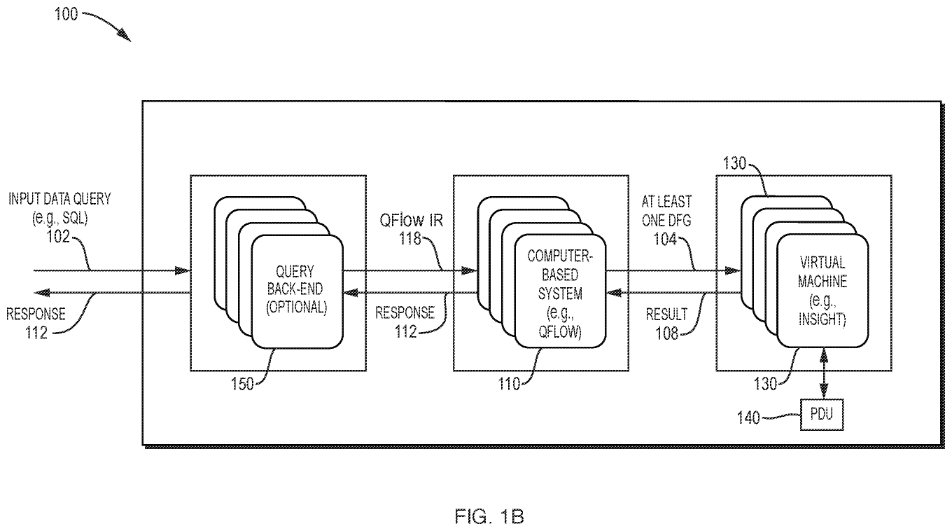

According to an example embodiment, QFlow is a novel framework that may, among other things, compile down languages used for data analytics, such as SQL, the Apache Spark language, and other suitable known languages, into data flow graphs (DFGs) generated for execution by VMs, also referred to herein as “Insight VM DFG(s),” as such VMs may be executed on a machine/engine referred to as “Insight,” and execute the generated DFG(s). The QFlow framework may include a set of modules that provide application-specific interfaces (APIs) to, for non-limiting example:
a) Generate QFlow IR from known languages like SQL
b) Optionally, apply optimization(s) on the generated IR
c) Convert the (optionally optimized) IR into Insight VM DFG(s)
d) Execute the Insight VM DFG(s) and monitor them
   A computer-based system for implementing an example embodiment of the QFlow framework is disclosed below, with reference to FIG. 1A.

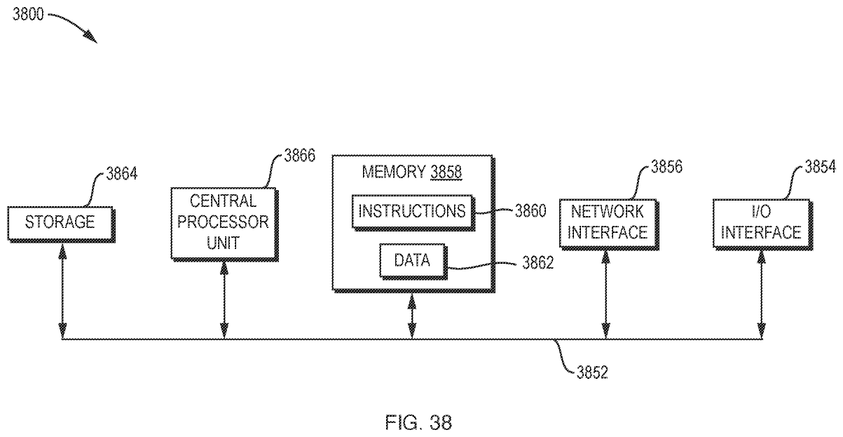

FIG. 1A is a block diagram of an example embodiment of a computer-based system 110, also referred to interchangeably herein as QFlow. In the example embodiment of FIG. 1A, the system 110 comprises at least one processor (not shown) and memory (not shown) with computer code instructions (not shown) stored thereon, such as disclosed further below with regard to FIG. 38. Continuing with reference to FIG. 1A, the at least one processor and the memory, with the computer code instructions, may be configured to cause the system to implement a compiler module 114 and a runtime module 116. The compiler module 114 may be configured to transform a query plan tree (not shown) into a query strategy tree (not shown). The query plan tree may be constructed from an input data query 102 associated with a computation workload. In the example embodiment, the input data query is received from a user device 115 of a user 114 for non-limiting example. The user device 115 may be a personal computer (PC), laptop, table, smartphone, or any other user device for non-limiting examples. The compiler module 114 may be configured to compile the query strategy tree into at least one dataflow graph (DFG) 104. The runtime module 116 may be configured to transmit the at least one DFG 104 for execution via a virtual platform 120, monitor the execution of the at least one DFG 104, and output a response 112 to the input query 102 based on a result 108 of the execution monitored. The response 112 to the input data query 102 may be transmitted to the user device 115 which may, in turn, provide the response to the user 114 for non-limiting example. The result 108 may be received from the virtual platform 120 and may represent at least one computational result (not shown) of processing the computation workload by the virtual platform 120.

The compiler module 114 may be further configured to generate, based on the input data query 102 associated with the computation workload, a query logic tree (not shown) including at least one query element node (not shown). The compiler module 114 may be further configured to construct, based on the query logic tree generated, the query plan tree in an IR (not shown). The IR may be compatible with at least one type of computation workload. The at least one type of computation workload may include a type of computation workload associated with the input data query 102. The IR may be architecture-independent and may represent at least one query operation of the input data query 102.

The at least one type of computation workload may include a Structured Query Language (SQL) query plan, a data ingestion pipeline, an artificial intelligence (AI) or machine learning (ML) workload, a high-performance computing (HPC) program, another type of computation workload, or a combination thereof for non-limiting examples.

The compiler module 114 may be further configured to generate the query strategy tree from the query plan tree. The query strategy tree may include at least one action node (not shown). An action node of the at least one action node may correspond to a respective portion of the computation workload. The compiler module 114 may be further configured to determine at least one resource (not shown) for executing the action node of the query strategy tree generated. The action node may include at least one stage. A stage of the at least one stage may correspond to a unique portion of the respective portion of the computation workload. The compiler module 114 may be further configured to determine at least one respective resource for executing each stage of the at least one stage.

According to an example embodiment, the query plan tree may be annotated with at least one statistic (not shown) relating to the computation workload and the compiler module 114 may be further configured to transform the query plan tree into the query strategy tree based on a statistic of the at least one statistic.

The compiler module 114 may be further configured to distribute at least a portion of the computation workload equally across at least two action nodes of at least one level of action nodes of the query strategy tree. Alternatively, the compiler module 114 may be further configured to distribute at least a portion of the computation workload equally across at least two stages of an action node of at least one action node of the query strategy tree. It should be understood, however, that the computation workload is not limited to being distributed equally.

According to an example embodiment, the compiler module 114 may be further configured to apply at least one optimization to the query strategy tree. The at least one optimization may include a node-level optimization, an expression-level optimization, or a combination thereof for non-limiting examples.

The compiler module 114 may be further configured to select, based on at least one resource (not shown) associated with an action node (not shown) of at least one action node (not shown) of the query strategy tree, a virtual machine (VM) of at least one VM (not shown) of the virtual platform 120. The compiler module 114 may be further configured to translate the action node of the at least one action node of the query strategy tree into a DFG of the at least one DFG 104 and assign the DFG for execution by the VM selected.

According to an example embodiment, the compiler module 114 may be further configured to select the VM based on at least one of: a workload of the VM, at least one resource of the VM for processing the computation workload, and compatibility of the computation workload with the VM for non-limiting examples.

A scheduling mode for the query strategy tree may be a store-forward mode. The compiler module 114 may be further configured to identify the action node of the at least one action node of the query strategy tree by traversing the query strategy tree in a breadth-first mode. The action node of the at least one action node of the query strategy tree may be a parent node associated with at least one child action node of the query strategy tree. The compiler module 114 may be further configured to translate the action node and assign the DFG responsive to determining that execution of a respective DFG of the at least one DFG 104 has completed. The respective DFG may correspond to a child action node of the at least one child action node.

According to an example embodiment, a scheduling mode for the query strategy tree may be a cut-through mode. The compiler module 114 may be further configured to cause the VM selected to reserve the at least one resource associated with the action node of the at least one action node of the query strategy tree. The compiler module 114 may be further configured to translate the action node and assign the DFG responsive to traversing the query strategy tree in a post-order depth-first mode.

The VM selected may include at least one programmable dataflow unit (PDU) based execution node (not shown). The compiler module 114 may be further configured to select the VM based on at least one resource of a PDU based execution node of the at least one PDU based execution node. A dataflow node (not shown) of the DFG may correspond to a query operation. The compiler module 114 may be further configured to map the query operation to the PDU based execution node.

The VM selected may include at least one non-PDU based execution node (not shown). The compiler module 114 may be further configured to select the VM based on at least one resource of a non-PDU based execution node of the at least one non-PDU based execution node. The non-PDU based execution node may be a central processing unit (CPU) based execution node, a graphics processing unit (GPU) based execution node, a tensor processing unit (TPU) based execution node, or another type of non-PDU based execution node for non-limiting examples.

The runtime module 116 may be further configured to detect an execution failure of a DFG of the at least one DFG 104 on a first VM of the virtual platform 120. The runtime module 116 may be further configured to assign the DFG for execution on a second VM of the virtual platform 120.

According to an example embodiment, the compiler module 114 may be further configured to adapt the query strategy tree based on at least one statistic (not shown) associated with the computation workload. A statistic of the at least one statistic may include a runtime statistical distribution of data values (not shown) in a data source 106, associated with the computation workload. The data source 106 may be a data lake for non-limiting example. The compiler module 114 may be further configured to adapt the query strategy tree responsive to identifying a mismatch between the runtime statistical distribution of the data values and an estimated statistical distribution (not shown) of the data values.

According to an example embodiment, the compiler module 114 may be further configured to regenerate a DFG of the at least one DFG 104 by performing at least one of: reordering dataflow nodes of the DFG, removing an existing dataflow node of the DFG, or adding a new dataflow node to the DFG, for non-limiting examples. By adapting the query strategy tree, the compiler module 114 may increase efficiency of execution of the DFG relative to not adapting the query strategy tree.

According to an example embodiment, the compiler module 114 may be further configured to generate, based on a DFG of the at least one DFG 104, a plurality of dataflow subgraphs (not shown) and configure dataflow subgraphs of the plurality of dataflow subgraphs to, when executed via the virtual platform 120, perform a data movement operation in parallel. The data movement operation may include at least one of: streaming data from the data source 106, associated with the computation workload and transferring data to or from at least one VM of the virtual platform 120 for non-limiting examples. According to an example embodiment, the computer-based system 110 may be employed in a data analytics compute cluster, such as disclosed below with regard to FIG. 1B.

FIG. 1B is a simplified block diagram of an example embodiment of a data analytics compute cluster 100 according to an example embodiment. In the example embodiment of FIG. 1B, the cluster 100 includes the computer-based system 110, e.g., QFlow, a VM 130, and a PDU execution unit 140. Optionally, the cluster 100 may also include a query back-end 150. According to an example embodiment, the cluster 100 may also include other components/modules (not shown), such as a shared state service, performance monitor service, etc. for non-limiting examples. According to an example embodiment, the system 110 may provide features such as DFG conversion, execution orchestration, etc. The VM 130 may provide features, such as DFG execution, data path implementation, etc. The optional back-end 150 may provide features, such as query planning, optimization, etc. According to an example embodiment, the system 110, VM 130, optional back-end 150, shared state service, and performance monitor service may be implemented variously as services or stateful applications using a container orchestration system, such as a Kubernetes® (K8s®) system, or any other suitable container system known to those of skill in the art for non-limiting examples.

According to an example embodiment, the input data query 102, e.g., a SQL query for non-limiting example, may be received from a user, such as the user 114 of FIG. 1A. Continuing with reference to FIG. 1B, as an optional procedure, the back-end 150 may transform the received input query 102 into a QFlow IR 118, which is sent to the computer-based system 110. According to an example embodiment, the system 110 may compile the QFlow IR 118 into the at least one DFG 104. According to an example embodiment, a DFG of the at least one DFG 104 may, in turn, be executed via the VM 130, which may include the PDU 140. Executing the DFG of the at least one DFG 104 may produce the result 108, which may also be referred to as an execution result. According to an example embodiment and with reference to FIGS. 1A and 1B, based on the result 108, the system 110 may generate the response 112 that may be sent to the user 114, optionally via back-end 150.

Continuing with reference to FIGS. 1A and 1B, according to an example embodiment, the computer-based system 110 may transform a query plan tree (not shown) into a query strategy tree (not shown), wherein the query plan tree may be constructed from the input data query 102, which may be associated with a computation workload. The system 110 may be configured to compile the query strategy tree into the at least one DFG 104. The system 110 may be configured to transmit a DFG of the at least one DFG 104 for execution via the virtual platform 120. The system 110 may monitor execution of the DFG transmitted. In addition, the system 110 may be configured to output, based on the result 108 of the execution monitored, the response 112 to the input data query 102. The result 108 may be received from the virtual platform 120 and may represent at least one computational result of processing the computation workload by the virtual platform 120.

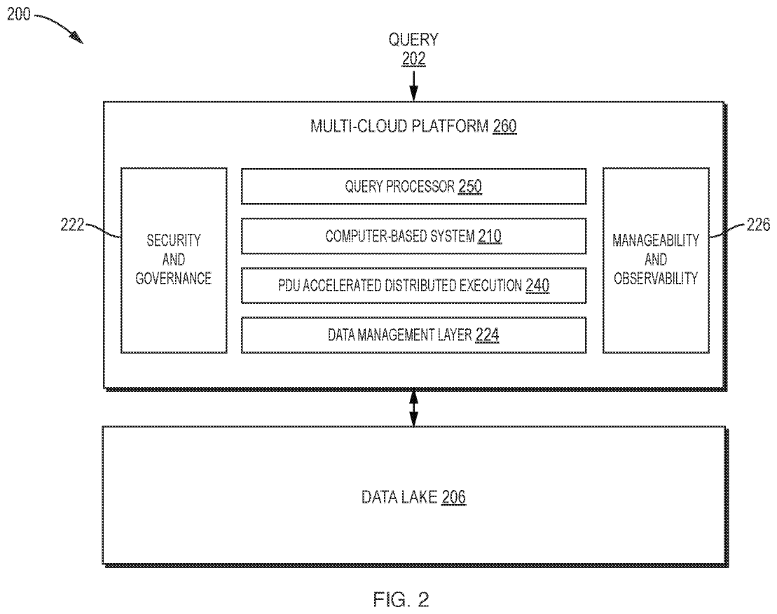

According to an example embodiment, the computer-based system 110 may select, based on resource(s) associated with an action node of action node(s) of the query strategy tree, a VM, e.g., the VM 130, of VM(s) of the virtual platform 120. The system 110 may translate the action node of the action node(s) of the query strategy tree into a DFG of the at least one DFG 104. According to another example embodiment, the system 110 may be configured to assign the DFG for execution by the VM selected, such as the VM 130. The VM selected may include a PDU based execution node(s), such as the PDU 140. The computer-based system 110 of FIGS. 1A and 1B, disclosed above, may be employed in a data analytics system, such as disclosed below with regard to FIG. 2.

FIG. 2 is a block diagram of an example embodiment of a data analytics system 200. The system 200 includes a data lake 206, for non-limiting example, that may be configured to store structured and/or unstructured data. Alternatively, a plurality of data lakes (not shown), or a combination of data lakes, data warehouses and/or other data stores, may be implemented in place of the data lake 206. A multi-cloud analytics platform 260 may be configured to receive a data query, e.g., the query 202 which may be the input data query 102 of FIG. 1A, disclosed above, to analyze data of the data lake 206 in accordance with the query 202, and be further configured to provide a corresponding result to a user, such as the response 112 provided to the user 114 of FIG. 1A. Continuing with reference to FIG. 2, the platform 260 may be implemented via a plurality of cloud networks (not shown) that may each include at least one server (not shown), as described in further detail below. Functional elements of the platform 260 are shown in FIG. 2, including a query processor 250, the computer-based system 210, a PDU block 240, a data management layer 224, a security manager 222, and a management controller 226 for non-limiting examples.

The query processor 250 may be configured to receive the query 202 from a user. The query 202 may be written in a data analytics language, such as a SQL or Python language, for non-limiting examples, and represents the user's intent for analysis of the data stored at the data lake 206. The query processor 250 may receive and process the query 202 to generate a corresponding DFG, which defines an analytics operation as a tree of nodes, each node representing a distinct action. The computer-based system 210 may be the computer-based system 110 of FIGS. 1A and 1B, disclosed above, and compiles the DFG into machine-readable instructions for execution by a VM operated at the PDU block 240. The VM may also be referred to herein as an Insight machine, or simply Insight. Continuing with reference to FIG. 2, the data management layer 224 interfaces with the data lake 206 to access data requested by the PDU block 240. The security manager 222 provides secured access to the platform 260 and may control authentication, authorization, and confidentiality components, among other examples, of the platform 260. Lastly, the management controller 226 may enable users to view and manage operations of the platform 260, and may manage components of the platform 260, such as monitoring, relocation of components in response to a failure, scaling on up and down, and observing the usage and performance of components.

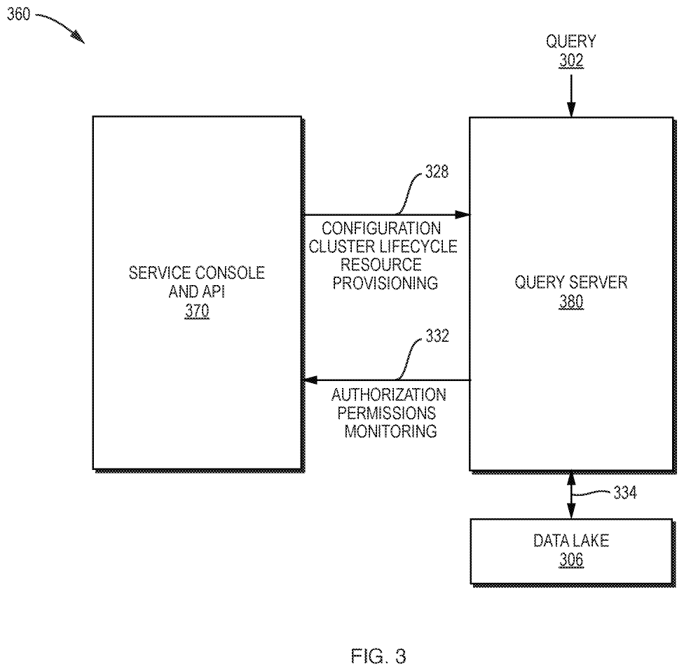

The analytics platform 260 can provide several advantages over conventional data analytics solutions. For example, the platform 260 can be scaled easily to service data lakes of any size while meeting demands for reliable data analytics, providing a fully managed analytics service on decentralized data. Further, because the platform 260 can process data regardless of its location and format, it can be adapted to any data store, such as the data lake 206, without changing or relocating the data. The platform 260 may be employed as a multi-cloud analytics platform, disclosed below with regard to FIG. 3.

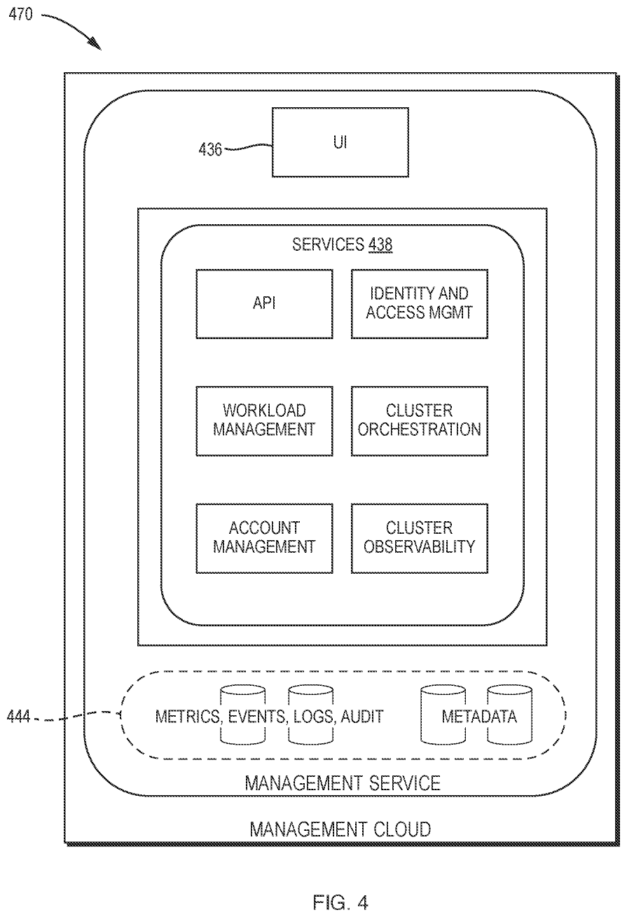

FIG. 3 is a block diagram of an example embodiment of a multi-cloud analytics platform 360. In the example embodiment of FIG. 3, the analytics platform 360 is shown as two networked servers, a service console server 370, and a query server 380 for non-limiting example. The servers 370, 380 may each include one or more physical servers configured as a cloud service. The service console server 370 may provide a user interface (not shown) to a managing user through a connected device (not shown), enabling the managing user to monitor the performance and configuration of the query server 380. The query server 380 may communicate with a client user (such as an owner of a data lake, e.g., data lake 306, data lake 206 of FIG. 2, or data source 106 of FIG. 1A) to receive a query, e.g., query 302, input data query 202 (FIG. 2), or input data query 102 (FIG. 1A), to access the data lake 306 to perform an analytics operation in accordance with the query 302, and return a corresponding result to the user, such as disclosed above with regard to FIGS. 1A, 1B, and 1. Continuing with reference to FIG. 3, the service console server 370 may transmit management and configuration commands 328 to manage the query server 380, while the query server 380 may provide monitoring communications 342 to the service console server 370. An example embodiment of such a service console server is disclosed below with regard to FIG. 4.

FIG. 4 is a block diagram of an example embodiment of a service console server 470, with attention to functional blocks that may be operated by the service console server 470. A user interface (UI) 436 can be accessed by a managing user via a computing device (not shown) connected via the Internet or another network, and provides the managing user with access to a plurality of services 438:
a) Application Programming Interface (API): Provides the necessary functionality to drive the UI 436.
b) Identity and Access Management: Provides authentication services, including verifying the authenticity of the platform user and authorization, and controlling access to various components of the platform to various platform users.
c) Workload Management: Manages the control plane workloads, such as creating a cluster and destroying a cluster.
d) Cluster Orchestration: Controls operations to create, destroy, start, stop, and relocate the clusters.
e) Account Management: Manages the customer account and users within the customer account.
f) Cluster Observability: Monitors the cluster for usage and failures so that it can be relocated to other physical machines if the failures rate crosses a threshold.

The service console server 470 may also include a data store 444 configured to store a range of data associated with a platform, e.g., platform 260 (FIG. 2), such as performance metrics, operational events (e.g., alerts), logs indicating queries and responses, and operational metadata, for non-limiting examples.

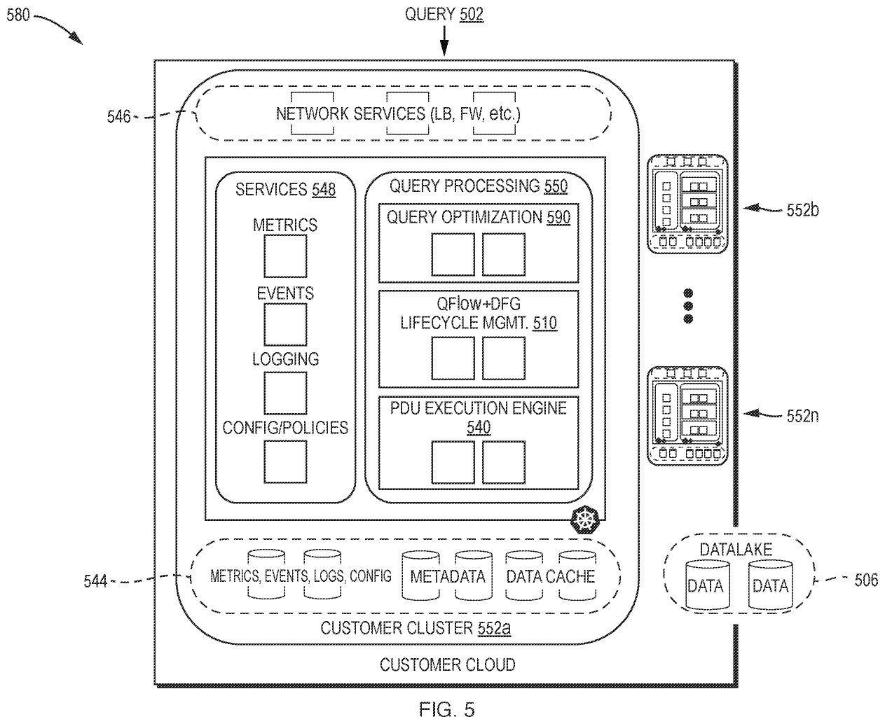

FIG. 5 is a block diagram of a query server 580, with attention to functional blocks that may be operated by the server 580. As a cloud service, the query server 580 may include a plurality of server clusters 552a-n, of which server 552a is shown in detail. Each of the server clusters 552a-n may be communicatively coupled to a data lake, e.g., the data lake 506, 306 (FIG. 3), 206 (FIG. 2), or 106 (FIG. 1A), to allow independent access to data stored thereon. In response to a query, e.g., the query 502, 302 (FIG. 3), 202 (FIG. 2), or 102 (FIG. 1A), the server clusters 552a-n may coordinate to determine an efficient distribution of tasks to process such query, execute analytics tasks, and generate a corresponding response.

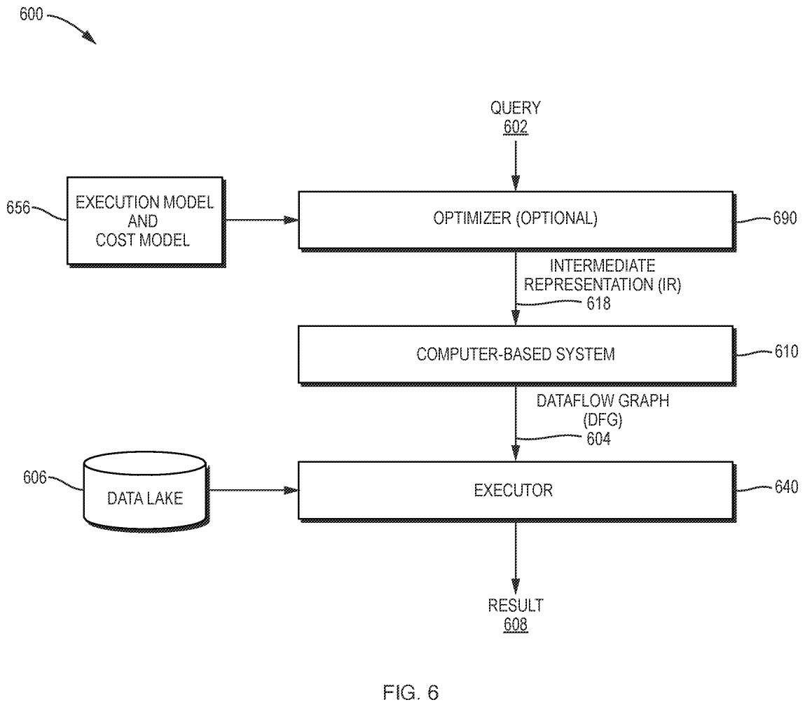

The server cluster 552a is depicted as a plurality of functional blocks that may be performed by a combination of hardware and software as described in further detail below. Network services 546 may be configured to interface with a user device (not shown) across a network to receive a query, return a response, and communicate with a service console server, e.g., the server 370 (FIG. 3) or 470 (FIG. 4). The query services 550 may include a query optimization block 590, a computer-based system 510, and a PDU executor 540. The computer-based system 510 may be the computer-based system 110 or 210, disclosed above with regard to FIGS. 1A-B and 2, respectively. As described further below with reference to FIG. 6, the query services 550 of FIG. 5 operate to generate an IR of a query (optionally including one or more optimizations), produce DFG(s) defining execution of the generated IR, and execute the query.

Continuing with reference to FIG. 5, the management services block 548 may monitor operation of the server cluster 552a, recording performance metrics and events and maintaining a log of the same. The management services block 548 may also govern operation of the query services 550 based on a set of configurations and policies determined by a user. Further, the management services block 548 may communicate with the service console server, e.g., 370 (FIG. 3) or 470 (FIG. 4), to convey performance metrics and events and to update policies as communicated by the server, e.g., 370 or 470. Lastly, a data store 544 may be configured to store the data controlled by the management services block 548, including performance metrics, operational events, logs indicating queries and responses, and operational metadata, for non-limiting examples. The data store 544 may also include a data cache configured to store a selection of data retrieved from the data lake, e.g., 506, 306 (FIG. 3), 206 (FIG. 2), or 106 (FIG. 1A), for use by the query services 550 for executing a query. An example embodiment of a data analysis process that may be performed by the server 580 is disclosed below with regard to FIG. 6.

FIG. 6 is a flow diagram of an example embodiment of a data analysis process 600 that may be performed by a query server, e.g., server 380 (FIG. 3) or 580 (FIG. 5). In the example embodiment of FIG. 6, an optional query optimizer 690 may receive a query, e.g., query 602, 502 (FIG. 5), 302 (FIG. 3), 202 (FIG. 2), or 102 (FIG. 1A), for processing, as well as execution model(s) 656 for reference in optimizing the query. For example, an execution model 656 may specify relevant information on the hardware and software configuration of the PDU executor 158, enabling the query optimizer 156 to adapt an IR to the capabilities and limitations of a PDU executor, e.g., the executor 640, 540 (FIG. 5), 240 (FIG. 2), or 140 (FIG. 1B). Further, a cost model 656 may specify user-defined limitations regarding resources to dedicate to processing a query over a given timeframe. The optional query optimizer 690 may utilize such a cost model 656 to prioritize a query relative to other queries, define a maximum or minimum number of PDUs to be assigned for the query, and/or lengthen or shorten a timeframe in which to process the query. According to an example embodiment, when invoked, the optional query optimizer 690 may apply optimizations such as customized execution operators and/or and rewrite rules, among other examples. According to an example embodiment, the optional query optimizer 690 may also, or alternatively, apply heuristic-based optimizations and/or any suitable known type of optimization, such as a Volcano optimization, for non-limiting example.

The computer-based system 610 may receive an IR 618 (optionally optimized by the query optimizer 690) and generate corresponding DFG(s) 604 that define how the query is to be performed by the PDU executor 640. For example, the DFG(s) 604 may define the particular PDUs to be utilized in executing the query, the specific processing functions to be performed by those PDUs, a sequence of functions connecting inputs and outputs of each function, and compilation of the results to be returned to the user. Finally, the PDU executor 640 may access a data lake, e.g., data lake 606, 506 (FIG. 5), 306 (FIG. 3), 206 (FIG. 2), or 106 (FIG. 1A), perform the query on the accessed data as defined by the DFG(s) 604, and return a corresponding result, e.g., the result 608 or 108 (FIG. 1A). In an embodiment, data lake 606 may be, e.g., Amazon S3®, Microsoft® Azure, PostgreSQL®, or another suitable data lake known to those of skill in the art.

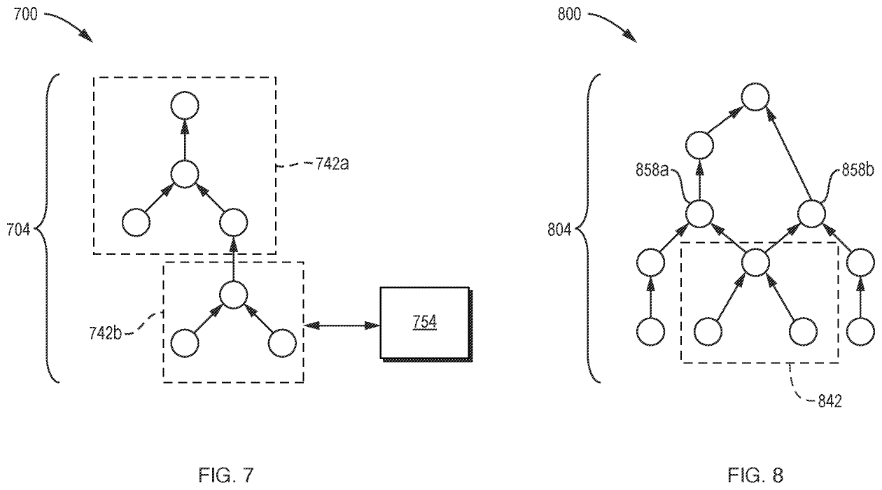

FIG. 7 is a block diagram 700 of an example embodiment of computation pushdown. In the example embodiment of FIG. 7, computation pushdown may be a rewrite rule that is applied by a query optimizer, e.g., the optimizer 590 (FIG. 5) or 690 (FIG. 6). With reference to FIG. 7, the DFG 704 includes computation portions 742a-b. Computation pushdown may include pushing a portion of DFG 704, e.g., computation 742b, down to compute-capable external data source, e.g., data source 754, which may be a compute-capable data source such as a PostgreSQL® data source, among other examples for non-limiting example. Other compute-capable data sources known to those of skill in the art are also suitable.

FIG. 8 is a block diagram 800 of an example embodiment of computation reuse. In the example embodiment of FIG. 8, computation reuse may be a rewrite rule that is applied by a query optimizer, e.g., optimizer 590 (FIG. 5) or 690 (FIG. 6). With reference to FIG. 8, DFG 804 includes nodes 858a-b and partial computation 842. Computation reuse may include configuring a DFG, e.g., 804, so that results of a computation, e.g., 842, are used more than once, for instance, by both node 858a and 858b. Additionally or alternately, partial computations, e.g., 842, may be cached. Further, computation reuse/caching may be either intra-query, i.e., a partial computation is used/cached more than once in a single query, or inter-query, i.e., a partial computation is used/cached in more than one query.

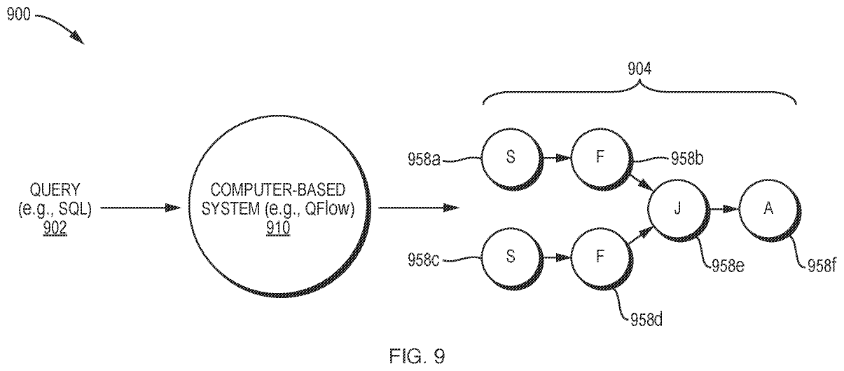

FIG. 9 is a flow diagram of an example embodiment of a process 900 for generating a dataflow graph. The process 900 may be performed by a computer-based system according to embodiments, e.g., computer-based system 910, 610 (FIG. 6), 510 (FIG. 5), 210 (FIG. 2), or 110 (FIGS. 1A-B). With reference to FIG. 9, the computer-based system 910 may receive an input data query, e.g., query 902, 602 (FIG. 6), 502 (FIG. 5), 302 (FIG. 3), 202 (FIG. 2), or 102 (FIG. 1A). The input data query 902 may be received from a framework, such as an Apache Spark framework, Python® framework, Presto framework, SQL framework, or any other suitable framework known to those of skill in the art for non-limiting examples. Continuing with reference to FIG. 9, the system 910 may transform a query plan tree (not shown) into a query strategy tree (not shown), where the query plan tree is constructed from the query 902, which may be associated with a computation workload. The system 910 may compile the query strategy tree into DFG(s), e.g., the at least one DFG 904, 604 (FIG. 6), or 104 (FIG. 1A). The at least one DFG 904 may include dataflow nodes 958a-f. To continue, the system 910 may transmit a DFG of the at least one DFG 904 for execution via a virtual platform (not shown). The system 910 may monitor the execution of the DFG. In addition, the system 910 may output, based on a result (not shown) of the execution monitored, a response (not shown) to the query 902. The result may be received from the virtual platform and may represent computational result(s) of processing the computation workload by the virtual platform.

As shown in FIG. 9, because a DFG(s), e.g., a DFG of the at least one DFG 904, may be executed by the virtual platform that resides at a layer just above a user data lake (not shown), this has the benefit of moving computations (e.g., as specified by a DFG of the at least one DFG 904) near to data in the data lake. Moreover, the process 900 is a non-limiting example of an end-to-end framework to express general-purpose computations (e.g., as specified by the query 902) on so-called “Big Data” that may be stored in a data lake. The system 910 of FIG. 9 may compile user intent-expressed via the query 902 in, e.g., SQL, or other suitable known languages-into distributed physical plan(s), e.g., the at least one DFG 904. In other words, the system 910 may generate code for the virtual platform, which may include a cluster of target execution machine(s) (e.g., Insight Machine(s)). Furthermore, the process 900 facilitates disaggregation of the data stack because, for non-limiting example, the system 910, the virtual platform, and the data lake may each reside in a different layer. Lastly, the process 900 advantageously lacks a single point of failure, while also providing support for multiple coordinator modules to transmit DFGs for execution via a virtual platform and monitor execution of the DFG(s) as part of a QFlow runtime module according to the present disclosure, e.g., runtime module 116 (FIG. 1A). The former is because computation may be distributed across a plurality of DFGs of the at least one DFG 904, so the process 900 does not depend on successful execution of any particular DFG. Likewise, the latter—support for multiple coordinator modules—is enabled by the existence of multiple DFGs that may be included in the at least one DFG 904. Further, if a first coordinator module submits a DFG for execution to an Insight VM and then fails (such as due to a network issue and/or power outage) while overseeing the DFG execution, a second coordinator module can take over for the failed first coordinator module and resume overseeing the DFG execution.

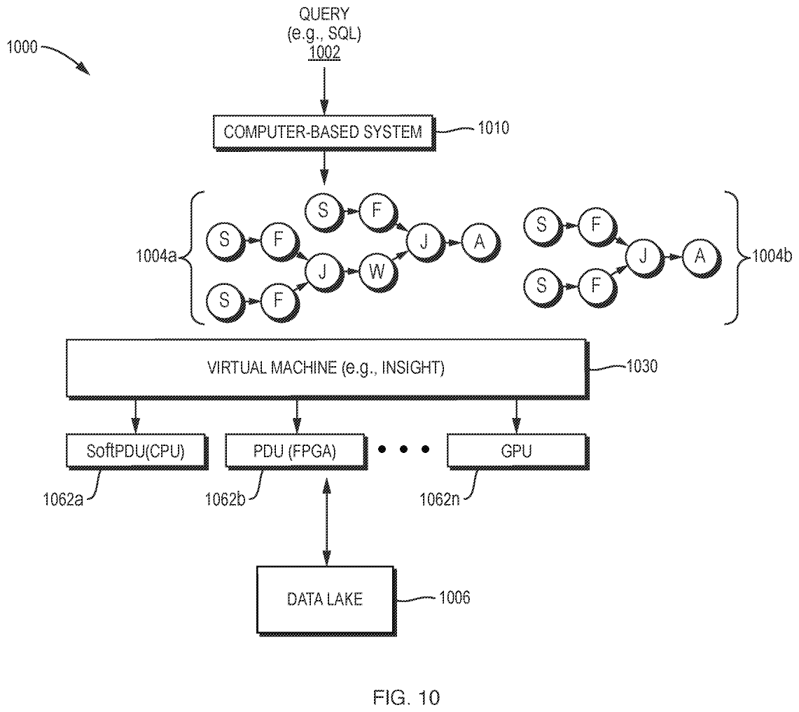

FIG. 10 is a simplified block diagram of an example embodiment of a disaggregated data analytics stack 1000 with domain-specific computing. The stack 1000 includes a computer-based system, e.g., the computer-based system 1010, 910 (FIG. 9), 610 (FIG. 6), 510 (FIG. 5), 210 (FIG. 2), or 110 (FIG. 1A). With reference to FIG. 10, the computer-based system 1010 may receive an input data query, e.g., the query 1002, 902 (FIG. 9), 602 (FIG. 6), 502 (FIG. 5), 302 (FIG. 3), 202 (FIG. 2), or 102 (FIG. 1A). The input data query 1002 may be received from a framework such as an Apache Spark, Python, Presto, or SQL framework, or any other suitable framework known to those of skill in the art for non-limiting examples.

Continuing with reference to FIG. 10, the system 1010 may transform a query plan tree (not shown) into a query strategy tree (not shown), where the query plan tree is constructed from the query 1002, which may be associated with a computation workload. The system 1010 may compile the query strategy tree into DFG(s), e.g., DFGs 1004a-b, 904 (FIG. 9), 604 (FIG. 6), or 104 (FIGS. 1A-B). The DFGs 1004a-b may include dataflow nodes, e.g., the nodes 958a-f (FIG. 9). The dataflow nodes 958a-f may include machine code (not shown) in a domain-specific ISA (instruction set architecture) for data computing. The system 1010 may transmit the DFGs 1004a-b for execution via a virtual platform (not shown). The system 1010 may monitor the execution of DFGs 1004a-b. In addition, the system 1010 may output, based on a result (not shown) of the execution monitored, a response (not shown) to the query 1002. The result may be received from the virtual platform and may represent computational result(s) of processing the computation workload by the virtual platform.

Continuing with reference to FIG. 10, as part of the virtual platform, the stack 1000 may also include a VM 1030 with resource(s), e.g., SoftPDU 1062a (i.e., a software-based PDU executing on a CPU), a PDU 1062b (i.e., a hardware-based PDU implemented via a FPGA (field-programmable gate array)), and a GPU (graphics processing unit) 1062n. According to an example embodiment, the system 1010 may select, based on resource(s) associated with an action node of action node(s) of the query strategy tree, a VM, e.g., VM 1030, of VM(s) of the virtual platform. The system 1010 may translate the action node of the action node(s) of the query strategy tree into a dataflow graph, e.g., DFG 1004a or 1004b, of the DFG(s). The system 1010 may assign the DFG, e.g., DFG 1004a or 1004b, for execution by the VM selected, e.g., VM 1030. According to another embodiment, the system 1010 may select the VM based on a workload of the VM, resource(s), e.g., 1062a-n, of the VM for processing the computation workload, or compatibility of the computation workload with the VM for non-limiting examples.

Continuing with reference to FIG. 10, according to an example embodiment, the stack 1000 may further include a data lake, e.g., the data lake 1006, 606 (FIG. 6), 306 (FIG. 3), 206 (FIG. 2), or 106 (FIG. 1A). The data lake 1006 may be, e.g., a Microsoft® Azure, Amazon S3®, or Google Cloud Storage™ data lake, or another suitable data lake known to those of skill in the art for non-limiting examples.

According to an example embodiment, the system 1010 may adapt the query strategy tree based on statistic(s) associated with the computation workload. A statistic of the statistic(s) may include a runtime statistical distribution of data values in a data source, e.g., the data lake 1006, associated with the computation workload. Further, the adapting may be responsive to identifying a mismatch between the runtime statistical distribution of the data values and an estimated statistical distribution of the data values. According to an example embodiment, the adapting may include regenerating a dataflow graph, e.g., DFG 1004a or 1004b, of the DFG(s) by reordering dataflow nodes, e.g., 958a-f (FIG. 9), of the DFG, removing an existing dataflow node of the DFG, or adding a new dataflow node to the DFG.

Continuing with reference to FIG. 10, according to an example embodiment, the disaggregated data analytics stack 1000 may provide one or more benefits, such as improved efficiency and agility, among other examples for non-limiting examples. The disaggregated data analytics stack 1000 may further supply an end-to-end framework to express general-purpose computations on Big Data.

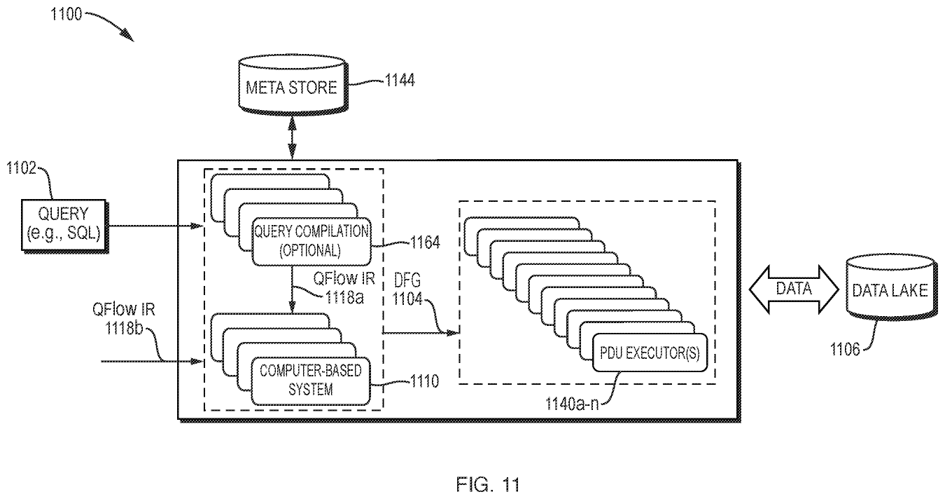

FIG. 11 is a simplified block diagram of an example embodiment of a scaled and distributed architecture 1100 for a data analytics pipeline. In the example embodiment of FIG. 11, the architecture 1100 includes a computer-based system 1110, e.g., QFlow, one or more execution node(s), e.g., PDU executor(s) 1140a-n, and a data lake 1106; optionally, the architecture 1100 may also include a query compilation module 1164, e.g., for SQL control for non-limiting example. According to an example embodiment, an input data query 1102, e.g., a SQL query for non-limiting example, may be received from a user via an application, such as a business intelligence (BI) tool, an integrated development environment (IDE), or another suitable application known to those of skill in the art for non-limiting examples. According to an example embodiment, as an optional procedure, the compilation module 1164 may transform a received query 1102 into an IR 1118a, e.g., a common QFlow IR, and the IR 1118a may be sent to the system 1110. Further, according to yet another example embodiment, as an alternative to receiving the IR 1118a optionally generated via the compilation module 1164, the system 1110 may instead receive the IR 1118b directly from a framework, such as a Presto, Apache Spark, or Apache Kafka framework, or another suitable framework known to those of skill in the art.

Continuing with reference to FIG. 11, the computer-based system 1110 may compile the IR, e.g., 1118a or 1118b, into at least one DFG 1104. According to an example embodiment, a DFG of the resulting at least one DFG 1104 may be a highly optimized and/or data-aware DFG. According to an example embodiment, a DFG of the at least one DFG 1104 may be executed via one or more execution node(s) 1140a-n. The execution node(s) 1140a-n may be PDU-powered execution node(s) and/or may run on accelerated server instance(s) in a cloud, e.g., the virtual platform 120 (FIG. 1A) for non-limiting example. Further, according to an example embodiment, during execution, a DFG of the at least one DFG 1104 may receive input data from and/or output computational results to a data lake 1106, which may be, e.g., an Apache Hudi™, Apache Iceberg™, Delta Lake, or Amazon S3 data lake, or another suitable data lake known to those of skill in the art for non-limiting examples.

According to an example embodiment, the architecture 1100 may include a meta store 1144 that provides, for example, a list of available VM(s), e.g., VM(s) 130 (FIG. 1B) or 1030 (FIG. 10), and their capabilities, a list of distributed cache servers, etc., to aid in compiling the IR 1118a-b into DFG 1104 and scheduling the generated DFG 1104 on the execution node(s) 1140a-n.

The computer-based system 1110 may transform a query plan tree, e.g., the IR 1118a or 1118b, into a query strategy tree (not shown), where the query plan tree 1118a or 1118b may be constructed from the query 1102, which may be associated with a computation workload. The system 1110 may compile the query strategy tree into DFG(s), e.g., DFG 1104. To continue, the system 1110 may transmit the DFG 1104 for execution via a virtual platform (not shown). The system 1110 may then monitor the execution of DFG 1104. In addition, the system 1110 may output, based on a result (not shown) of the execution monitored, a response (not shown) to the input data query 1102. The result is received from the virtual platform and represents computational result(s) of processing the computation workload by the virtual platform.

According to an example embodiment, the computer-based system 1110 may select, based on resource(s) associated with an action node of action node(s) of the query strategy tree, a VM of VM(s) of the virtual platform. The system 1110 may translate the action node of the action node(s) of the query strategy tree into a DFG, e.g., 1104, of the DFG(s). In another embodiment, the system 1110 may assign the DFG 1104 for execution by the VM selected. The VM selected may include PDU based execution node(s), e.g., the execution node(s) 1140a-n.

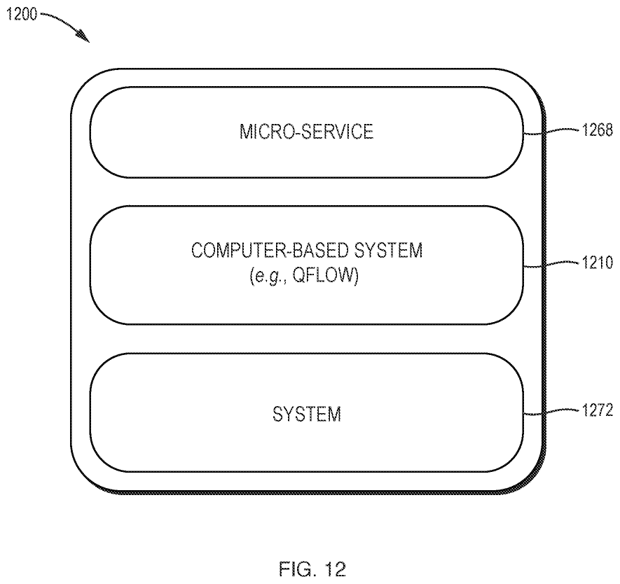

FIG. 12 is a block diagram of an example embodiment of an architecture 1200 for a computer-based system according to an embodiment. With reference to FIG. 12, the architecture 1200 includes a micro-service 1268, computer-based system 1210, and system 1272. In an example embodiment, the micro-service 1268 may provide an API endpoint for the computer-based system 1210, such as a Hypertext Transfer Protocol (HTTP) or GraphQL endpoint for non-limiting examples. Other endpoint types known to those of skill in the art are also suitable.

According to an example embodiment, the computer-based system 1210 may include an IR-to-DFG compiler, e.g., the compiler module 114 (FIG. 1A), that, for instance, compiles a plan in QFlow IR, e.g., IR 118 (FIG. 1B), 618 (FIG. 6), or 1118a-b (FIG. 11), to Insight DFG(s), e.g., DFG(s) 104 (FIG. 1A), 604 (FIG. 6), 704 (FIG. 7), 804 (FIG. 8), 904 (FIG. 9), 1004a-b (FIG. 10), or 1104 (FIG. 11). The compiler, e.g., 114, may also perform resource assignment, and, optionally, apply optimization(s), e.g., via optimizer 690 (FIG. 6). Further, according to an example embodiment, the computer-based system 1210 may include a DFG executor/monitor, e.g., the runtime module 116 (FIG. 1A), that, for instance, schedules DFG(s), e.g., 104, 604, 704, 804, 904, 1004a-b, or 1104, to executors, e.g., executor 140 (FIG. 1B), 240 (FIG. 2), 540 (FIG. 5), 640 (FIG. 6), or 1140 (FIG. 11), and monitors them. To continue, according to an example embodiment, the system 1272 may provide features and functionality, such as high-performance network protocol stacks (e.g., TLS/HTTP), which may include, for instance, zero copy, high performance storage access, and a high-performance task scheduler, which may, for instance, be Quality of Service (QOS) controlled for non-limiting example.

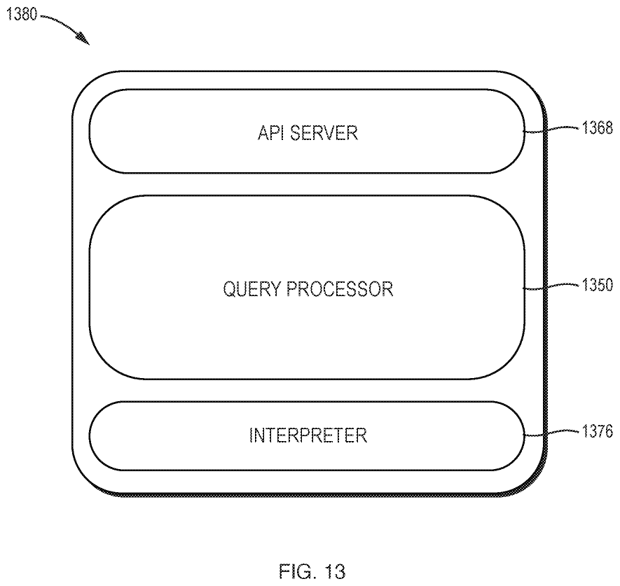

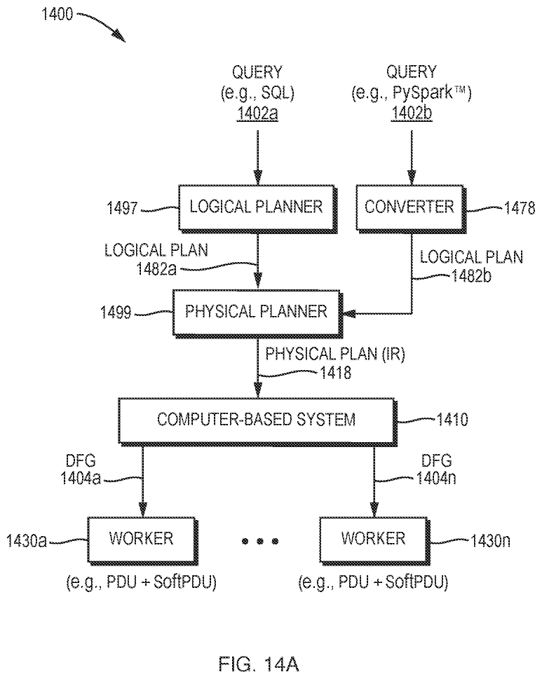

FIG. 13 is a block diagram of an example embodiment of a query server architecture 1380. With reference to FIG. 13, the architecture 1380 includes an API server 1368, query processor 1350, and interpreter 1376. According to an example embodiment, the API server 1368 may provide an API endpoint for a query processor 1350, such as a Java Database Connectivity (JDBC) or Open Database Connectivity (ODBC) API for non-limiting examples. Other API types known to those of skill in the art are also suitable. According to an example embodiment, the API 1368 may be configured to receive a query, e.g., query 102 (FIG. 1A), 202 (FIG. 2), 302 (FIG. 3), 502 (FIG. 5), 602 (FIG. 6), 902 (FIG. 9), 1002 (FIG. 10), or 1102 (FIG. 11).

According to an example embodiment, the query processor 1350 may implement functionality, such as SQL to AST compilation, AST to logical plan conversion/translation, and logical plan to QFlow IR (physical plan) conversion/translation, among other examples for non-limiting examples. According to an example embodiment, the query processor 1350 may also access a meta store or data store, e.g., the data store 544 (FIG. 5). Lastly, in an embodiment, query processor 1350 may apply optional logical plan and/or QFlow IR optimization(s), such as via an optimizer, e.g., optimizer 690 (FIG. 6). According to an example embodiment, the interpreter 1376 may provide functionality that includes executing the query processor 1350.

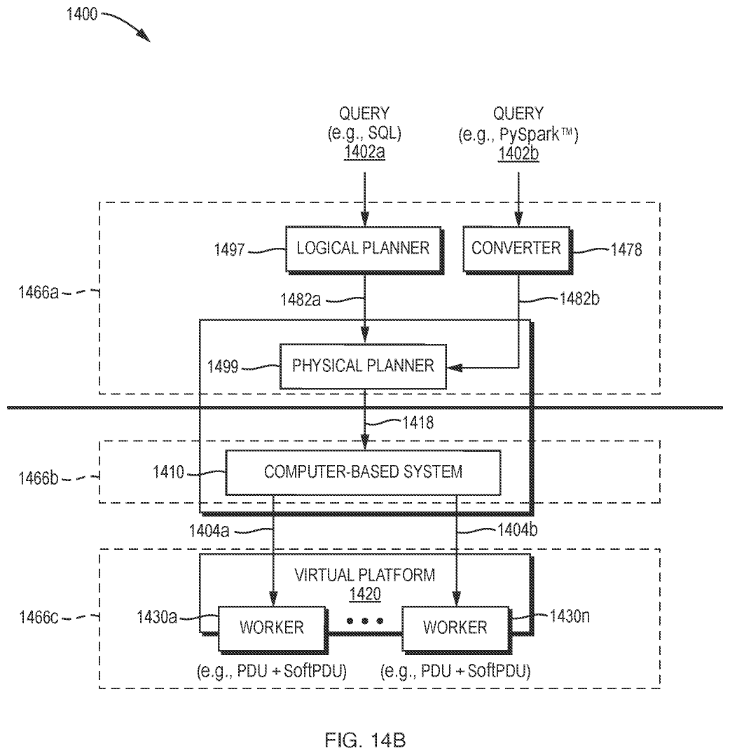

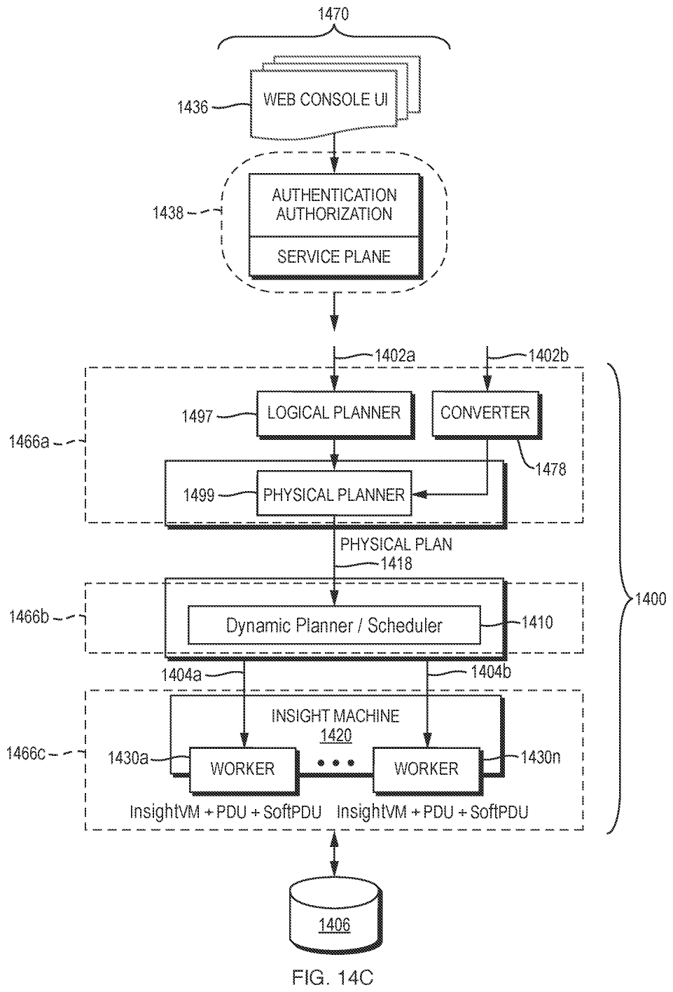

FIG. 14A is a block diagram of an example embodiment of a data analytics compute plane 1400. With reference to FIG. 14A, a query 1402a or 1402b may be received, e.g., from a user, such as the user 114 (FIG. 1A). The query 1402a may be, e.g., a SQL query, while query 1402 may be, e.g., a PySpark™ query for non-limiting examples. Other query types known to those of skill in the art are also suitable. According to an embodiment, if the query 1402a is, e.g., a SQL query, then logical planner 1497 may convert/translate/compile the query 1402a to a logical plan 1482a. As an optional, intermediate action, the query 1402a may first be compiled to an AST (not shown), e.g., via the query processor 1350 (FIG. 13) or 550 (FIG. 5), after which the AST may then be transformed into the logical plan 1482a. Similarly, according to an example embodiment, if the query 1402b is, e.g., a PySpark query, then the converter 1478 may translate or compile the query 1402b into a logical plan 1482b. According to an example embodiment, the physical planner 1499 may convert/translate/compile the logical plan 1482a or 1482b into a physical plan 1418, e.g., IR. According to an example embodiment, the computer-based system 1410 may transform or compile the IR 1418 into the DFG(s) 1404a-n. According to an example embodiment, the DFG(s) 1404a-n may be variously executed by worker node(s) 1430a-n. A worker node, e.g., 1404a or 1404n, may be configured with, for instance, a PDU and/or SoftPDU; however, embodiments are not so limited and other configurations of worker nodes are also contemplated.

FIG. 14B is a block diagram of an example embodiment of different components of the example embodiment of the data analytics compute plane 1400 of FIG. 14A, disclosed above. With reference to FIGS. 14A and 14B, the compute plane 1400 may include three components 1466a-c for non-limiting example. According to an example embodiment, a first component 1466a may include or bundle a logical planner 1497, converter 1478, and/or physical planner 1499; a second component 1466b may include a computer-based system 1410; and a third component 1466c may include a virtual platform 1420, e.g., an Insight Machine, having worker node(s) 1430a-n.

According to an example embodiment, the compute plane 1400 may be configured such that the second and third components 1466b-c are maintained/operated separately and/or at a distance/remotely from first component 1466a, for example, in separate physical and/or network location(s). This is convenient for an application end-user, who can still interact locally with the first component 1466a. Further, it provides security because the second and third components 1466b-c are remote (e.g., as measured by physical and/or network distance) from an end-user location and, thus, cannot be compromised by an intruder at the end-user location. The separation of the second and third components 1466b-c is also efficient and convenient for the end-user, because the end-user is freed from the responsibility of maintaining such components. Further, it is efficient because compute-intensive functionality of the second and/or third components 1466b-c takes place in a cloud or other comparable environment, in closer proximity to where data is stored in an end-user's data lake.

Continuing with reference to FIG. 14B, according to an example embodiment, the computer-based system 1410 may transform a query plan tree, e.g., IR 1418, into a query strategy tree (not shown), where the query plan tree 1418 may be constructed from an input data query, e.g., query 1402a or 1402b, which may be associated with a computation workload. The system 1410 may compile the query strategy tree into DFG(s), e.g., the DFG(s) 1404a-b. The system 1410 may transmit the DFG(s) 1404a-b for execution via a virtual platform, e.g., the virtual platform 1420. The system 1410 may monitor the execution of the DFG(s) 1404a-b. In addition, the system 1410 may output, based on a result (not shown) of the execution monitored, a response (not shown) to the input data query 1402a or 1402b. The result may be received from the virtual platform 1420 and may represent computational result(s) of processing the computation workload by the virtual platform 1420.

According to an example embodiment, the computer-based system 1410 may generate, based on the input data query 1402a or 1402b associated with the computation workload, a query logic tree, e.g., a logical plan 1482a or 1482b, including query element node(s). The system 1410 may further construct, based on the query logic tree generated 1482a or 1482b, the query plan tree 1418 in an IR. The IR may be compatible with computation workload type(s), including a type of the computation workload associated with the input data query 1402a or 1402b. In addition, the IR may be architecture-independent and may represent a query operation(s) of the input data query 1402a or 1402b.

Continuing with reference to FIG. 14B, according to an example embodiment, the computer-based system 1410 may select, based on resource(s) associated with an action node of action node(s) of the query strategy tree, a VM of at least one VM(s), e.g., VM(s) 1430a-n, of the virtual platform 1420.

FIG. 14C is a block diagram of an example embodiment of disaggregation of the example embodiment of the data analytics compute plane 1400 of FIG. 14A. With reference to FIG. 14C, a separation of the components 1466b-c from the component 1466a is graphically depicted, which is described in more detail above in relation to FIG. 14B. Notably, according to an example embodiment, the components 1466a and 1466b-c are separated such that the latter are located closer, e.g., in terms of physical and/or network distance, to the data lake 1406 (e.g., belonging to a data plane (not shown)). Further, continuing with reference to FIG. 14C, an example embodiment of the control plane 1470 may interact or interface with an example embodiment of the compute plane 1400. According to an example embodiment, the control plane 1470 may include a web console UI 1436 and/or service plane 1438, the latter providing functionality such as authentication and/or authorization, among other examples for non-limiting examples.

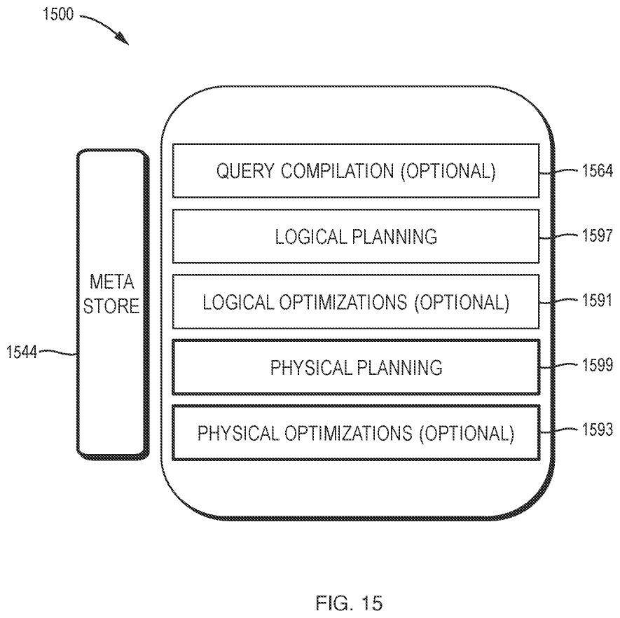

FIG. 15 is a block diagram of an example embodiment of a first phase 1500 of a data analytics pipeline. In the example embodiment of FIG. 15, a query, e.g., query 102 (FIG. 1A), 202 (FIG. 2), 302 (FIG. 3), 502 (FIG. 5), 602 (FIG. 6), 902 (FIG. 9), 1002 (FIG. 10), 1102 (FIG. 11), or 1402a-b (FIG. 14A), may be received by an API server, e.g., the API server 1368 (FIG. 13). According to an example embodiment, the API server 1368 may provide an API endpoint for a query processor, e.g., 1350 (FIG. 13), such as a JDBC or ODBC API for non-limiting examples. Other API types known to those of skill in the art are also suitable. According to an example embodiment, the first phase 1500 may include optional query compilation 1564. According to an example embodiment, the optional query compilation 1564 may, for non-limiting example, compile, e.g., a SQL query, into an AST, such as via the query processor 1350 of FIG. 13.

Continuing with reference to FIG. 15, according to an example embodiment, the first phase 1500 may include logical planning 1597, which may, for instance, take the query (e.g., 102, 202, 302, 502, 602, 902, 1002, 1102, or 1402a-b) as input directly, or, instead, take as input the AST resulting from the optional query compilation 1564. According to an example embodiment, the logical planning 1597 may generate as output a logical plan, e.g., logical plan 1482a-b (FIG. 14A). According to an example embodiment, the optional logical optimization(s) 1591 may be applied to the logical plan.

The first phase 1500 may include the physical planning 1599, which may convert the logical plan into a physical plan/IR, e.g., IR 118 (FIG. 1B), 618 (FIG. 6), 1118a-b (FIG. 11), or 1418 (FIG. 14A). According to an example embodiment, the optional physical optimization(s) 1593 may be applied to the resulting IR. Further, according to an example embodiment, the physical planning 1599 may apply optional physical optimization(s) 1593 based on information regarding capabilities of a VM, e.g., VM 130 (FIG. 1B), 1030 (FIG. 10), or 1430a-n (FIG. 14A), such as an Insight VM, and/or capabilities of an execution unit, e.g., PDU 140 (FIG. 1B), 240 (FIG. 2), 540 (FIG. 5), 640 (FIG. 6), or 1140 (FIG. 11).

Continuing with reference to FIG. 15, according to an example embodiment, the logical planning 1597 and optional logical optimization(s) 1591 may obtain information from a meta store 1544, such as metadata, schema(s), table(s), etc. to convert the query (or, alternately, the AST resulting from the optional query compilation 1564) into a logical plan and, optionally, perform logical optimization(s). According to an example embodiment, the IR generated by the physical planning 1599 (and optionally having applied physical optimization(s) 1593) may be serialized via known methods and moved closer to a data source, e.g., such as the data source 106 (FIG. 1A), 206 (FIG. 2), 306 (FIG. 3), 606 (FIG. 6), 1006 (FIG. 10), 1106 (FIG. 11), or 1406 (FIG. 14C), that may be data lakes for non-limiting example. According to an example embodiment, this may facilitate disaggregation, for example as described hereinabove in relation to FIG. 14C.

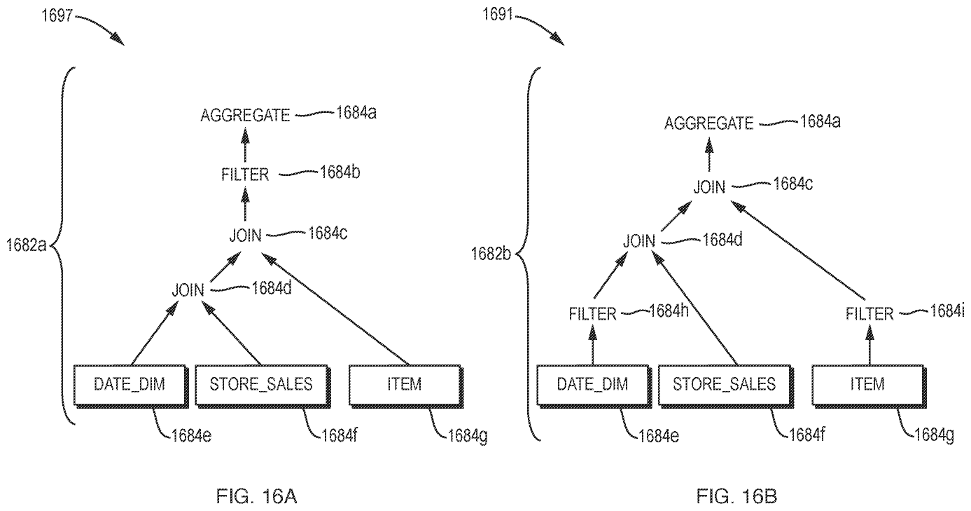

FIGS. 16A and 16B are block diagrams of example embodiments of a logical planning 1697 and an optional logical optimization 1691, respectively. With reference to FIG. 16A, a logical plan 1682a may be generated via the logical planning 1697 that may include nodes 1684a-g. According to an example embodiment, 1684a may be an aggregation node, 1684b may be a filtering node, 1684c-d may be join nodes, and 1684e, 1684f, and 1684g may be data input nodes (e.g., for date, sales, and product data, respectively). However, embodiments are not so limited, and other types of nodes are also contemplated. To continue, in the example embodiment of FIG. 16A, the node 1684d may join inputs from nodes 1684e and 1684f, while the node 1684c may, in turn, join an output of the node 1684d with an input from the node 1684g. Further, according to an example embodiment, data from nodes 1684e, 1684f, and 1684g may be sorted, for instance, by year, amount, and brand identifier, respectively, for non-limiting examples.

With reference to FIGS. 16A and 16B, according to an example embodiment, the optional logical optimization 1691 may be applied to the logical plan 1682a of FIG. 16A which may result in an optimized logical plan 1682b. According to an example embodiment, the logical plan 1682b may include original nodes 1684a and 1684c-g from a plan 1682a; however, as a result of optimization 1691, which may be, e.g., a logical rewrite or push down (such as described hereinabove in relation to FIG. 7), single filtering node 1684b between nodes 1684a and 1684c, and may be replaced with two filtering nodes, 1684h and 1684i, the former of which may be included between the nodes 1684d and 1684e, while the latter of which may be included between the nodes 1684c and 1684g.

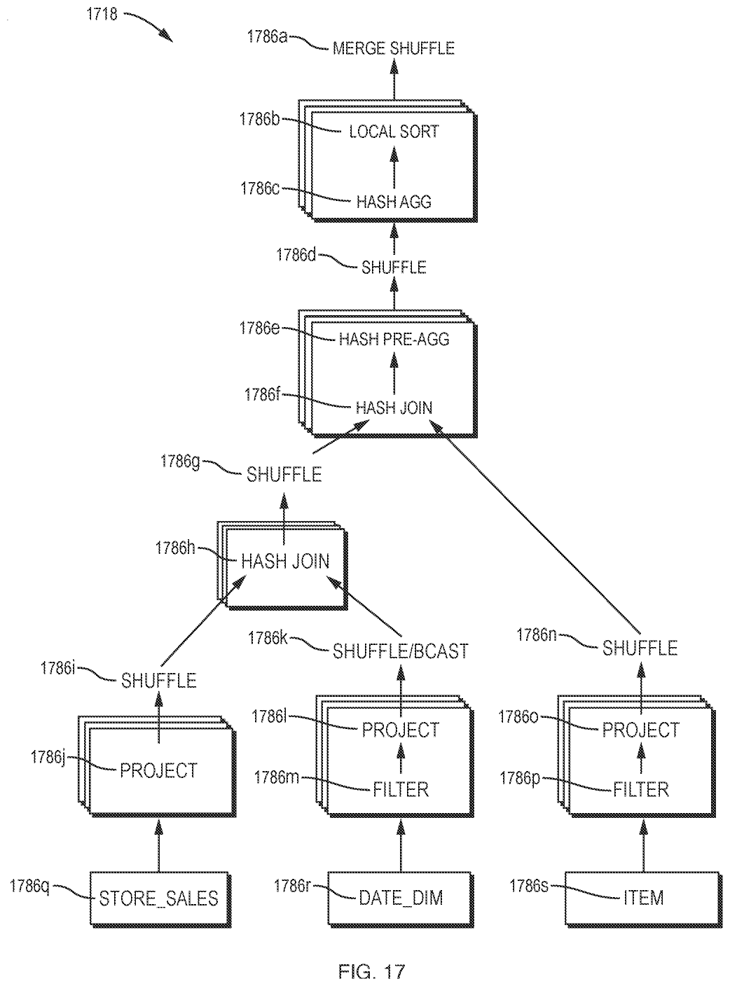

FIG. 17 is a block diagram of an example embodiment of a physical plan generation and optional physical optimization for the logical plan 1682b of FIG. 16B. In an example embodiment, as shown in FIG. 17, the physical plan generation, and, optionally, the physical optimization, performed on the logical plan 1682b may result in the physical plan/IR 1718. According to an example embodiment, the optional physical optimization may be a PDU-aware cost-based optimization; however, embodiments are not so limited and other optimization types are also contemplated. To continue, according to an example embodiment, the IR 1718 may contain nodes 1786a-s. According to an example embodiment, the nodes 1786a-c may correspond to the node 1684a; the nodes 1786d-f may correspond to the node 1684c; the nodes 1786g-h may correspond to the node 1684d; the nodes 1786i-j and 1786q may correspond to the node 1684f; the nodes 1786k-m and 1786r may correspond to the nodes 1684h and 1684e; and the nodes 1786n-p and 1786s may correspond to nodes 1684i and 1684g.

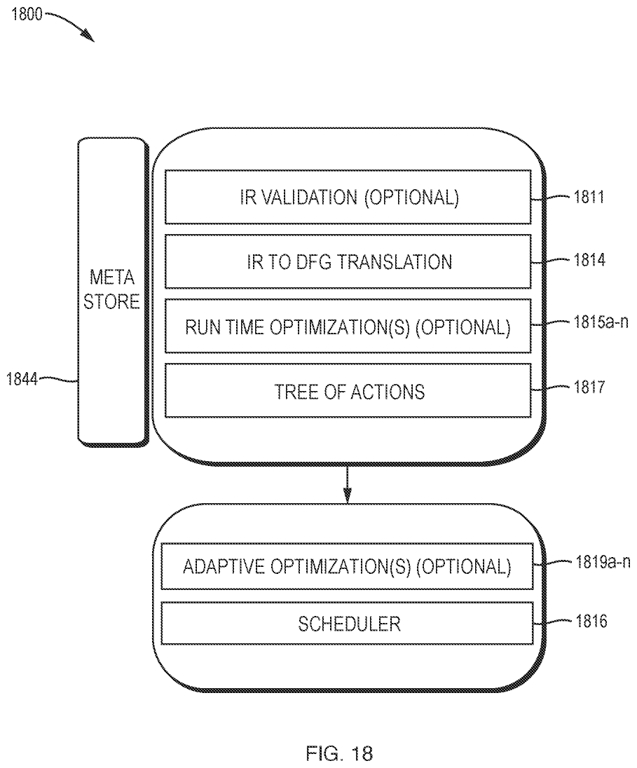

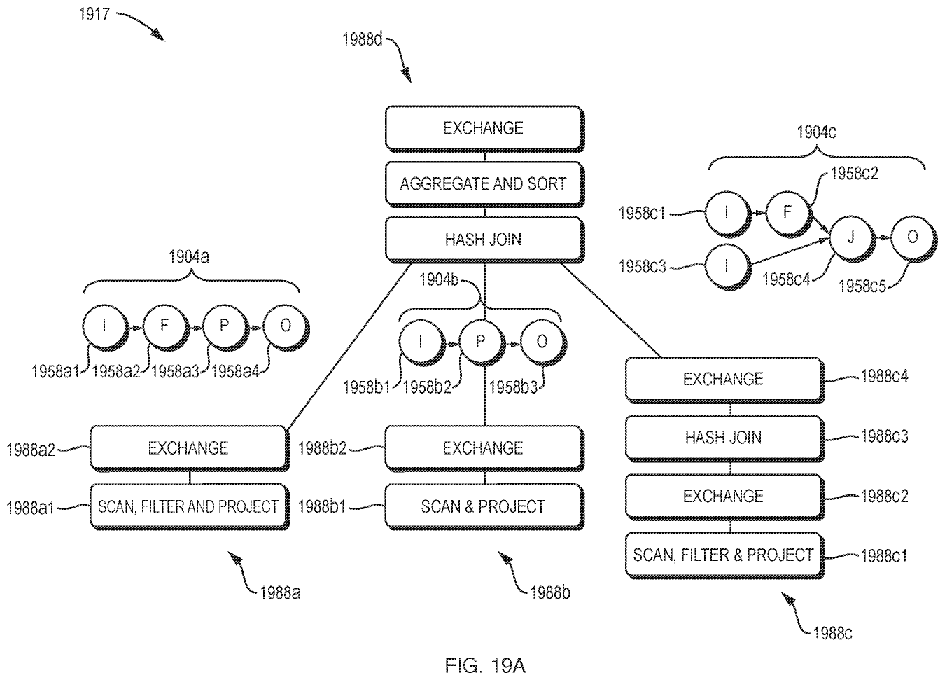

FIG. 18 is a block diagram of an example embodiment of a second phase 1800 of a data analytics pipeline. According to an example embodiment, the second phase 1800 may be implemented by a computer-based system, e.g., system 110 (FIG. 1A), 210 (FIG. 2), 510 (FIG. 5), 610 (FIG. 6), 910 (FIG. 9), 1010 (FIG. 10), 1110 (FIG. 11), 1210 (FIG. 12), or 1410 (FIG. 14A). According to an example embodiment, the system may receive a physical plan or IR, e.g., IR 118 (FIG. 1B), 618 (FIG. 6), 1118a-b (FIG. 11), or 1718 (FIG. 17). According to another example embodiment, after the optional validation 1811 of the received IR, the second phase 1800 may include compiling or translating 1814 the IR into a tree of actions 1817, wherein each action may contain a DFG, e.g., DFG 104 (FIG. 1A), 604 (FIG. 6), 704 (FIG. 7), 804 (FIG. 8), 904 (FIG. 9), 1004a-b (FIG. 10), 1104 (FIG. 11), or 1404a-n (FIG. 14A). According to an example embodiment, the tree of actions 1817 may be configured to capture one or more dependencies in execution of an input data query, e.g., query 102 (FIG. 1A), 202 (FIG. 2), 302 (FIG. 3), 502 (FIG. 5), 602 (FIG. 6), 902 (FIG. 9), 1002 (FIG. 10), 1102 (FIG. 11), or 1402a-b (FIG. 14A). To continue, according to another example embodiment, the second phase 1800 may, optionally, include applying one or more runtime optimization(s) 1815a-n and/or one or more adaptive optimization(s) 1819a-n to the tree of actions 1817. According to an example embodiment, the second phase 1800 may further include using a scheduler 1816 to transmit the DFG(s) (i.e., of the tree of actions 1817) for execution via a virtual platform, e.g., the virtual platform 120 (FIG. 1A) or 1420 (FIG. 14B), and monitor execution of the DFG(s).

Continuing with reference to FIG. 18, according to an example embodiment, the scheduler 1816 may be fault-tolerant, e.g., the scheduler 1816 may detect VM failures and rerun jobs on different VMs. For example, the scheduler 1816 may be configured to detect an execution failure of a DFG on a first VM of a virtual platform and assign the DFG for execution on a second VM of the virtual platform.

According to an example embodiment, the second phase 1800 may utilize a meta store 1844 that may provide, for non-limiting examples, a list of available VM(s), e.g., VM(s) 130 (FIG. 1B), 1030 (FIG. 10), or 1430a-n (FIG. 14A), and their capabilities, a list of distributed cache servers, etc., to aid in translating 1814 the IR into DFG(s) and scheduling 1816 the generated DFG(s).

Continuing with reference to FIG. 18, according to another example embodiment, the computer-based system may transform a query plan tree (not shown) into a query strategy tree, e.g., the tree of actions 1817, where the query plan tree is constructed from an input data query (not shown), which may be associated with a computation workload. The system may compile 1814 the query strategy tree 1817 into DFG(s) (not shown). The system may transmit the DFG(s) for execution via a virtual platform (not shown). The system may then monitor the execution of DFG(s) 1404a-b. In addition, the system 1410 may output, based on a result (not shown) of the execution monitored, a response (not shown) to the input data query. The result may be received from the virtual platform and may represent a computational result(s) of processing the computation workload by the virtual platform.

According to an example embodiment, the computer-based system may apply optimization(s), e.g., optional runtime optimization(s) 1815a-n, to the query strategy tree 1817. According to an example embodiment, the optimization(s) 1815a-n may include a node-level optimization, an expression-level optimization, or a combination thereof for non-limiting examples.

According to another example embodiment, the computer-based system may adapt the query strategy tree 1817 based on at least one statistic associated with the computation workload. According to an example embodiment, adapting the query strategy tree 1817 may include applying the one or more optional adaptive optimization(s) 1819a-n to the tree of actions 1817.

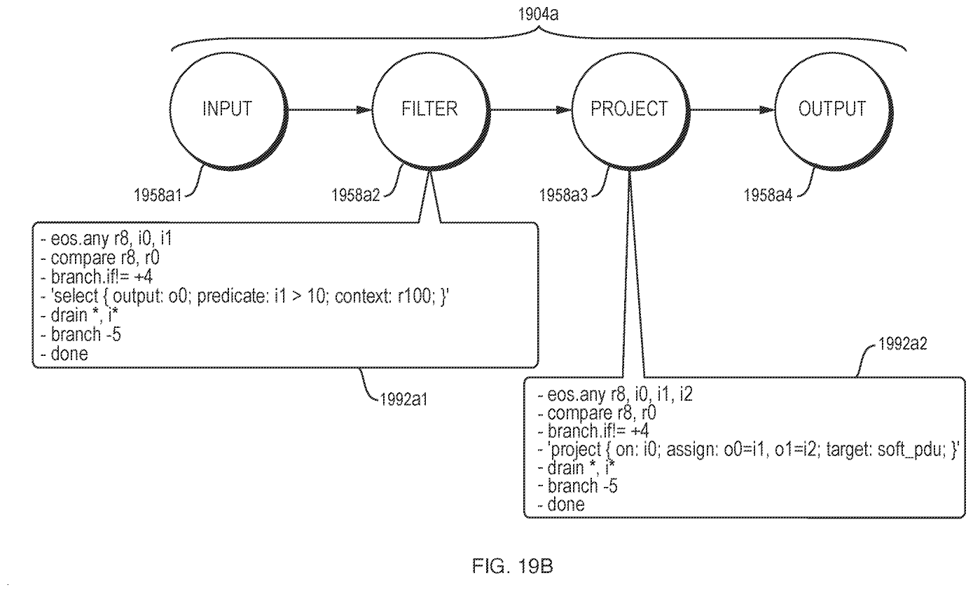

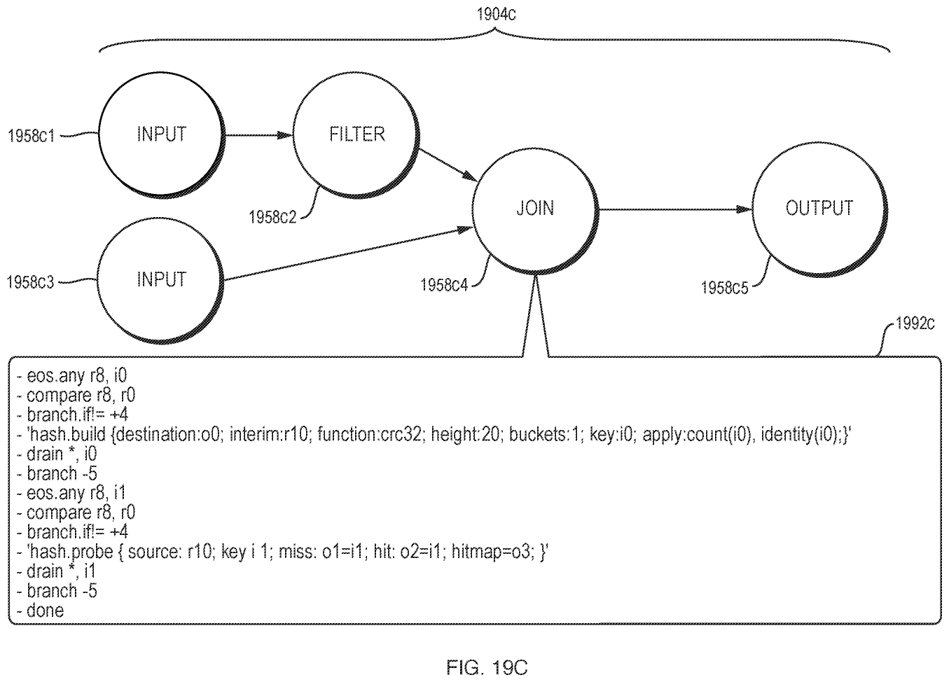

FIG. 19A is a block diagram of an example embodiment of a tree of actions 1917. With reference to FIG. 19A, a tree 1917 may include child action nodes 1988a-c and a root action node 1988d. According to an example embodiment, a first action node 1988a may include subactions 1988a1-2, a second action node 1988b may include subactions 1988b1-2, and a third action node 1988c may include subactions 1988c1-4. According to an example embodiment, the DFG 1904a may correspond to the first action node 1988a, the DFG 1904b may correspond to the second action node 1988b, and the DFG 1904c may correspond to the third action 1988c node.

Further, according to an example embodiment, the DFG 1904a may include dataflow nodes 1958a1-3 (e.g., input, filter, project operations) and 1958a4 (e.g., output operation) that correspond to the subactions 1988a1 (e.g., scan, filter, project operations) and 1988a2 (e.g., exchange operation), respectively; the DFG 1904b may include dataflow nodes 1958b1-2 (e.g., input, project operations) and 1958b3 (e.g., output operation) that correspond to the subactions 1988b1 (e.g., scan, project operations) and 1988b2 (e.g., exchange operation), respectively; and the DFG 1904c may include dataflow nodes 1958c1-2 (e.g., input, filter operations), 1958c3 (e.g., input operation), 1958c4 (e.g., join operation), and 1958c5 (e.g., output operation) that correspond to the subactions 1988cl (e.g., scan, filter, project operations), 1988c2 (e.g., exchange operation), 1988c3 (e.g., hash join operation), and 1988b2 (e.g., exchange operation), respectively. According to an example embodiment, the tree 1917 may be handed over to a runtime module or scheduler, e.g., the runtime 116 (FIG. 1A) or 1816 (FIG. 18), for execution on a virtual platform, e.g., the virtual platform 120 (FIG. 1A) or 1420 (FIG. 14B).

According to an example embodiment, a data structure may be used to represent the tree of actions 1917. In an example embodiment, the data structure may include an identifier (ID) field (e.g., for a numeric or other suitable identifier) as well as a pointer or reference to a root action node, e.g., 1988d. In another example embodiment, the data structure may also include one or more optional field(s), such as a connection ID, a statement ID, a statement text, a statement plan, and/or a logging level (the latter for, e.g., auditing and/or debugging purposes), for non-limiting examples. According to yet another example embodiment, the optional logging level field may be an unsigned 64-bit integer (u64) or other suitable known data type, while the other optional field(s) may be strings or other suitable known data types.

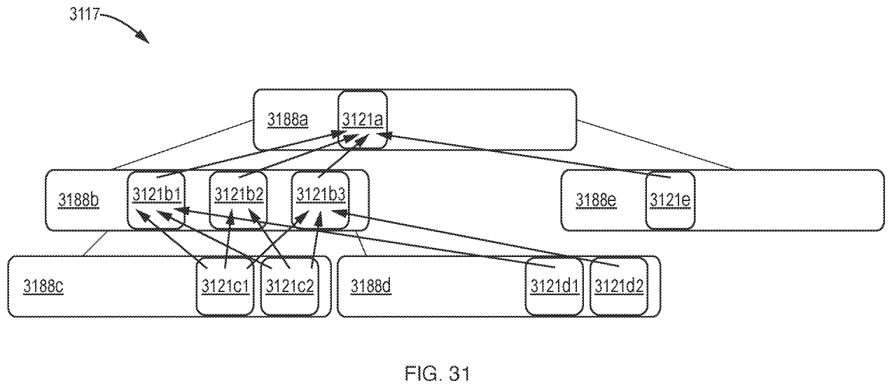

According to an example embodiment, a data structure may be used to represent an action node, e.g., 1988a-d. In an example embodiment, the data structure may include an ID field (e.g., for a numeric or other suitable identifier), a collection of stage(s) (described in more detail hereinbelow in relation to FIG. 31), a collection of action node(s) (if any) on which the action node depends (e.g., action node 1988d may depend on action nodes 1988a-c), and a creation time/date field, for non-limiting examples. In another example embodiment, the collections of stages and dependencies may be vectors, arrays, or other suitable known data structures, while the creation time/date may be an u64 or other suitable known data type.

FIG. 19B is a block diagram of an example embodiment of machine code for a DFG 1904a. With reference to FIGS. 19A and 19B, the DFG 1904a may corresponding to the first action 1988a of FIG. 19A, according to an example embodiment. With reference to FIG. 19B, the dataflow node 1958a2 (e.g., a filtering node) of the DFG 1904a may include the machine code snippet 1992a1; likewise, the dataflow node 1958a3 (e.g., a projection node) of DFG 1904a may include the machine code snippet 1992a2 for non-limiting examples.

FIG. 19C is a block diagram of an example embodiment of machine code for a DFG 1904c. The DFG 1904c may correspond to the third action 1988c of FIG. 19A, according to an example embodiment. With reference to FIG. 19C, the dataflow node 1958c4 (e.g., a join node) of the DFG 1904c may include the machine code snippet 1992c for non-limiting example.

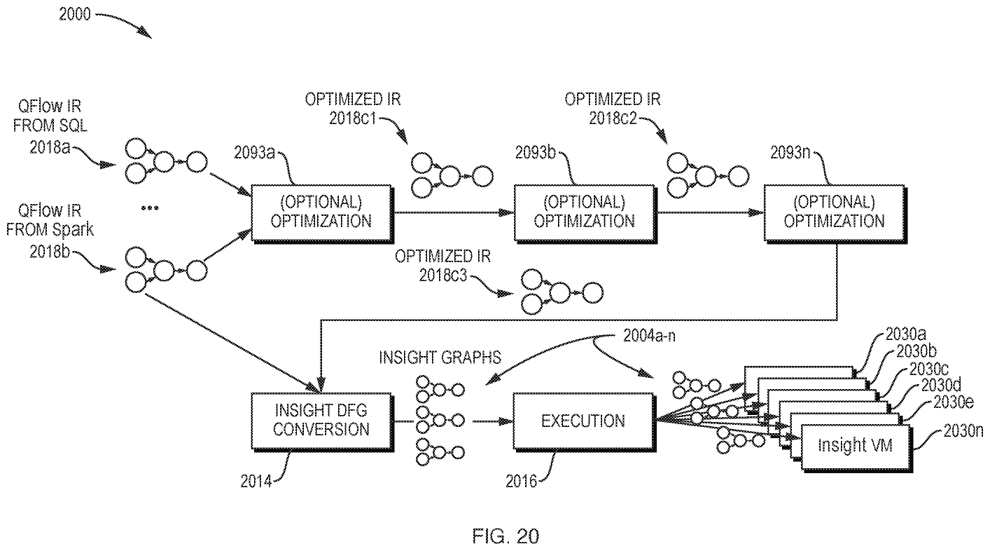

FIG. 20 is a flow diagram of an example embodiment of a process 2000 that may be implemented by a computer-based system (not shown), e.g., QFlow, according to an example embodiment. With reference to FIG. 20, the process 2000 may include receiving the IR 2018a and the IF 2018b. According to an example embodiment, the IR 2018a-b may include, for instance, QFlow IR 2018a generated from an input data query, e.g., query 102 (FIG. 1A), 202 (FIG. 2), 302 (FIG. 3), 502 (FIG. 5), 602 (FIG. 6), 902 (FIG. 9), 1002 (FIG. 10), 1102 (FIG. 11), or 1402a-b (FIG. 14A), via optional query compilation, e.g., module 1164 (FIG. 11) or 1564 (FIG. 15). The IR 2018a-n may also likewise include, for instance, QFlow IR 2018b received directly from a framework, such as Presto, Apache Spark, Apache Kafka, or another suitable framework known to those of skill in the art.

According to an example embodiment, the process 2000 may optionally include applying one or more optimization(s) 2093a-n, e.g., physical optimization(s), to the IR 2018a-n. According to an example embodiment, this optional procedure may result in the optimized IR 2018c1-3. Further, according to yet another embodiment, the process 2000 may include transforming, compiling, or converting 2014 the QFlow IR, e.g., 2018a-b or 2018c1-3, into one or more DFG(s) 2004a-n. According to an example embodiment, the process 2000 may further include executing 2016 the DFG(s) 2004a-n via one or more VM(s) 2030a-n, e.g., Insight VM(s).

### IR (Intermediate Representation)

According to an example embodiment, QFlow IR is a multifaceted intermediate representation in which common data analytics and HPC pipelines may be represented. Below is a non-limiting list of example known frontend frameworks that may be represented in QFlow IR:
a) Logical/physical plans of SQL frameworks like Apache Calcite, Apache Spark, Presto, etc.
b) Data ingestion pipelines like Apache Kafka, Apache Spark streaming, etc.
c) Programs of HPC languages like R, Julia, etc.

A plan representation is one variation of QFlow IR that may capture a logical or physical plan from various known frontend frameworks, like Apache Calcite, Apache Spark, Presto, etc. for non-limiting examples. A QFlow IR may be based on relational algebra as described in E. F. Codd, “A Relational Model of Data for Large Shared Data Banks,” June 1970, Commun. ACM 13, 6, pp. 377-387, with some influence from declarative relational calculus as described in E. F. Codd, “Relational Completeness of Data Base Sublanguages,” IBM Research Report RJ 987, San Jose, California (1972), both of which are incorporated herein by reference in their entireties. A plan representation may be used as, for non-limiting example:
a) Common representation for multiple known frontend SQL frameworks
   i. SQL, Apache Spark, Presto, etc.
b) Common representation for physical optimizations
   i. Rule-based, Cost-based optimizations
c) Source representation for multiple targets
   i. Insight VM with SoftPDU
   ii. Insight VM with Hardware PDU

### Plan

A plan, as disclosed herein, may be a tree of nodes representing a plan of execution for queries written in front-end languages like SQL, Scala, and other suitable known frontend languages. Table 1 lists non-limiting example node types in a QFlow IR plan and their corresponding descriptions according to an example embodiment:

TABLE 1
Example node types in plan representation of QFlow IR

| CATEGORY | NODE | DESCRIPTION |
|---|---|---|
| LEAVES | SCAN | Scan the relation using given schema |
| | | and location |
| RELATIONAL | JOIN | Joins two relations using given type, |
| ALGEBRA | | condition and method |
| | FILTER | Filters the relation with given |
| | | predicate |
| | PROJECT | Computes the given expressions on |
| | | the relation |
| | GROUP | Computes aggregations on relation |
| | | with given attributes |
| | SORT | Sorts the attributes of given relation |
| | LIMIT | Limits the number of attributes in the |
| | | relation |
| | ORDER | Orders the attributes of given relation |
| SET | UNION | Generate a union of given relations |
| OPERATIONS | INTER- | Generate an intersection of given |
| | SECTION | relations |
| | DEDUP | Removes duplicate attributes of given |
| | | relation |
| DISTRIBUTED | EXCHANGE | Exchanges the attributes across |
| EXEC. | | physical instances |

### Scan

In an example embodiment, scan nodes may be leaves in a plan and may be responsible for pulling data from storage, peers, etc. Table 2 lists non-limiting example parameters of scan nodes and their corresponding descriptions according to an example embodiment:

TABLE 2
Example scan node parameters

| PARAMETER | DESCRIPTION |
|---|---|
| Location | Contains the location from where the data needs to be |
| | fetched |
| Schema | Interesting columns to read from the retrieved data |
| Predicate | Predicate to match, e.g., partitions to filter etc. |

### Location

In an example embodiment, a location parameter for a scan node may contain information about a location of data, protocol to use to fetch the data, access keys, etc. Table 3 lists non-limiting examples of supported locations and their corresponding configurations according to an example embodiment:

TABLE 3
Example location configurations

| LOCATION | CONFIGURATION | DESCRIPTION |
|---|---|---|
| S3 | access_key | Amazon S3 ® access key |
| | secret_key | S3 ® secret key |
| | bucket | S3 ® bucket name to fetch |
| | key | S3 ® object key to fetch |
| | cache | If true, fetched data is cached |
| | | locally in cluster |
| TCP, | address | IP address to listen or connect |
| TLS | listen | If true, wait for sender else connect |
| | | to sender |
| CACHE | address | If set, IP address of cache server, |
| | | else local cache |
| | key | Key to lookup in cache |
| INLINE | content | Data to send |
| LOCAL | full_path | Full path to the file to read |
| FILE | range | Byte range to read |
| LOCAL | full_path | Full path to the directory to read |
| DIR | filter | File(s) to filter |
| GENERATOR | kind | Can be Random or Sequential |
| | start | Starting number |
| | count | Number of elements to generate |
| | type | Type of the element |
| | seed | Random seed |
| ODBC | connection_string | ODBC connection string |
| HDFS | address | Address of named node |
| | full_path | Full path to the file to read |

### Schema

In an example embodiment, a schema parameter for a scan node may contain information about a format of data, used and unused columns, and their data types. Below is a non-limiting example of a schema to extract id, name, quantity, price, and address columns from Apache Parquet® data where only id, quantity, and zip code of address are used, according to an example embodiment:

```
{
  format: parquet;
  view ordered full nocase {
    id les64;
    unused optional name ldstring;
    quantity les64;
    unused price lef64;
    view ordered full nocase address {
      unused street ldstring;
      unused optional repeated line ldstring;
      zipcode fwstring(5);
    }
  }
}
```

### Predicate

In an example embodiment, a predicate parameter for a scan node may contain a filter to apply at a time of reading data.

### Join

According to an example embodiment, join nodes in a plan may be responsible for joining two tables at a time using various techniques, etc. Further, in another example embodiment, joins may have different types, for example as described in “SQL Tutorial=>JOIN Terminology: Inner, Outer, Semi, Anti . . . ,” riptutorial.com, which is incorporated herein by reference in its entirety.

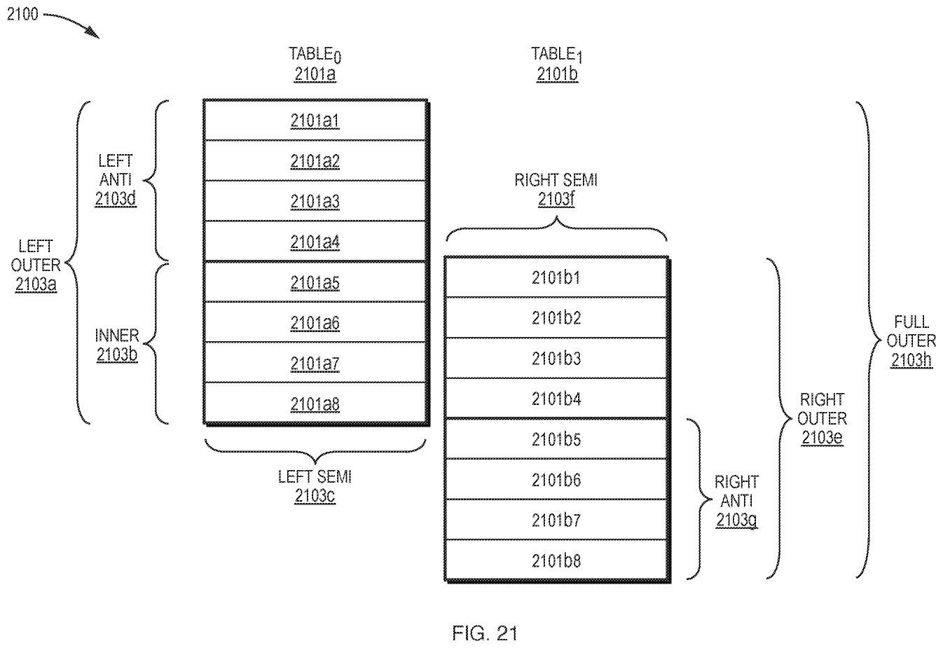

FIG. 21 is a block diagram of nonlimiting example embodiment of join types 2103a-h supported by a join node (not shown). In the example embodiment, the joins 2103a-h may be performed on tables 2101a-b. With reference to FIG. 21, according to an example embodiment, the left outer join 2103a may include rows 2101b1-4 of the table 2101b that match a corresponding row 2101a5-8 of the table 2101a, together with all of the rows 2101a1-8 of the table 2101a, regardless of whether a row in the table 2101a matches a corresponding row in the table 2101b. In an example embodiment, the inner join 2103b may be similar to the left outer join 2103a in that the inner join 2103b may also include the rows 2101b1-4 of the table 2101b that match a corresponding row 2101a5-8 of table 2101a, but the inner join 2103b may only include the rows 2101a5-8 of table 2101a that match the corresponding rows 2101b1-4 of the table 2101b. According to another example embodiment, the left semi join 2103c may be similar to the inner join 2103b in that the left semi join 2103c may also include the rows 2101a5-8 of the table 2101a that match the corresponding rows 2101b1-4 of the table 2101b; however, the left semi join 2103c may not include the matching rows 2101b1-4 of the table 2101b. Further, in yet another example embodiment, the left anti join 2103d may not include any rows of the table 2101b and may only include the rows 2101a1-4 of the table 2101a that do not match any rows of table 2101b.

Continuing with reference to FIG. 21, according to an example embodiment, the right outer join 2103e may include the rows 2101a5-8 of table 2101a that match a corresponding row 2101b1-4 of the table 2101b, together with all the rows 2101b1-8 of the table 2101b, regardless of whether a row in the table 2101b matches a corresponding row in the table 2101a. In another example embodiment, the right semi join 2103f may be similar to the inner join 2103b in that the right semi join 2103f may also include the rows 2101b1-4 of table 2101b that match the corresponding rows 2101a5-8 of table 2101a; however, the right semi join 2103f may not include the matching rows 2101a5-8 of the table 2101a.

Further, according to another example embodiment, the right anti join 2103g may not include any rows of the table 2101a and may only include the rows 2101b5-8 of the table 2101b that do not match any rows of the table 2101a. To continue, in an example embodiment, the full outer join 2103h may include the rows 2101a1-4 in the table 2101a that lack a matching row in the table 2101b, the rows 2101a5-8 of the table 2101a and their matching rows 2101b1-4 of the table 2101b, as well as the rows 2101b5-8 of the table 2101b that lack a matching row in the table 2101a.

Lastly, it should be noted that, according to an example embodiment, for a join that includes rows from a first table where the rows either do not have matching rows in a second table or matching rows from the second table are not included, e.g., the left outer join 2103a, left semi join 2103c, left anti join 2103d, right outer join 2103e, right semi join 2103f, right anti join 2103g, and full outer join 2103h, the rows from the first table may be paired with null values. However, example embodiments are not limited to null values and any other suitable value known to those of skill in the art may also be used.

Table 5 lists non-limiting example parameters of join nodes and their descriptions according to an example embodiment:

TABLE 5
Example join node parameters

| PARAMETER | DESCRIPTION |
|---|---|
| Method | Method to use for joining, which can be one of Hash or |
| | Sort |
| Type | Type of join, which can be one of Inner, Outer, Full, |
| | Semi, Anti |
| Predicate | Condition to use for joining |
| Left | Lefthand side table to use for joining |
| Right | Righthand side table to use for joining |

### Filter

In an example embodiment, filter nodes in a plan may be responsible for filtering rows from incoming data that match a given predicate. Table 6 lists non-limiting example parameters of filter nodes and their descriptions, according to an example embodiment:

TABLE 6
Example filter node parameters

| PARAMETER | DESCRIPTION |
|---|---|
| Predicate | Condition to use to filter |
| Argument | Table to use for filtering |

### Project

In an example embodiment, project nodes in a plan may be responsible for applying transformation(s) on incoming rows using given attributes. Table 7 lists non-limiting example parameters of project nodes and their descriptions, according to an example embodiment:

TABLE 7
Example project node parameters

| PARAMETER | DESCRIPTION |
|---|---|
| Attributes | Attributes to project where each attribute is a |
| | computation on columns |
| Argument | Table to use for projecting |

### Group

In an example embodiment, group nodes in a plan may be responsible for grouping rows and computing aggregations on them. Table 8 lists non-limiting example parameters of group nodes and their descriptions, according to an example embodiment:

TABLE 8
Example group node parameters

| PARAMETER | DESCRIPTION |
|---|---|
| By | The list of keys to group on, which can be empty |
| Aggregations | Aggregations to compute |
| Argument | Table to use for grouping |

### Sort

In an example embodiment, a sort node in a plan may be responsible for sorting rows.

### Limit

In an example embodiment, a limit node in a plan may be responsible for limiting a number of rows processed and/or skipping processing of a number of rows. Table 9 lists non-limiting example parameters of limit nodes and their descriptions, according to an example embodiment:

TABLE 9
Example limit node parameters

| PARAMETER | DESCRIPTION |
|---|---|
| Offset | Number of rows to skip |
| Count | Number of rows to limit |

### Order

In an example embodiment, an order node in a plan may be responsible for ordering rows. Table 10 lists non-limiting example parameters of order nodes and their descriptions, according to an example embodiment:

TABLE 10
Example order node parameters

| PARAMETER | DESCRIPTION |
|---|---|
| Type | Type of exchange, e.g., Single, Hash, Random, or |
| | Broadcast |
| Argument | Input columns to exchange |

### Exchange

In an example embodiment, exchange nodes in a plan may be responsible for consolidating results of a distributed computation at a destination. According to another example embodiment, the destination can be a same physical node or a remote physical node. Table 11 lists non-limiting example parameters of exchange nodes and their descriptions, according to an example embodiment:

TABLE 11
Example exchange node parameters

| PARAMETER | DESCRIPTION |
|---|---|
| Single | The results need to be consolidated at a single node |
| Hash | The results need to be distributed using the hash key |
| Key | The key to use for Hash Exchange |
| Argument | Table to exchange |

### Union

In an example embodiment, union nodes in a plan may be responsible for combining or multiplexing columns. Table 12 lists non-limiting example parameters of union nodes and their descriptions, according to an example embodiment:

TABLE 12
Example union node parameters

| PARAMETER | DESCRIPTION |
|---|---|
| Argument | Array of columns to union |

### Dedup

In an example embodiment, dedup nodes in a plan may be responsible for deduplicating columns. Table 13 lists non-limiting example parameters of union nodes and their descriptions, according to an example embodiment:

TABLE 13
Example dedup node parameters

| PARAMETER | DESCRIPTION |
|---|---|
| By | Columns to find duplicates on |
| Argument | Array of columns to deduplicate |

### Insight VM Target Description

According to an example embodiment, QFlow module(s) may convert IR into Insight VM DFG(s) along with code for compute nodes in the DFG(s) using Insight's VM ISA. An Insight VM may be as described in U.S. application Ser. No. ______, entitled “System and Method for Computation Workload Processing” (Docket No. 6214.1003-000), filed on Dec. 15, 2023, which is herein incorporated by reference in its entirety. This section lists non-limiting example capabilities of an Insight VM at a logical level that may be used by the QFlow module(s) in generating graphs and code for compute nodes.

### Evaluate

According to an example embodiment, Insight can take a list of expressions and a set of input streams and evaluate their result in parallel with hardware acceleration. The expressions can have an arbitrary number of inputs and operators. The expressions can also share the inputs and outputs with each other, and their execution is pipelined. This capability can be used to implement filter and project nodes of an IR.

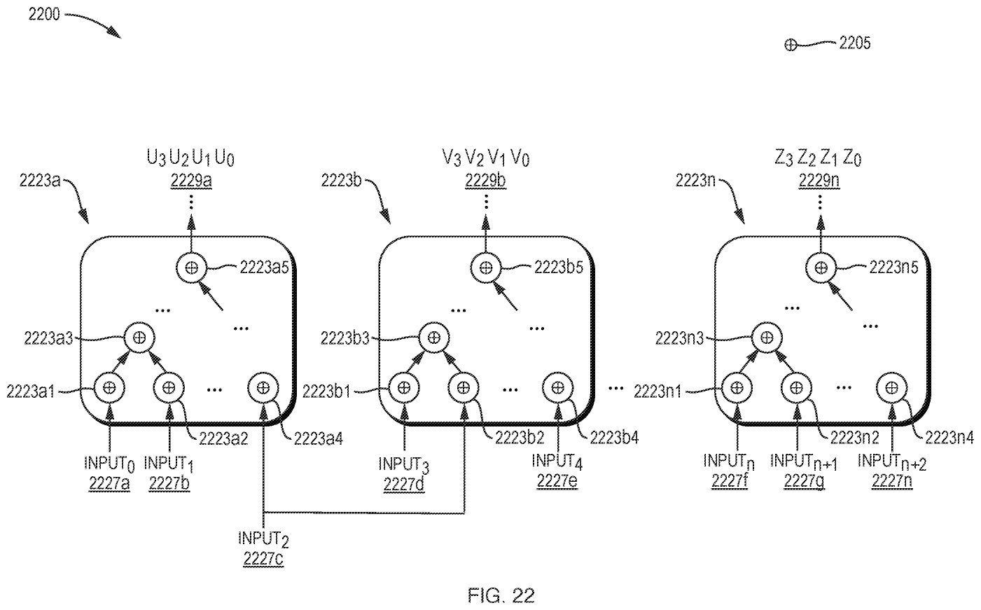

FIG. 22 is a block diagram of an example embodiment of functionality of an evaluate node 2200. In the example embodiment of FIG. 22, the evaluate node 2200 may include expressions 2223a-n. According to an example embodiment, the expression 2223a may include operators 2223a1-5, the expression 2223b may include operators 2223b1-5, and the expression 2223n may include the operators 2223n1-5. In another example embodiment, the operators 2223a1-5, 2223b1-5, and 2223n1-5 may be labeled with a symbol 2205, which may indicate that any suitable operator known to those of skill in the art may be used for the operators 2223a1-5, 2223b1-5, and 2223n1-5.

Continuing with reference to FIG. 22, according to an example embodiment, the expression 2223a may receive the inputs 2227a-c, the expression 2223b may receive the inputs 2227c-e, and the expression 2223n may receive the inputs 2227f-g and 2227n. It is noted that, in an example embodiment, the expressions, e.g., 2223a and 2223b, may share common input(s), e.g., 2227c. According to an example embodiment, the expression 2223a may generate the output 2229a, the expression 2223b may generate the output 2229b, and the expression 2223n may generate the output 2229n. In an example embodiment, the expressions 2223a-n may be pipelined and/or evaluated in parallel, using, e.g., hardware acceleration, or any other suitable known technique. Lastly, it is noted that, in an example embodiment, an evaluate node, e.g., 2200, may be used to implement a filter or project node.

### Match

According to an example embodiment, Insight can take a regular expression, match it in each column value in an incoming stream of data, and output a bitmap of match results. This capability can be used to implement filter nodes of an IR.

### Project Bitmap

According to an example embodiment, Insight can take a bitmap and a set of data value streams and project the bitmap onto the streams, i.e., output values from the input streams only if a corresponding bit in the bitmap is set to 1 and omit other values from the input streams. Such functionality may be performed when a project bitmap node is operating in a first, default configuration. In a second, optional configuration, the node can also output separate streams with values from the data streams corresponding to 0 bits in the bitmap. This capability can be used to implement filter and join nodes (e.g., join types 2103a-h described hereinabove in relation to FIG. 21) of the IR.

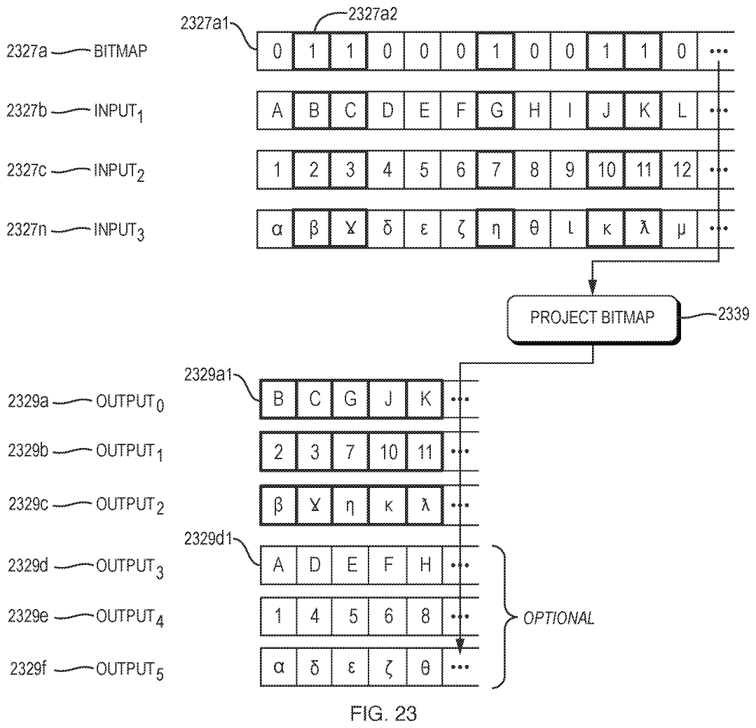

FIG. 23 is a block diagram of an example embodiment of functionality of a project bitmap node 2339. In the example embodiment of FIG. 23, the project bitmap node 2339 may take as inputs a bitmap stream 2327a, which may include bits 2327a1-2 and one or more data value stream(s) 2327b-n. According to an example embodiment, among the bits 2327a1-2 of input bitmap 2327a there may be included, e.g., bit 2327a1 of 0 and bit 2327a2 of 1, which may correspond to, e.g., the value 2327a1 of A and the value 2327a2 of B in the input stream 2327a, respectively. In another example embodiment, the project bitmap node 2339 may generate the output streams 2329a-c, and, optionally depending on a configuration of the project bitmap node 2339, output streams 2329d-f. It should be noted that, although six (i.e., three default and three optional) output streams 2329a-f are shown in FIG. 23, an arbitrary number of default and/or optional output streams may be generated by the project bitmap node 2339, and such number may be based on a number of the input data streams 2327b-n and the configuration of the project bitmap node 2339.

According to an example embodiment, the default output streams 2329a-c may reflect values in the corresponding input streams 2327a-c, where a position of a value in an input stream corresponds to a position of a 1 bit in bitmap 2327a. For example, in an example embodiment, the output stream 2329a may include the value 2329a1 of B because the position 2327a2 of the value B in the input stream 2327a corresponds to the position 2327a2 of a 1 bit in the bitmap 2327a. Likewise, according to an example embodiment, the optional output streams 2329d-f may reflect values in corresponding input streams 2327a-c, where a position of a value in an input stream corresponds to a position of a 0 bit in the bitmap 2327a. For example, in an example embodiment, the optional output stream 2329d may include the value 2329d1 of A because the position 2327a1 of the value A in the input stream 2327a corresponds to position 2327a1 of a 0 bit in bitmap 2327a.

### Tuple Hash

According to an example embodiment, Insight can take a set of streams, build tuples from elements in the stream, and compute a hash/digest of the tuples for non-limiting examples. Supported hash/digest methods may include, e.g., AES (Advanced Encryption Standard)-GMAC (Galois Message Authentication Code) for non-limiting example, or any other suitable method for computing a hash/digest known to those of skill in the art.

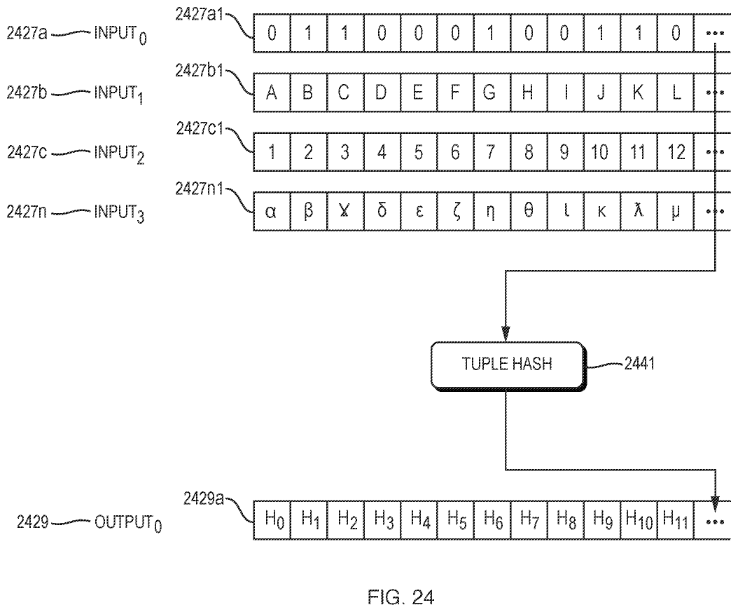

FIG. 24 is a block diagram of an example embodiment of functionality of a tuple hash node 2441. In the example embodiment of FIG. 24, the node 2441 may take as inputs one or more stream(s) 2427a-n and generate the output 2429. For example, according to an example embodiment, an item 2429a of the output 2429 may be a hash or digest of a tuple that includes a value 2427a1 of 0 from the input stream 2427a, a value 2427b1 of A from the input stream 2427b, a value 2427c1 of 1 from the input stream 2427c, and a value 2427n1 of a from the input stream 2427n.

### Hash Build

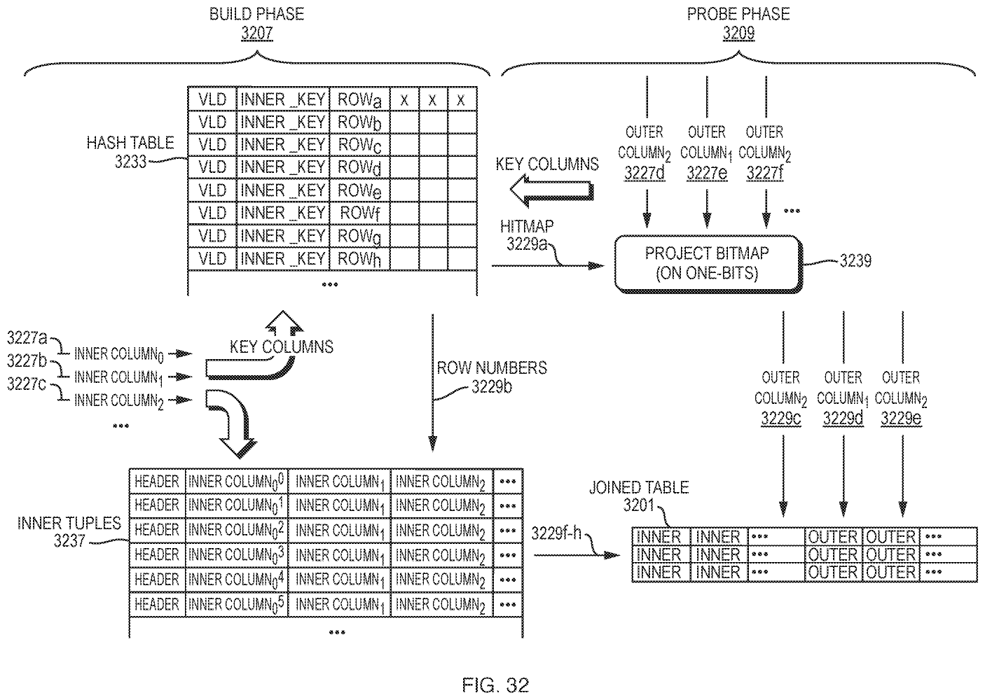

According to an example embodiment, Insight can take a stream of (key, value0, value1, . . . ) tuples and build a hash table with the key. Note that a key may include multiple streams, and aggregation functions can be applied on the value streams; aggregation functions may include, e.g., sum, count, min, max, first, last, tally, index, or any other suitable function known in the art. The “first” and “last” functions may store a first value or a last value of the stream, respectively. A tally function may be the same as count except that nulls are also counted, i.e., it returns a total row count. An index function may store an index of a row, i.e., a row number. The hash table may include two bucket entries; however, any suitable number of bucket entries may be used. Upon collision, a probing method may be used to probe neighboring buckets of the hash table for free slots. If free slots are not found, the colliding tuple may be sent back to a host for further processing. This capability can be used to implement group and join nodes (e.g., as described hereinbelow in relation to FIGS. 32-36) of an IR.

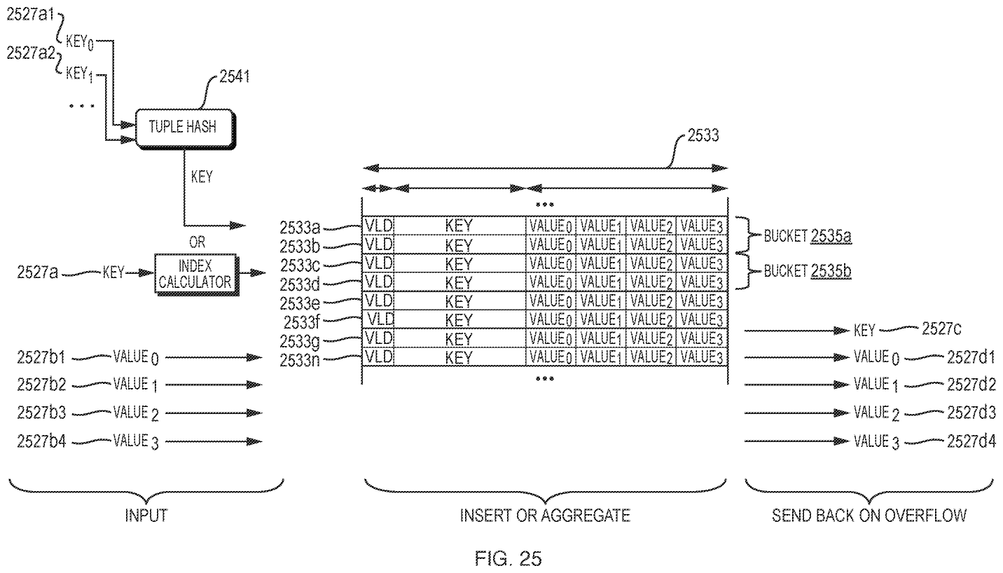

FIG. 25 is a block diagram of a nonlimiting example embodiment of using a hash build node (not shown) to build a table 2533 according to an example embodiment. In the example embodiment of FIG. 25, the hash build node may construct a table 2533 based on a key stream 2527a and one or more value stream(s) 2527b1-4. According to an example embodiment, values of stream(s) 2527b1-4 may be inserted in the table 2533 as-is, or, alternately, any suitable known aggregation function, e.g., sum, count, min, max, first, last, tally, index, etc., may be applied to the values of stream(s) 2527b1-4.

In an example embodiment, instead of single key stream 2527a, the hash build node may alternately use two or more key streams 2527a1-2. According to an example embodiment, the key streams 2527a1-2 may also be supplied as inputs to a tuple hash node 2541 to generate a single key stream. To continue, in an example embodiment, the table 2533 may include one or more row(s) 2533a-n. Further, according to an example embodiment, rows, e.g., 2533a and 2533b, may belong to a bucket entry, e.g., 2535a. In an example embodiment, the table 2533 may include two bucket entries, e.g., 2535a and 2535b. However, embodiments are not limited to two bucket entries, and any other suitable number of bucket entries may be used. According to another example embodiment, streams, e.g., key stream 2527c and value stream(s) 2527d1-4, may be sent back if, for instance, an overflow occurs when attempting to insert the streams in table 2533.

### Hash Probe

According to an example embodiment, Insight can take a stream of keys and probe a prebuilt hash table. The hash table may contain, e.g., a single value with an aggregation function index. However, other suitable numbers of values may be used. When a match is found, the row number stored in the value may sent out along with a 1-bit in a hitmap output stream, i.e., an output bitmap stream where each 1-bit value indicates a match or “hit” and each 0-bit value indicates no match or “miss.” If a match is not found, the missing key may be sent out along with a 0-bit in the hitmap output stream. This capability can be used to implement a probe phase of join nodes (e.g., as described hereinbelow in relation to FIGS. 32-36) of an IR.

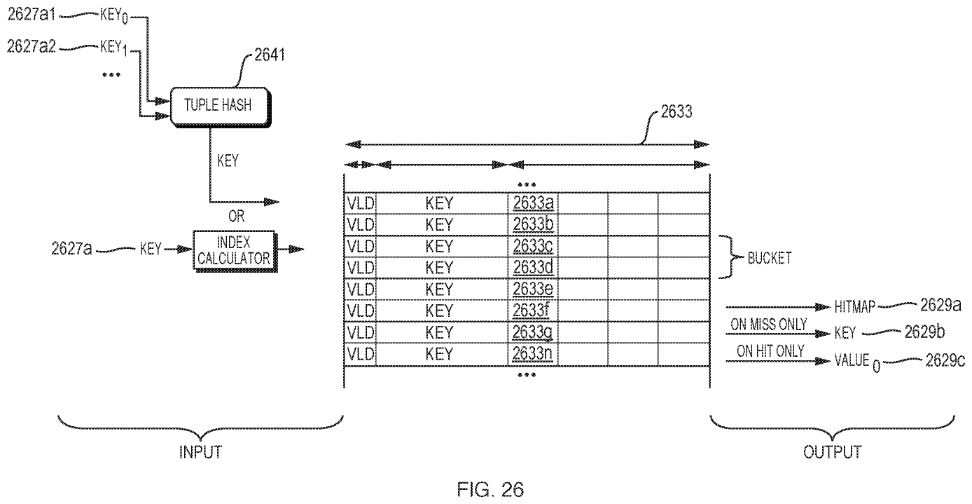

FIG. 26 is a block diagram of a non-limiting example of using a hash probe node (not shown) to probe a table 2633 according to an example embodiment. In the example embodiment of FIG. 26, the hash build node may probe a prebuilt hash table 2633 based on a key stream 2627a. According to an example embodiment, the table 2633 may contain, e.g., single values 2633a-n with an aggregation function index. However, other suitable numbers of values may be used. To continue, in another example embodiment, instead of a single key stream 2627a, the hash probe node may alternately use two or more key streams 2627a1-2. According to an example embodiment, the key streams 2627a1-2 may also be supplied as inputs to the tuple hash node 2641 to generate a single key stream. Further, according to an example embodiment, the hash probe node's outputs may include a hitmap stream 2629a, key stream 2629b, and value stream 2629c. According to an example embodiment, if a match is found, a row number from, e.g., one of the values 2633a-n, may be sent out in a value stream 2629c along with a 1-bit in the hitmap stream 2629a. If, however, a match is not found, a missing key may be sent out in the key stream 2629b along with a 0-bit in the hitmap stream 2629a.

### Tuple Build

According to an example embodiment, Insight can build tuples of input streams and build a table. The table may include a header with details about each attribute followed by the attribute data. The rows in the table may be arranged on a cache line boundary and a width of each row may be fixed to optimize for random access. Logically, this operation may convert the data in column major format into row major format. This capability can be used to implement a build phase of join nodes (e.g., as described hereinbelow in relation to FIGS. 32-36) and sort nodes in the IR.

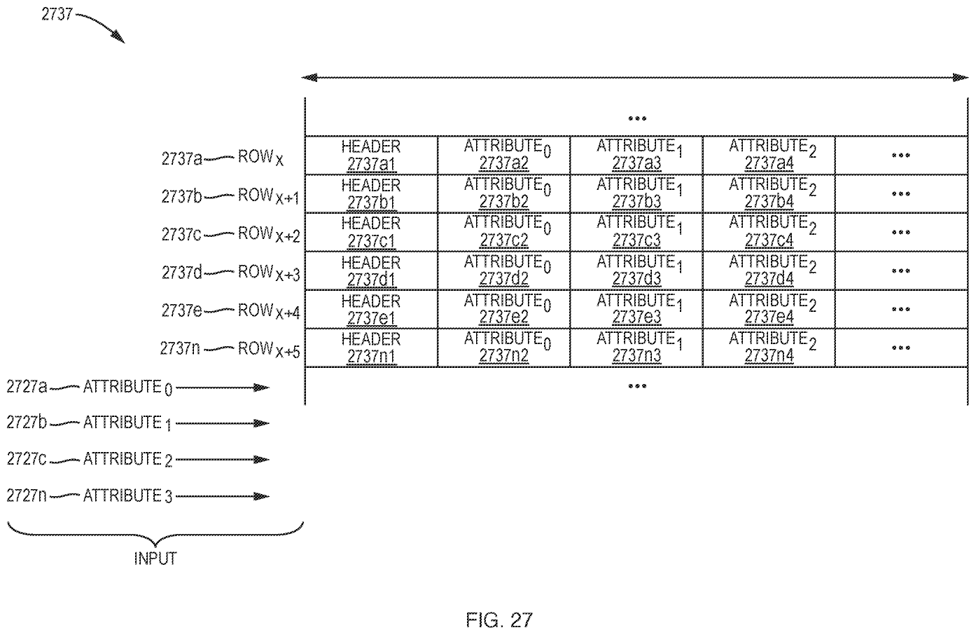

FIG. 27 is a block diagram a non-limiting example embodiment of using a tuple build node (not shown) to build a table 2737. In the example embodiment of FIG. 27, a table 2737 may be constructed based on input streams 2727a-n, where each input stream 2727a-n includes data values for a particular attribute. According to an example embodiment, the table 2737 may include one or more row(s) 2737a-n. For example, in another example embodiment, the row 2737a may include a header entry 2737a1 with details about each attribute corresponding to the input streams 2727a-n, as well as an entry for the attribute data tuple 2737a2-4.

### Tuple Probe

According to an example embodiment, Insight can probe a prebuilt table of tuples. It takes a stream of row numbers and de-tuples each row at the given row number into its constituent columns. Optionally, it may also take another bitmap as input. If the bitmap is provided, only the rows where the bit in the bitmap is set are de-tupled. If the bit in the bitmap is zero, nulls are sent out in the output stream. Logically, this operation converts the data in row major format into column major format. This capability can be used to implement a probe phase of join nodes (e.g., as described hereinbelow in relation to FIGS. 32-36) and sort nodes in the IR.

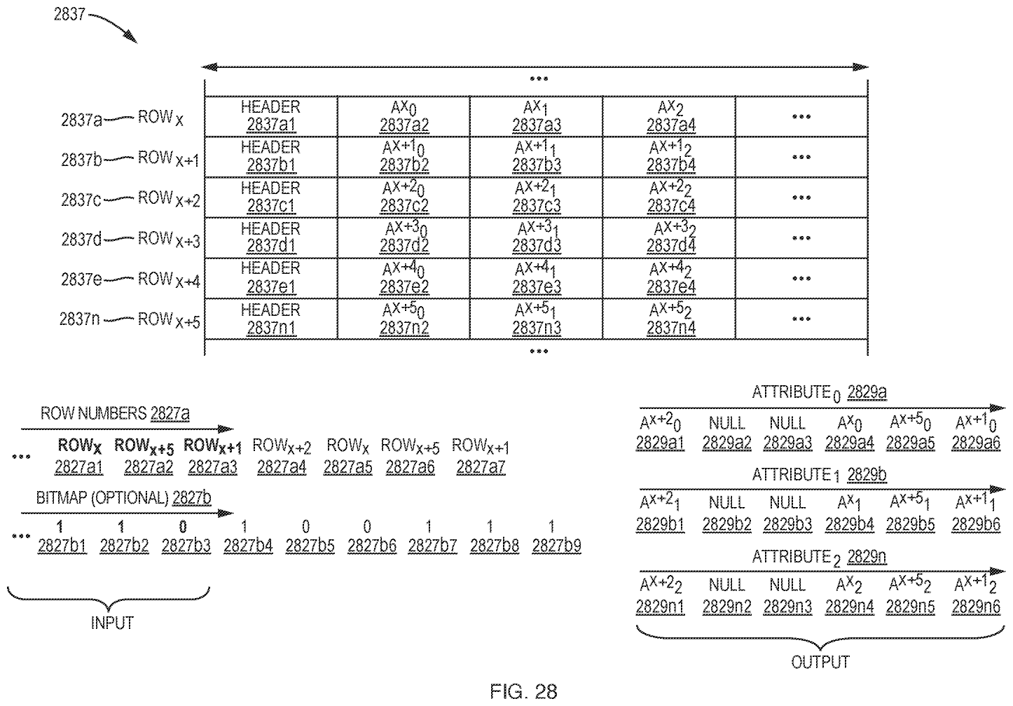

FIG. 28 is a block diagram of a non-limiting example embodiment of using a tuple probe node (not shown) to probe a table 2837 according to an example embodiment. In the example embodiment of FIG. 28, a table 2837 may include rows 2837a-n. According to an example embodiment, a row in the table 2837, e.g., the row 2837a, may, in turn, include a header entry 2837a1 with details about each attribute corresponding to the output streams 2829a-n, as well as an entry for attribute data tuple 2837a2-4.

According to another example embodiment, the table 2837 may be probed based on the input stream 2827a that includes row numbers 2827a1-7, which may variously correspond to rows 2837a-n of table 2837, and, optionally, the input bitmap 2827b that includes 0/1 values 2827b1-9. For example, according to an example embodiment, a row number 2827a1 of the input stream 2827a may correspond to a row 2837a of the table 2837. To continue, in yet another example embodiment, performing a tuple probe on the table 2837 may result in generating one or more output stream(s) 2829a-n, where each output stream of the output stream(s) 2829a-n includes data values for a particular attribute. According to an example embodiment, an item in the output stream 2829a, e.g., the item 2829a1, may correspond to attribute data in a tuple in the table 2837, e.g., attribute data 2837c2 of the tuple 2837c2-4 in the row 2837c of the table 2837. Conversely, an item in the output stream 2829a, e.g., the item 2829a2, may be a null value if the optional bitmap 2827b is provided as an input and the bitmap 2827b includes a 0 value, e.g., 2827b3, in a position that corresponds to a position of the item 2829a2 in the output stream 2829a.

### Sort and Merge

According to an example embodiment, Insight can sort a given stream of input along with its row number using a merge sort method or any other suitable method known to those of skill in the art. This capability can be used to implement non-equi joins and order by nodes in an IR, for non-limiting examples.

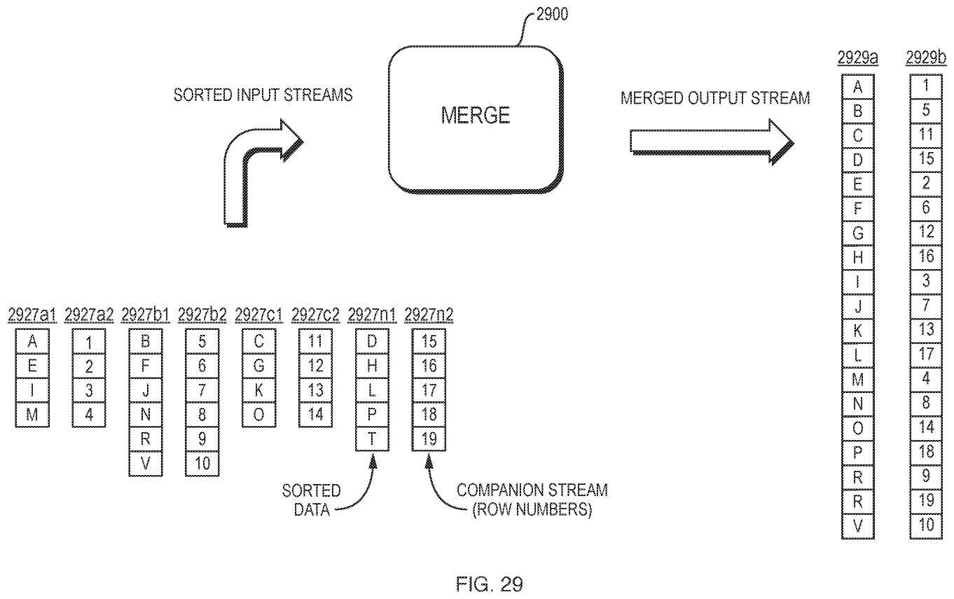

FIG. 29 is a block diagram of an embodiment of functionality of a merge node 2900 according to an example embodiment. In the example embodiment of FIG. 29, the merge node 2900 may take as inputs one or more pair(s) of streams 2927a1-2, 2927b1-2, 2927c1-2, and 2927n1-2, and generate a pair of output streams 2929a-b. According to an example embodiment, a first stream in a pair, e.g., 2927a1, may be a stream of sorted input values, while a second stream in the pair, e.g., 2927a2, may be a stream of row numbers corresponding to the input values in stream 2927a1. In another example embodiment, a first stream in the pair of output streams, e.g., 2929a, may include the input values from the streams 2927a1, 2927b1, 2927c1, and 2927n1 in sorted order, while a second stream in the pair, e.g., 2929b, may include the corresponding row numbers from streams 2927a2, 2927b2, 2927c2, and 2927n2.

### Optimizations

### Optional Rule-Based Optimization(s)

In an example embodiment, an optional rule-based optimization phase may include applying one or more rule(s) on an input IR. According to another example embodiment, a rule may include a pattern to match in an IR tree and a replacement pattern to substitute for the matching pattern in the IR tree. For instance, in an example embodiment, while performing rule-based optimization(s), a rule may find its pattern in an IR and replace the pattern in the IR with a provided replacement. According to yet another example embodiment, if no replacements are performed during a given optimization pass, then the optional rule-based optimization phase may be considered complete.

### Optional Cost-Based Optimization(s)

In an example embodiment, an optional cost-based optimization phase may include computing a cost of execution at each node in an IR. According to another example embodiment, if the computed cost of execution for a given node exceeds a load factor, which may be preconfigured, then the optional cost-based optimization phase may convert an action associated with the given node into multiple stages.

### Plan Compilation

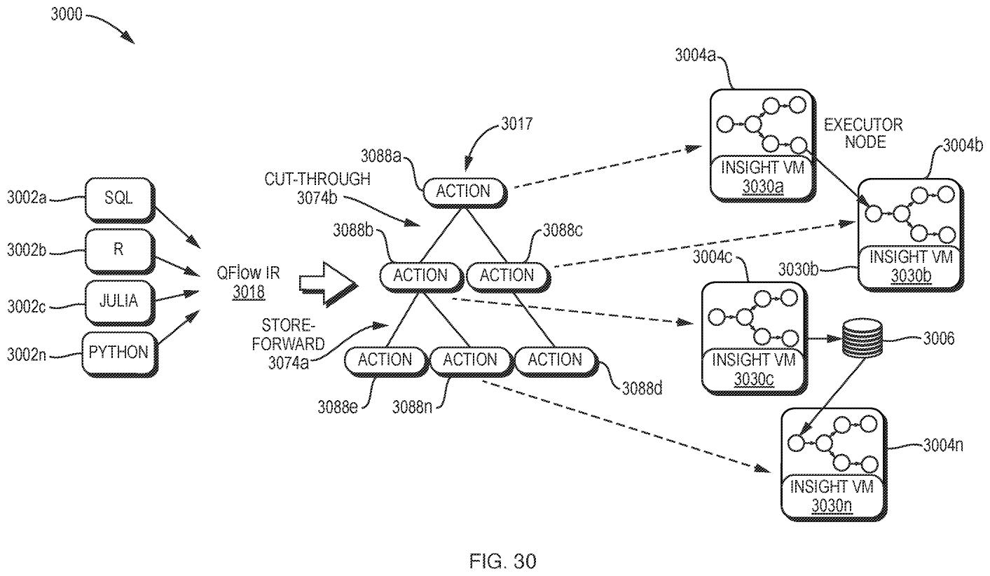

FIG. 30 is a flow diagram of an example embodiment of a process 3000 for distributed scheduling and execution of dataflow graphs. The process 3000 may be performed by a computer-based system according to an example embodiment, e.g., computer-based system 1410 (FIG. 14A), 1210 (FIG. 12), 1110 (FIG. 11), 1010 (FIG. 10) 910 (FIG. 9), 610 (FIG. 6), 510 (FIG. 5), 210 (FIG. 2), or 110 (FIGS. 1A-B). As shown in FIG. 30, such a computer-based system may receive an input data query, e.g., the input data query 3002a-n. The input data query 3002a-n may be received from a framework such as SQL, the R programming language, the Julia programming language, Python®, or any other suitable framework known to those of skill in the art. In an example embodiment, the system may transform a query plan tree (not shown) into a query strategy tree 3017, where the query plan tree is constructed from the input data query 3002a-n, which may be associated with a computation workload. The system may compile the query strategy tree 3017 into DFG(s), e.g., DFG(s) 3004a-n. The system may transmit the DFG(s) 3004a-n for execution via a virtual platform (not shown). The system may monitor the execution of the DFG(s) 3004a-n. In addition, the system may output, based on a result (not shown) of the execution monitored, a response (not shown) to the input data query 3002a-n. The result may be received from the virtual platform and may represent computational result(s) of processing the computation workload by the virtual platform. In another example embodiment, during execution, the DFG(s) 3004a-n may receive input data from and/or output results to the data lake 3006.

Continuing with reference to FIG. 30, in an example embodiment, the computer-based system may select, based on resource(s) associated with an action node of action node(s), e.g., the action nodes 3088a-n, of the query strategy tree 3017, a VM of VM(s), e.g., VM(s) 3030a-n, of the virtual platform. According to an example embodiment, the system may translate the action node of the action node(s) 3088a-n of the query strategy tree 3017 into a DFG of the DFG(s) 3004a-n. In an example embodiment, the system may assign the DFG for execution by the VM selected.

According to an example embodiment, a scheduling mode for the query strategy tree 3017 may be a store-forward mode, e.g., 3074a. According to an example embodiment, the computer-based system may further identify the action node of the action node(s) 3088a-n of the query strategy tree 3017 by traversing the query strategy tree 3017 in a breadth-first mode. In another example embodiment, the scheduling mode for the query strategy tree 3017 may be a cut-through mode, e.g., 3074b. According to an example embodiment, the system may cause the VM to reserve the resource(s) associated with the action node of the action node(s) 3088a-n of the query strategy tree 3017. In such an example embodiment, the translating and the assigning may be performed responsive to traversing the query strategy tree 3017 in a post-order depth-first mode.

FIG. 31 is a block diagram of an example embodiment of a query strategy tree 3117 that includes action nodes 3188a, 3188b, 3188c, 3188d, and 3188e that include stages 3121a, 3121b1-3, 3121c1-2, 3121d1-2, and 312l, respectively. It should be understood that the number of action nodes and stages thereof are for non-limiting example and that a query strategy tree disclosed herein is not limit to same.

In the example embodiment of FIG. 31, a child action node may have a single immediate parent action node; for instance, the child action nodes 3188c and 3188d may each have the action node 3188b as their sole immediate parent action node, while the child action nodes 3188b and 3188e may each have the action node 3188a as their sole immediate parent action node. Additionally or alternately, a child action node may have intermediate parent action node(s) and/or an ultimate parent action node. For instance, in the example embodiment of FIG. 31, child action nodes 3188c and 3188d both have action node 3188a as their ultimate parent action node.

According to another example embodiment, an action node may include at least one stage. In another example embodiment, each stage may be associated with one or more parent stage(s); for instance, the action node 3188c may include the two stages 3121cl and 3121c2, both of which may be associated with the same immediate parent stages in the action node 3188b: 3121b1, 3121b2, and 3121b3. According to an example embodiment, while the action node 3188d may similarly include the two stages 3121d1-2, each of the two stages 3121d1 and 3121d2 may only have as an immediate parent the stages 3121b1 and 3121b3, respectively. In another example embodiment, as shown in FIG. 31, the child-parent relationships among the stages 3121a, 3121b1-3, 3121c1-2, 3121d1-2, and 312l may result in a directed acyclic graph (DAG). According to yet another example embodiment, instead of generating DFGs that correspond to each of the action nodes 3188a, 3188b, 3188c, 3188d, and 3188e of the query strategy tree 3117, DFGs may be generated that correspond to each of the stages included in the action nodes, such as the stages 3121a, 3121b1-3, 3121c1-2, 3121d1-2, and 3121e.

In an example embodiment, a data structure may be used to represent a stage, e.g., 3121a, 3121b1-3, 3121c1-2, 3121d1-2, or 3121e. As disclosed below, in an example embodiment, the data structure may include: an ID field (e.g., for a numeric or other suitable identifier), an ID of an action node (e.g., 3188a-e) containing the stage, an IR used to generate the stage, an assigned resource for executing the stage, and a creation time/date field, or a combination thereof, for non-limiting examples. In another example embodiment, the data structure may also include at least one optional field(s), such as a connection ID, a statement ID, a collection of parent stage(s) (if any), and/or a logging level (the latter for, e.g., auditing and/or debugging purposes), for non-limiting examples. According to yet another example embodiment, the collection of parent stage(s) may be a vector, array, or other suitable known data structure, with each parent stage being a tuple including a string and an unsigned 16-bit integer (u16) or other suitable known data type(s) or structure(s), while the creation time/date may be an u64 or other suitable known data type. Below is a non-limiting example of such a data structure used to represent a stage:

```
struct {
  id: ID,
  action: ID,
  statement: Option<ID>,
  connection: Option<ID>,
  log_level: Option<u64>,
  ir: IR,
  assigned: Rc<resource::Response>,
  parent: Option<Vec<(String, u16)>>,
  created_at: u64,
}
```

Continuing with reference to FIG. 31, in an example embodiment, the computer-based system may select a VM of VM(s), e.g., VM(s) 3030a-n, of the virtual platform. According to an example embodiment, the selecting may be based on resource(s) associated with a stage of stage(s), e.g., the stage(s) 3121a, 3121b1-3, 3121c1-2, 3121d1-2, and 312l, of an action node of action node(s), e.g., the action node(s) 3188a-e, of the query strategy tree 3117. In an example embodiment, the system may translate the stage, e.g., 3121a, 3121b1-3, 3121c1-2, 3121d1-2, or 312l, into a DFG of DFG(s), e.g., DFG(s) 3004a-n (FIG. 30). According to an example embodiment, the system may assign the DFG for execution by the VM selected.

In an example embodiment, a scheduling mode for the query strategy tree 3117 may be a store-forward mode, e.g., 3074a (FIG. 30). According to an example embodiment, the computer-based system may further identify the action node, e.g., 3188a-e, by traversing the query strategy tree 3117 in a breadth-first mode. In another example embodiment, the action node of the action node(s) 3188a-e of the query strategy tree 3117 may be a parent action node, e.g., 3188a-b, of child action node(s), e.g., 3188b-e, of the query strategy tree. According to an example embodiment, the stage, e.g., 3121a or 3121b1-3, of the action node, e.g., 3188a-b, may be associated with a stage of stage(s), e.g., 3121b1-3, 3121c1-2, 3121d1-2, and 312l, of the child action node(s), e.g., 3188b-e. In another example embodiment, the translating and the assigning may be performed responsive to determining that execution of a respective DFG of the DFGs 3004a-n has completed. According to an example embodiment, the respective DFG may correspond to the stage of the stage(s), e.g., 3121b1-3, 3121c1-2, 3121d1-2, and 312l, of the child action node(s), e.g., 3188b-e. Further, in yet another example embodiment, the action node, e.g., 3188a-e, may be a child action node, e.g., 3188b-e, of a parent action node, e.g., 3188a-b, of the query strategy tree 3117 and the stage, e.g., 3121b1-3, 3121c1-2, 3121d1-2, or 312l, of the action node, e.g., 3188b-e, may be associated with a stage of stage(s), e.g., 3121a and 3121b1-3, of the parent action node, e.g., 3188a-b.

In an example embodiment, the scheduling mode for the query strategy tree 3117 may be a cut-through mode, e.g., 3074b (FIG. 30). According to an example embodiment, the system may cause the VM to reserve the resource(s) associated with the stage of stage(s), e.g., 3121a, 3121b1-3, 3121c1-2, 3121d1-2, and 312l, of the action node of the action node(s), e.g., 3188a-e, of the query strategy tree 3117. According to another example embodiment, the translating and the assigning may be performed responsive to traversing the query strategy tree 3117 in a post-order depth-first mode.

With reference to FIG. 30, in an example embodiment, compiling a plan into an Insight VM DFG may include the following operations:
a) Strategize
   i. Build a tree of actions, e.g., query strategy tree 3017, from a plan
   ii. Compute resources utilized for each action, e.g., action nodes 3088a-n, may include, as non-limiting examples:
      1) Number of PDU accelerators needed by type
      2) Amount of PDU and host memory
      3) Amount of SSD storage needed
      4) Number of CPUs needed
      5) Network bandwidth
      6) Number of network ports needed
b) Schedule
   i. Setup a runtime environment for a given strategy
   ii. If an execution mode is store-forward, e.g., mode 3074a
      1) Walk the tree of actions 3017 in breadth order from leaves
      2) At each node 3088a-n
         a) Assign a VM, e.g., 3030a-n, that satisfies resources needed
         b) Schedule the action
         (i) Build a DFG, e.g., 3004a-n, for the action
         (ii) Send the DFG 3004a-n to the VM 3030a-n
         c) Once the action is finished, notify a parent
         d) Once all siblings are finished, schedule the parent
   iii. If the execution mode is cut-through, e.g., mode 3074b
      1) Assign a VM 3030a-n to each action 3088a-n in the tree 3017
         a) Find a VM 3030a-n that satisfies the resource needed for the action 3088a-n
         b) Reserve resources on the selected VM 3030a-n
      2) Walk the tree of actions 3017 in pre-order
         a) At each node 3088a-n
         (i) Build a DFG 3004a-n for the action 3088a-n
         (ii) Send the DFG 3004a-n to the VM 3030a-n

### Strategize

According to an example embodiment, a strategizing operation may include converting an IR into a tree of actions, where each action in the tree of action includes a set of stages based on a load factor, disclosed in more detail hereinabove in relation to optional cost-based optimization(s).

### Schedule

### Data Flow Graph Generation

According to an example embodiment, DFG generation may include converting each node in a QFlow IR into a set of input, output, and compute nodes. In another example embodiment, for each operation in the IR, the DFG generation may also include generating a sequence of Insight VM instructions to perform the operation.

### Compute Node Code Generation

### Scan

In an example embodiment, a scan node may be responsible for pulling data from storage, peers, etc.

### Join

In an example embodiment, a join node may be implemented using hash build, hash probe, tuple build, tuple probe, project bitmap, and/or sort capabilities of an Insight VM, for non-limiting examples. According to another example embodiment, a hash table-based approach may be used for equi-joins and a sort-merge based approach may be used for other joins, for non-limiting examples.

### Hash Join

In hash joins, a join may be implemented in two phases, a build phase followed by a probe phase. In the build phase, two intermediate structures are built in memory for inner table data. First, a hash table with a join key and row numbers of an inner table is built. Second, a tuple table with inner table rows is built in row-major format. The hash table allows fast lookups and the tuple table reduces the number of random accesses to prepare the inner table rows while preparing joined rows. All four types of joins, i.e., inner, outer, semi, and anti joins, may be implemented using the above approach.

### Inner Hash Join

Inner hash join may be implemented by building the hash table and tuple table as described above in the build phase. In the probe phase, a hitmap from a hash probe node may be fed to a project bitmap node to filter out outer table rows. Also, row numbers of the inner table may be fed to a tuple probe node to output matching inner table rows.

FIG. 32 is a block diagram of an example embodiment of a nonlimiting example of inner hash join implementation that includes a build phase 3207 and a probe phase 3209. In the example embodiment of FIG. 32, the build phase 3207 may include performing a hash build (e.g., as described hereinabove in relation to FIG. 25) based on key columns of inner table data 3227a-c to generate a hash table 3233 that includes a join key and row numbers of the inner table. According to an example embodiment, the build phase 3207 may further include performing a tuple build (e.g., as described hereinabove in relation to FIG. 27) based on inner table data streams 3227a-c to generate tuple table 3237 that includes inner tuples for the inner table data 3227a-c.

According to an example embodiment, probe phase 3209 may include performing a hash probe (e.g., as described hereinabove in relation to FIG. 26) of the hash table 3233 based on key columns of outer table data 3227d-f to generate an output hitmap stream 3229a and a row numbers stream 3229b. In turn, according to an example embodiment, the hitmap 3229a may be provided to project a bitmap node 3239 operating in a default configuration (as described hereinabove in relation to FIG. 23), which node 3239 may also receive the outer table data streams 3227d-f and, based on the hitmap 3229a, generate filtered outer table data streams 3229c-e. Further, according to an example embodiment, the row numbers 3229b may be supplied to a node (not shown) that may perform a tuple probe (e.g., as described hereinabove in relation to FIG. 28) on tuple table 3337 and, based on the row numbers 3229b, generate matching inner table data streams 3229f-h. According to an example embodiment, combining inner table data 3229f-h and outer table data 3229c-e may produce inner joined table 3201. Finally, it is noted that, while the three inner table streams 3227a-c and three outer table streams 3227d-f are used in the example embodiment of FIG. 32, an example embodiment can perform an inner hash join on an arbitrary number of inner table and/or outer table data streams.

### Left Outer Hash Join

Left outer hash join may be implemented by building the hash table and tuple table as described above in the build phase. In the probe phase, both a hitmap and row numbers from a hash probe may be sent to a tuple probe to insert nulls wherever a bit is zero in the hitmap.

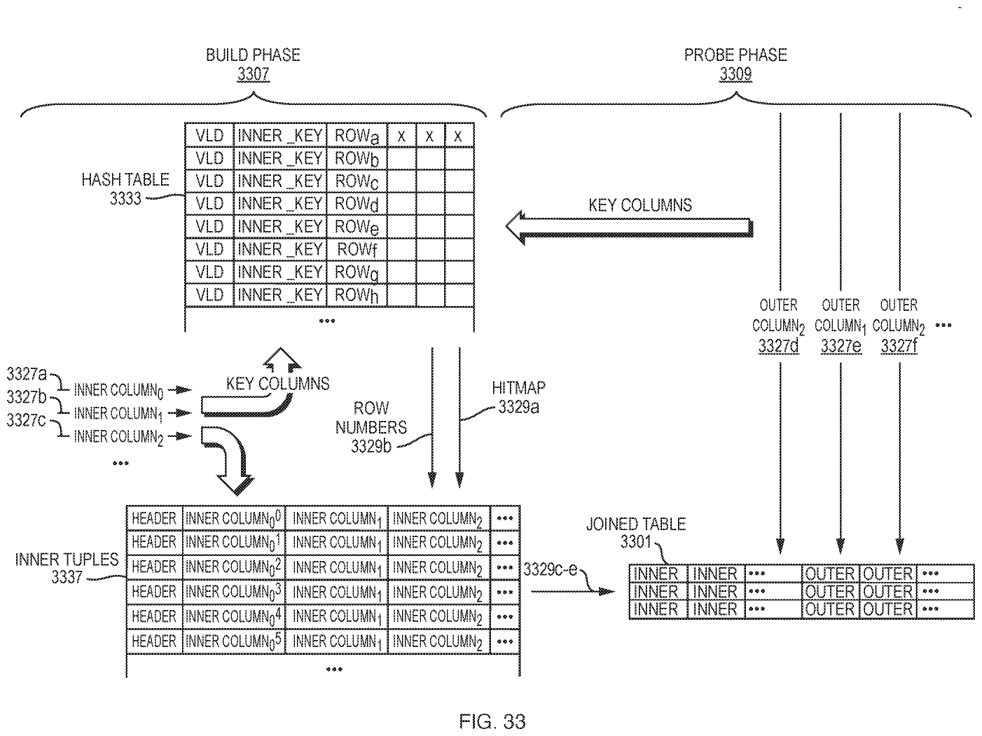

FIG. 33 is a block diagram of a nonlimiting example embodiment of a left outer hash join implementation that includes a build phase 3307 and a probe phase 3309. In the example embodiment of FIG. 33, the build phase 3307 may include performing a hash build (e.g., as described hereinabove in relation to FIG. 25) based on key columns of an inner table data 3327a-c to generate a hash table 3333 that includes a join key and row numbers of the inner table.

According to an example embodiment, the build phase 3307 may further include performing a tuple build (e.g., as described hereinabove in relation to FIG. 27) based on the inner table data streams 3327a-c to generate the tuple table 3337 that includes inner tuples for the inner table data 3327a-c. To continue, in an example embodiment, the probe phase 3309 may include performing a hash probe (e.g., as described hereinabove in relation to FIG. 26) of the hash table 3333 based on key columns of the outer table data 3327d-f to generate an output hitmap stream 3329a and a row numbers stream 3329b. In turn, according to an example embodiment, the hitmap 3329a and row numbers 3329b may be supplied to a node (not shown) that may perform a tuple probe (e.g., as described hereinabove in relation to FIG. 28) on tuple table 3337 and, based on the hitmap 3329a and row numbers 3329b, generate matching inner table data streams 3329c-e.

According to an example embodiment, combining the inner table data 3329c-e and outer table data 3327d-f may result in left outer joined table 3201. Finally, it is noted that, while the three inner table streams 3327a-c and three outer table streams 3327d-f are used in the example embodiment of FIG. 33, an example embodiment can perform a left outer hash join on an arbitrary number of inner table and/or outer table data streams.

### Right Outer Hash Join

According to an example embodiment, a right outer hash join may be implemented by swapping the build side and probe side at a planner level. Note that a right outer hash join can alternatively be implemented by adding a hit count per row in the hash table and adding a parameter to a hash probe node to output row numbers for entries with a zero hit count. Null values for the outer table can be generated using a mover node.

### Full Outer Hash Join

A full outer hash join may be implemented by doing a left outer hash join (e.g., as described hereinabove in relation to FIG. 33), along with an alternative implementation of right outer hash join described above.

### Left Semi Hash Join

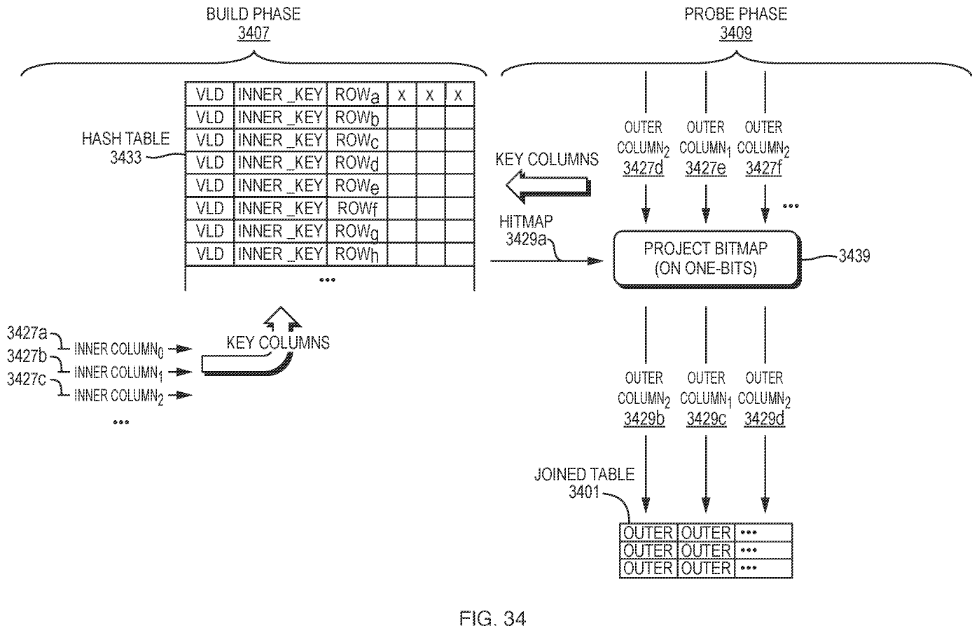

A left semi hash join may be implemented like inner hash join (e.g., as described hereinabove in relation to FIG. 32), but without any columns from an inner table, e.g., the table 3237, as shown in FIG. 34 described below.

FIG. 34 is a block diagram of a nonlimiting example embodiment of a left semi hash join implementation that includes a build phase 3407 and a probe phase 3409. In the embodiment of FIG. 34, a build phase 3407 may include performing a hash build (e.g., as described hereinabove in relation to FIG. 25) based on key columns of an inner table data 3427a-c to generate a hash table 3433 that includes a join key and row numbers of the inner table. According to an example embodiment, the probe phase 3409 may include performing a hash probe (e.g., as described hereinabove in relation to FIG. 26) of the hash table 3433 based on key columns of outer table data 3427d-f to generate an output hitmap stream 3429a. In turn, according to an example embodiment, the hitmap 3429a may be provided to project the bitmap node 3439 operating in a default configuration (as described hereinabove in relation to FIG. 23), which node 3439 may also receive outer table data streams 3427d-f and, based on the hitmap 3429a, generate filtered outer table data streams 3429b-d. According to an example embodiment, the filtered outer table data 3429b-d may be used to produce left semi joined table 3401. Finally, it is noted that, while three inner table streams 3427a-c and three outer table streams 3427d-f are used in the example embodiment of FIG. 34, an example embodiment can perform a left semi hash join based on an arbitrary number of inner table and/or outer table data streams.

### Right Semi Hash Join

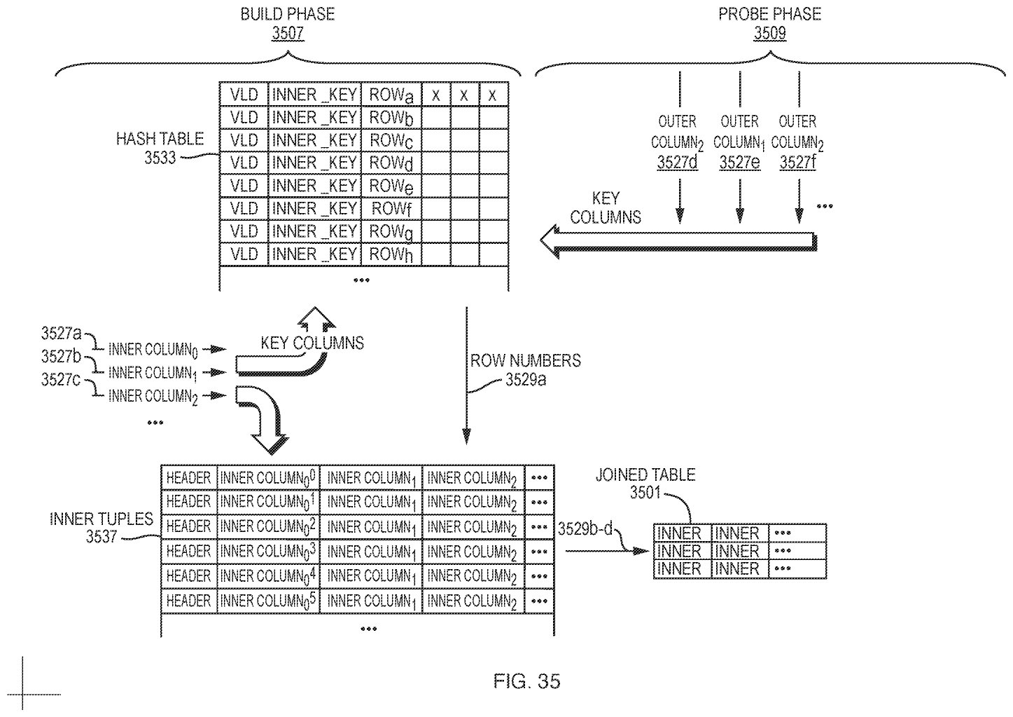

A right semi hash join may be implemented like an inner hash join without any columns from the outer table as shown in FIG. 35, described below.

FIG. 35 is a block diagram of a non-limiting example embodiment of a right semi hash join implementation that includes a build phase 3507 and a probe phase 3509 according to an example embodiment. In the embodiment of FIG. 35, the build phase 3507 may include performing a hash build (e.g., as described hereinabove in relation to FIG. 25) based on key columns of inner table data 3527a-c to generate a hash table 3533 that includes a join key and row numbers of the inner table.

According to an example embodiment, the build phase 3507 may further include performing a tuple build (e.g., as described hereinabove in relation to FIG. 27) based on inner table data streams 3527a-c to generate a tuple table 3537 that includes inner tuples for the inner table data 3527a-c. To continue, according to an example embodiment, the probe phase 3509 may include performing a hash probe (e.g., as described hereinabove in relation to FIG. 26) of the hash table 3533 based on key columns of the outer table data 3527d-f to generate the output row numbers stream 3529a. In turn, according to an example embodiment, row numbers 3529a may be supplied to a node (not shown) that may perform a tuple probe (e.g., as described hereinabove in relation to FIG. 28) on tuple table 3537 and, based on row numbers 3529a, generate a matching inner table data streams 3529b-d. According to an example embodiment, matching inner table data streams 3529b-d may be used to produce the right semi hash joined table 3501. Finally, it is noted that, while three inner table streams 3527a-c and three outer table streams 3527d-f are used in the example embodiment of FIG. 35, an example embodiment can perform a right semi hash join on an arbitrary number of inner table and/or outer table data streams.

### Left Anti Hash Join

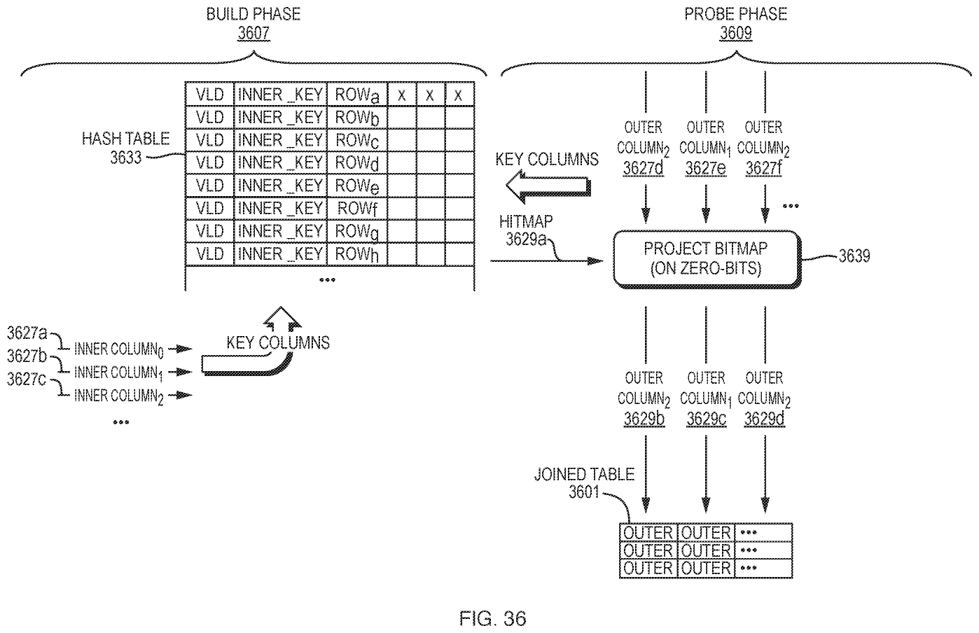

Left anti hash join may be implemented like left semi hash join (e.g., as described hereinabove in relation to FIG. 34), but with only nonintersecting rows, as shown in FIG. 36 described below.

FIG. 36 is a block diagram of a non-limiting example embodiment of a left anti hash join implementation that includes a build phase 3607 and a probe phase 3609 according to an embodiment. In the example embodiment of FIG. 36, the build phase 3607 may include performing a hash build (e.g., as described hereinabove in relation to FIG. 25) based on key columns of inner table data 3627a-c to generate hash table 3633 that includes a join key and row numbers of the inner table. To continue, in another example embodiment, the probe phase 3609 may include performing a hash probe (e.g., as described hereinabove in relation to FIG. 26) of the hash table 3633 based on key columns of the outer table data 3627d-f to generate an output hitmap stream 3629a. In turn, according to an example embodiment, the hitmap 3629a may be provided to project the bitmap node 3639 operating in an optional configuration (as described hereinabove in relation to FIG. 23), which node 3639 may also receive outer table data streams 3627d-f and, based on the hitmap 3629a, generate filtered outer table data streams 3629b-d corresponding to 0 bit values in a hitmap 3629a.

According to an example embodiment, the filtered outer table data 3629b-d may be used to produce a left anti joined table 3601. Finally, it is noted that, while three inner table streams 3627a-c and three outer table streams 3627d-f are used in the example of FIG. 36, embodiments can perform a left anti hash join based on an arbitrary number of inner table and/or outer table data streams.

### Right Anti Hash Join

According to an example embodiment, a right anti hash join may be the same as a right semi hash join, except that rows with a zero hitmap may be returned by the hasher.

### Sort-Merge Join

### Filter

In an example embodiment, a filter node may be implemented using evaluate and match instructions, feeding the output bitmap to a project bitmap instruction. According to another example embodiment, the evaluate instruction may evaluate a predicate for each row and send out a bitmap containing a 1-bit for matching rows and a 0-bit for mismatching rows. In yet another example embodiment, the project bitmap instruction may filter out the mismatching rows.

### Project

According to an example embodiment, a project node may be implemented using an evaluate instruction. In another example embodiment, expressions can be arbitrarily long, and all functions supported by Insight can be used in the expressions.

### Group

According to an example embodiment, a group node may be implemented using hash build.

### Sort

According to an example embodiment, a sort node may use a “sort” transform instruction or operation to sort data elements in a data stream. In another example embodiment, a sort node may be implemented in a PDU “mover” accelerator unit.

### Limit

According to an example embodiment, a limit node may be implemented by closing input port(s) of a DFG—i.e., closing the input port(s) to receiving additional data-after a limit has been reached.

### Union

According to an example embodiment, a union node may be implemented by multiplexing the node's input ports.

### Dedup

According to an example embodiment, a dedup node may be implemented using tuple hash (described hereinabove in relation to FIG. 24) and hash build (described hereinabove in relation to FIG. 25) functionality, for non-limit examples. In another example embodiment, a dedup node may be implemented in a PDU “mover” accelerator unit.

### Exchange

According to an example embodiment, an exchange node may be implemented using tuple hash (described hereinabove in relation to FIG. 24) functionality, for non-limit example. In another example embodiment, an exchange node may be implemented in a PDU “mover” accelerator unit.

### Scheduling and Monitoring

After IR is converted into one or more Insight VM DFG(s), the QFlow scheduling and monitoring module may dispatch the DFG(s) to Insight VMs and monitor their execution.

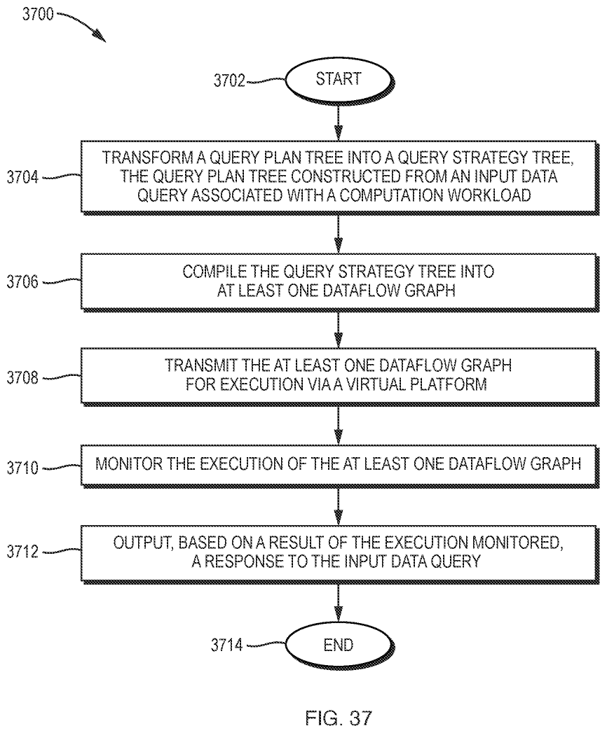

FIG. 37 is a flow diagram of an example embodiment of a computer-implemented method 3700. The method begins (3702) and comprises transforming a query plan tree into a query strategy tree, the query plan tree constructed from an input data query associated with a computation workload (3704). The method further comprises compiling the query strategy tree into at least one dataflow graph (3706). The method further comprises transmitting the at least one dataflow graph for execution via a virtual platform (3708). The method further comprises monitoring the execution of the at least one dataflow graph (3710) and outputting, based on a result of the execution monitored, a response to the input data query (3712). The result is received from the virtual platform and represents at least one computational result of processing the computation workload by the virtual platform. The method thereafter ends (3714) in the example embodiment.

FIG. 38 is a block diagram of an example of the internal structure of a computer 3800 in which various embodiments of the present disclosure may be implemented. The computer 3800 contains a system bus 3852, where a bus is a set of hardware lines used for data transfer among the components of a computer or digital processing system. The system bus 3852 is essentially a shared conduit that connects different elements of a computer system (e.g., processor, disk storage, memory, input/output ports, network ports, etc.) that enables the transfer of information between the elements. Coupled to the system bus 3852 is an I/O device interface 3854 for connecting various input and output devices (e.g., keyboard, mouse, displays, printers, speakers, etc.) to the computer 3800. A network interface 3856 allows the computer 3800 to connect to various other devices attached to a network (e.g., global computer network, wide area network, local area network, etc.). Memory 3858 provides volatile or non-volatile storage for computer software instructions 3860 and data 3862 that may be used to implement embodiments (e.g., method 3700, process 3000, process 2000, second phase 1800, first phase 1500, architecture 1380, architecture 1200, architecture 1100, process 900, process 600, server 580, server 470, platform 360, system 200, cluster 100, and computer-based system 110, etc.) of the present disclosure, where the volatile and non-volatile memories are examples of non-transitory media. Disk storage 3864 provides non-volatile storage for computer software instructions 3860 and data 3862 that may be used to implement embodiments (e.g., method 3700, process 3000, process 2000, second phase 1800, first phase 1500, architecture 1380, architecture 1200, architecture 1100, process 900, process 600, server 580, server 470, platform 360, system 200, cluster 100, and computer-based system 110, etc.) of the present disclosure. A central processor unit 3866 is also coupled to the system bus 3852 and provides for the execution of computer instructions.

As used herein, the terms “engine,” “module,” and “unit” may refer to any hardware, software, firmware, electronic control component, processing logic, and/or processor device, individually or in any combination, including without limitation: an application specific integrated circuit (ASIC), a FPGA, an electronic circuit, a processor and memory that executes one or more software or firmware programs, and/or other suitable components that provide the described functionality.

Example embodiments disclosed herein may be configured using a computer program product; for example, controls may be programmed in software for implementing example embodiments. Further example embodiments may include a non-transitory computer-readable medium that contains instructions that may be executed by a processor, and, when loaded and executed, cause the processor to complete methods described herein. It should be understood that elements of the block and flow diagrams may be implemented in software or hardware, such as via one or more arrangements of circuitry of FIG. 38, disclosed above, or equivalents thereof, firmware, a combination thereof, or other similar implementation determined in the future.

In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random-access memory (RAM), read-only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-implemented method comprising:
transforming a query plan tree into a query strategy tree, the query plan tree constructed from an input data query associated with a computation workload;
compiling the query strategy tree into at least one dataflow graph;
transmitting the at least one dataflow graph for execution via a virtual platform;
monitoring the execution of the at least one dataflow graph; and
outputting, based on a result of the execution monitored, a response to the input data query, the result received from the virtual platform and representing at least one computational result of processing the computation workload by the virtual platform.

2. The computer-implemented method of claim 1, further comprising:
generating, based on the input data query associated with the computation workload, a query logic tree including at least one query element node; and
constructing, based on the query logic tree generated, the query plan tree in an intermediate representation (IR), wherein the IR is compatible with at least one type of computation workload, wherein the at least one type of computation workload includes a type of the computation workload associated with the input data query, wherein the IR is architecture-independent, and wherein the IR represents at least one query operation of the input data query.

3. The computer-implemented method of claim 2, wherein the at least one type of computation workload includes a Structured Query Language (SQL) query plan, a data ingestion pipeline, an artificial intelligence (AI) or machine learning (ML) workload, a high-performance computing (HPC) program, another type of computation workload, or a combination thereof.

4. The computer-implemented method of claim 1, wherein transforming the query plan tree into the query strategy tree includes:
generating the query strategy tree from the query plan tree, the query strategy tree including at least one action node, an action node of the at least one action node corresponding to a respective portion of the computation workload; and
determining at least one resource for executing the action node of the query strategy tree generated.

5. The computer-implemented method of claim 4, wherein the action node includes at least one stage, wherein a stage of the at least one stage corresponds to a unique portion of the respective portion of the computation workload, and wherein determining the at least one resource includes determining at least one respective resource for executing each stage of the at least one stage.

6. The computer-implemented method of claim 1, wherein the query plan tree is annotated with at least one statistic relating to the computation workload and wherein transforming the query plan tree into the query strategy tree is based on a statistic of the at least one statistic.

7. The computer-implemented method of claim 1, wherein the transforming includes:
distributing at least a portion of the computation workload equally across at least two action nodes of at least one level of action nodes of the query strategy tree.

8. The computer-implemented method of claim 1, wherein the transforming includes:
applying at least one optimization to the query strategy tree.

9. The computer-implemented method of claim 8, wherein the at least one optimization includes a node-level optimization, an expression-level optimization, or a combination thereof.

10. The computer-implemented method of claim 1, wherein the compiling includes:
selecting, based on at least one resource associated with an action node of at least one action node of the query strategy tree, a virtual machine (VM) of at least one VM of the virtual platform;
translating the action node of the at least one action node of the query strategy tree into a dataflow graph of the at least one dataflow graph; and
assigning the dataflow graph for execution by the VM selected.

11. The computer-implemented method of claim 10, wherein:
selecting the VM is further based on at least one of: (i) a workload of the VM, (ii) at least one resource of the VM for processing the computation workload, and (iii) compatibility of the computation workload with the VM.

12. The computer-implemented method of claim 10, wherein a scheduling mode for the query strategy tree is a store-forward mode, and wherein the method further comprises:
identifying the action node of the at least one action node of the query strategy tree by traversing the query strategy tree in a breadth-first mode.

13. The computer-implemented method of claim 12, wherein the action node of the at least one action node of the query strategy tree is a parent action node associated with at least one child action node of the query strategy tree, and wherein:
the translating and the assigning are performed responsive to determining that execution of a respective dataflow graph of the at least one dataflow graph has completed, the respective dataflow graph corresponding to a child action node of the at least one child action node.

14. The computer-implemented method of claim 10, wherein a scheduling mode for the query strategy tree is a cut-through mode, and wherein:
the selecting includes causing the VM to reserve the at least one resource associated with the action node of the at least one action node of the query strategy tree; and
the translating and the assigning are performed responsive to traversing the query strategy tree in a post-order depth-first mode.

15. The computer-implemented method of claim 10, wherein the VM selected includes at least one programmable dataflow unit (PDU) based execution node, and wherein:
the selecting is further based on at least one resource of a PDU based execution node of the at least one PDU based execution node.

16. The computer-implemented method of claim 15, wherein a dataflow node of the dataflow graph corresponds to a query operation, and wherein:
the selecting includes mapping the query operation to the PDU based execution node.

17. The computer-implemented method of claim 10, wherein the VM selected includes at least one non-PDU based execution node, and wherein:
the selecting is further based on at least one resource of a non-PDU based execution node of the at least one non-PDU based execution node.

18. The computer-implemented method of claim 17, wherein the non-PDU based execution node is a central processing unit (CPU) based execution node, a graphics processing unit (GPU) based execution node, a tensor processing unit (TPU) based execution node, or another type of non-PDU based execution node.

19. The computer-implemented method of claim 1, wherein the monitoring includes:
detecting an execution failure of a dataflow graph of the at least one dataflow graph on a first VM of the virtual platform; and
assigning the dataflow graph for execution on a second VM of the virtual platform.

20. The computer-implemented method of claim 1, further comprising:
adapting the query strategy tree based on at least one statistic associated with the computation workload.

21. The computer-implemented method of claim 20, wherein a statistic of the least one statistic includes a runtime statistical distribution of data values in a data source associated with the computation workload.

22. The computer-implemented method of claim 21, wherein the adapting is responsive to identifying a mismatch between the runtime statistical distribution of the data values and an estimated statistical distribution of the data values.

23. The computer-implemented method of claim 20, wherein the adapting includes regenerating a dataflow graph of the at least one dataflow graph by performing at least one of: (i) reordering dataflow nodes of the dataflow graph, (ii) removing an existing dataflow node of the dataflow graph, and (iii) adding a new dataflow node to the dataflow graph.

24. The computer-implemented method of claim 1, further comprising:
generating, based on a dataflow graph of the at least one dataflow graph, a plurality of dataflow subgraphs; and
configuring dataflow subgraphs of the plurality of dataflow subgraphs to, when executed via the virtual platform, perform a data movement operation in parallel.

25. The computer-implemented method of claim 24, wherein the data movement operation includes at least one of: (i) streaming data from a data source associated with the computation workload and (ii) transferring data to or from at least one VM of the virtual platform.

26. The computer-implemented method of claim 1, wherein the compiling includes:
selecting a virtual machine (VM) of at least one VM of the virtual platform, the selecting based on at least one resource associated with a stage of at least one stage of an action node of at least one action node of the query strategy tree;
translating the stage into a dataflow graph of the at least one dataflow graph; and
assigning the dataflow graph for execution by the VM selected.

27. The computer-implemented method of claim 26, wherein a scheduling mode for the query strategy tree is a store-forward mode, and wherein the computer-implemented method further comprises:
identifying the action node by traversing the query strategy tree in a breadth-first mode.

28. The computer-implemented method of claim 27, wherein the action node is a parent action node of at least one child action node of the query strategy tree, wherein the stage of the action node is associated with a stage of at least one stage of the at least one child action node, and wherein:
the translating and the assigning are performed responsive to determining that execution of a respective dataflow graph of the at least one dataflow graph has completed, the respective dataflow graph corresponding to the stage of the at least one stage of the at least one child action node.

29. The computer-implemented method of claim 27, wherein the action node is a child action node of a parent action node of the query strategy tree and wherein the stage of the action node is associated with a stage of at least one stage of the parent action node.

30. The computer-implemented method of claim 26, wherein a scheduling mode for the query strategy tree is a cut-through mode, and wherein:
the selecting includes causing the VM to reserve the at least one resource associated with the stage of the at least one stage of the action node of the at least one action node of the query strategy tree; and
the translating and the assigning are performed responsive to traversing the query strategy tree in a post-order depth-first mode.

31. The computer-implemented method of claim 1, wherein the transforming includes:
distributing at least a portion of the computation workload equally across at least two stages of an action node of at least one action node of the query strategy tree.

32. A computer-based system comprising:
at least one processor; and
a memory with computer code instructions stored thereon, the at least one processor and the memory, with the computer code instructions, configured to cause the system to:
implement a compiler module, the compiler module configured to transform a query plan tree into a query strategy tree, the query plan tree constructed from an input data query associated with a computation workload, and compile the query strategy tree into at least one dataflow graph; and
implement a runtime module, the runtime module configured to transmit the at least one dataflow graph for execution via a virtual platform, monitor the execution of the at least one dataflow graph, and output a response to the input data query based on a result of the execution monitored, the result received from the virtual platform and representing at least one computational result of processing the computation workload by the virtual platform.

33. The computer-based system of claim 32, wherein the compiler module is further configured to:
generate, based on the input data query associated with the computation workload, a query logic tree including at least one query element node; and
construct, based on the query logic tree generated, the query plan tree in an intermediate representation (IR), wherein the IR is compatible with at least one type of computation workload, wherein the at least one type of computation workload includes a type of the computation workload associated with the input data query, wherein the IR is architecture-independent, and wherein the IR represents at least one query operation of the input data query.

34. The computer-based system of claim 33, wherein the at least one type of computation workload includes a Structured Query Language (SQL) query plan, a data ingestion pipeline, an artificial intelligence (AI) or machine learning (ML) workload, a high-performance computing (HPC) program, another type of computation workload, or a combination thereof.

35. The computer-based system of claim 32, wherein the compiler module is further configured to:
generate the query strategy tree from the query plan tree, the query strategy tree including at least one action node, an action node of the at least one action node corresponding to a respective portion of the computation workload; and
determine at least one resource for executing the action node of the query strategy tree generated.

36. The computer-based system of claim 32, wherein the action node includes at least one stage, wherein a stage of the at least one stage corresponds to a unique portion of the respective portion of the computation workload, and wherein the compiler module is further configured to:
determine at least one respective resource for executing each stage of the at least one stage.

37. The computer-based system of claim 32, wherein the query plan tree is annotated with at least one statistic relating to the computation workload and wherein the compiler module is further configured to transform the query plan tree into the query strategy tree based on a statistic of the at least one statistic.

38. The computer-based system of claim 32, wherein the compiler module is further configured to:
distribute at least a portion of the computation workload equally across at least two action nodes of at least one level of action nodes of the query strategy tree.

39. The computer-based system of claim 32, wherein the compiler module is further configured to:
apply at least one optimization to the query strategy tree.

40. The computer-based system of claim 39, wherein the at least one optimization includes a node-level optimization, an expression-level optimization, or a combination thereof.

41. The computer-based system of claim 32, wherein the compiler module is further configured to:
select, based on at least one resource associated with an action node of at least one action node of the query strategy tree, a virtual machine (VM) of at least one VM of the virtual platform;
translate the action node of the at least one action node of the query strategy tree into a dataflow graph of the at least one dataflow graph; and
assign the dataflow graph for execution by the VM selected.

42. The computer-based system of claim 41, wherein the compiler module is further configured to:
select the VM based on at least one of: (i) a workload of the VM, (ii) at least one resource of the VM for processing the computation workload, and (iii) compatibility of the computation workload with the VM.

43. The computer-based system of claim 41, wherein a scheduling mode for the query strategy tree is a store-forward mode, and wherein the compiler module is further configured to:
identify the action node of the at least one action node of the query strategy tree by traversing the query strategy tree in a breadth-first mode.

44. The computer-based system of claim 43, wherein the action node of the at least one action node of the query strategy tree is a parent action node associated with at least one child action node of the query strategy tree, and wherein the compiler module is further configured to:
translate the action node and assign the dataflow graph responsive to determining that execution of a respective dataflow graph of the at least one dataflow graph has completed, the respective dataflow graph corresponding to a child action node of the at least one child action node.

45. The computer-based system of claim 41, wherein a scheduling mode for the query strategy tree is a cut-through mode, and wherein the compiler module is further configured to:
cause the VM selected to reserve the at least one resource associated with the action node of the at least one action node of the query strategy tree; and
translate the action node and assign the dataflow graph responsive to traversing the query strategy tree in a post-order depth-first mode.

46. The computer-based system of claim 41, wherein the VM selected includes at least one programmable dataflow unit (PDU) based execution node, and wherein the compiler module is further configured to:
select the VM based on at least one resource of a PDU based execution node of the at least one PDU based execution node.

47. The computer-based system of claim 46, wherein a dataflow node of the dataflow graph corresponds to a query operation, and wherein the compiler module is further configured to:
map the query operation to the PDU based execution node.

48. The computer-based system of claim 41, wherein the VM selected includes at least one non-PDU based execution node, and wherein the compiler module is further configured to:
select the VM based on at least one resource of a non-PDU based execution node of the at least one non-PDU based execution node.

49. The computer-based system of claim 48, wherein the non-PDU based execution node is a central processing unit (CPU) based execution node, a graphics processing unit (GPU) based execution node, a tensor processing unit (TPU) based execution node, or another type of non-PDU based execution node.

50. The computer-based system of claim 32, wherein the runtime module is further configured to:
detect an execution failure of a dataflow graph of the at least one dataflow graph on a first VM of the virtual platform; and
assign the dataflow graph for execution on a second VM of the virtual platform.

51. The computer-based system of claim 32, wherein the compiler module is further configured to:
adapt the query strategy tree based on at least one statistic associated with the computation workload.

52. The computer-based system of claim 51, wherein a statistic of the least one statistic includes a runtime statistical distribution of data values in a data source associated with the computation workload.

53. The computer-based system of claim 52, wherein the compiler module is further configured to:
adapt the query strategy tree responsive to identifying a mismatch between the runtime statistical distribution of the data values and an estimated statistical distribution of the data values.

54. The computer-based system of claim 51, wherein the compiler module is further configured to:
regenerate a dataflow graph of the at least one dataflow graph by performing at least one of: (i) reordering dataflow nodes of the dataflow graph, (ii) removing an existing dataflow node of the dataflow graph, and (iii) adding a new dataflow node to the dataflow graph, and wherein by adapting the query strategy tree the compiler module is further configured to increase efficiency of execution of the dataflow graph relative to not adapting the query strategy tree.

55. The computer-based system of claim 32, wherein the compiler module is further configured to:
generate, based on a dataflow graph of the at least one dataflow graph, a plurality of dataflow subgraphs; and
configure dataflow subgraphs of the plurality of dataflow subgraphs to, when executed via the virtual platform, perform a data movement operation in parallel.

56. The computer-based system of claim 55, wherein the data movement operation includes at least one of: (i) streaming data from a data source associated with the computation workload and (ii) transferring data to or from at least one VM of the virtual platform.

57. The computer-based system of claim 32, wherein the compiler module is further configured to:
select a virtual machine (VM) of at least one VM of the virtual platform, the selecting based on at least one resource associated with a stage of at least one stage of an action node of at least one action node of the query strategy tree;
translate the stage into a dataflow graph of the at least one dataflow graph; and
assign the dataflow graph for execution by the VM selected.

58. The computer-based system of claim 57, wherein a scheduling mode for the query strategy tree is a store-forward mode, and wherein the compiler module is further configured to:
identify the action node by traversing the query strategy tree in a breadth-first mode.

59. The computer-based system of claim 58, wherein the action node is a parent action node of at least one child action node of the query strategy tree, wherein the stage of the action node is associated with a stage of at least one stage of the at least one child action node, and wherein the compiler module is further configured to:
translate the stage and assign the dataflow graph responsive to determining that execution of a respective dataflow graph of the at least one dataflow graph has completed, the respective dataflow graph corresponding to the stage of the at least one stage of the at least one child action node.

60. The computer-based system of claim 58, wherein the action node is a child action node of a parent action node of the query strategy tree and wherein the stage of the action node is associated with a stage of at least one stage of the parent action node.

61. The computer-based system of claim 57, wherein a scheduling mode for the query strategy tree is a cut-through mode, and wherein the compiler module is further configured to:
cause the VM to reserve the at least one resource associated with the stage of the at least one stage of the action node of the at least one action node of the query strategy tree; and
translate the stage and assign the dataflow graph responsive to traversing the query strategy tree in a post-order depth-first mode.

62. The computer-based system of claim 32, wherein the compiler module is further configured to:
distribute at least a portion of the computation workload equally across at least two stages of an action node of at least one action node of the query strategy tree.

63. A non-transitory computer-readable medium having encoded thereon a sequence of instructions which, when loaded and executed by at least one processor, cause the at least one processor to:
implement a compiler module, the compiler module configured to transform a query plan tree into a query strategy tree, the query plan tree constructed from an input data query associated with a computation workload, and compile the query strategy tree into at least one dataflow graph; and
implement a runtime module, the runtime module configured to transmit the at least one dataflow graph for execution via a virtual platform, monitor the execution of the at least one dataflow graph, and output a response to the input data query based on a result of the execution monitored, the result received from the virtual platform and representing at least one computational result of processing the computation workload by the virtual platform.
